(19) United States
(12) Patent Application Publication
(10) Pub. No.: US 2002/0142126 A1
(43) Pub. Date: Oct. 3, 2002

(54) Textile product and method

(76) Inventors: Kenneth B. Higgins, LaGrange, GA (US); William Tippett, Lancashire (GB); Scott C. Miller, LaGrange, GA (US)

Correspondence Address: Milliken & Company, P.O. Box 1927, Spartanburg, SC, 29304, US

(21) Appl. No.: 09/960,114

(22) Filed: Sep. 21, 2001

Related U.S. Application Data
(63) Continuation-in-part of application No. 09/721,871, filed on Nov. 24, 2000.
(63) Continuation-in-part of application No. 09/910,085, filed on Jul. 20, 2001.

(51) Int. Cl. B32B 5/22; B32B 3/02; B32B 33/00

(52) U.S. Cl. 428/95; 428/96; 428/97

(57) ABSTRACT

A layered cushioned composite which in one embodiment incorporates a glass layer of stabilizing material disposed within a layer of adhesive material below a primary carpet surface such that the adhesive material extends in covering relation away from each side of the stabilizing material and performs the dual functions of securing the stabilizing material at a defined position below the underside of the primary carpet and forming an attachment surface for an adjacent layer of underlying recycled foam or rebond foam cushioning material.

### CROSS-REFERENCE TO RELATED APPLICATIONS

This application claims priority to and benefit of and is a continuation-in-part of U.S. patent application Ser. No. 09/721,871, filed Nov. 24, 2000, and is a continuation-in-art of U.S. patent application Ser. No. 09/910,085, filed Jul. 20, 2001, both of which are hereby incorporated by reference herein.

### FIELD OF THE INVENTION

The present invention relates to textile products, composites or constructions such as surface coverings, wall coverings or floor coverings, including flooring, carpet, carpet tile, components thereof, or the like. More particularly, the present invention relates to a construction for a cushioned carpet composite or carpet tile incorporating foam or cushion material such as rebond foam or compressed particle foam. Processes, methods and apparatus for making, forming, installing, or using the cushion or foam backed composites or constructions of the present invention are also provided.

### BACKGROUND OF THE INVENTION

All of the U.S. patents cited herein are hereby incorporated by reference.

U.S. Pat. Nos. 4,522,857, 5,540,968, 5,545,276, 5,948,500, and 6,203,881 (all hereby incorporated by reference herein) describe carpet or carpet tiles having cushioned backings. As described in U.S. Pat. No. 5,948,500 and as shown herein, an example of a tufted carpet product 10A is illustrated in FIG. 1A and an example of a bonded carpet product 10B is illustrated in FIG. 1B.

In the tufted carpet 10A of FIG. 1A, a primary carpet fabric 12 is bonded to an adhesive layer 16 in which is embedded a layer of glass scrim 18. A foam base composite 19 is likewise adhesively bonded to the adhesive layer 16. In such tufted carpet construction, the primary carpet fabric 12 includes a loop pile layer 20 tufted through a primary backing 22 such as a non-woven textile by a conventional tufting process and held in place by a pre-coat backing layer of latex 24 or other appropriate adhesive. The foam base composite 19 of the tufted carpet product 10A includes an intermediate layer 26 molded to a layer of urethane foam 28 as illustrated.

The bonded carpet product 10B of FIG. 1B employs the same type of foam base composite 19 adhesively bonded by adhesive laminate layers 16 in which is disposed a layer of glass scrim 18. However, the primary bonded carpet fabric 12 has somewhat different components from that of the tufted product 10A in that it has cut pile yarns 34 implanted in an adhesive 36 such as PVC, latex, or hot melt adhesive and has a woven or non-woven reinforcement or substrate layer 38 of material such as fiberglass, nylon, polypropylene, or polyester.

The formation of a foam base composite 19 for use in prior cushioned carpeting constructions of either tufted or bonded configuration has typically involved pre-forming and curing virgin urethane foam across a carrier or backing material by practices such as are disclosed in U.S. Pat. Nos. 4,171,395, 4,132,817, and 4,512,831 to Tillotson (all hereby incorporated by reference herein). As described in these patents, such a foam base composite may be laminated to a carpet base thereby yielding a cushioned structure.

As described in the above-mentioned 5,948,500 patent, the cost associated with such modular formation and assembly practices may be reduced by a simplified operation in which a primary carpet fabric, either with or without a stabilizing layer of scrim or the like, is laid directly into a polyurethane-forming composition and thereafter curing the polyurethane. The process can be made even more efficient if the polyurethane-forming composition requires no pre-curing prior to joining the carpet base.

Prior to the invention described in the 5,948,500 patent, the known processes directed to the application of the polyurethane cushioned backings to fabric substrates relied on the extremely close control of temperature in both the polyurethane composition and the adjoined fabric layer to effect stability through pre-cure of the polyurethane prior to lamination of the primary carpet to form a composite structure. Such pre-cure had been largely considered necessary in order to yield a stable foam structure to which the primary carpet backing could be applied. The application of heat to the polyurethane composition prior to joiner of the heated fabric backing caused polymer cross linking which had been thought to be necessary to stabilize the foam mixture to a sufficient degree to prevent the collapse of the foam.

The invention described in the 5,948,500 patent also provides a particularly simple composite structure amenable to in-situ formation of a stable cushion carpet composite. Specifically, a single process is used to bring all the layers of the cushioned carpet composite together by laying a primary carpet fabric, either with or without some degree of preheat, directly into a mechanically frothed polyurethane-forming composition prior to curing the polyurethane and without an intermediate layer of material.

As described in the 5,948,500 patent, the base of the primary carpet fabric is adhesively bonded to a layer of non-woven glass reinforcement material to form a preliminary composite. A puddle of polyurethane-forming composition is simultaneously deposited across a woven or non-woven backing material. The preliminary composite and the polyurethane-forming composition are thereafter almost immediately brought together with the preliminary composite being laid into, and supported by, the polyurethane-forming puddle. The entire structure is then heated to cure the polyurethane forming composition. The preliminary composite may be slightly heated to about 120° F. to improve heating efficiency although the process may likewise be carried out without such preheating.

An excellent cushion backed carpet tile or modular cushion back carpet tile on the market today, for example, sold under the trademark Comfort Plus® by Milliken & Company of LaGrange, Ga. has a primary carpet fabric with a face weight of about 20 to 40 oz/yd², a hot melt layer of about 38 to 54 oz/yd², a cushion of about 0.10 to 0.2 inches thick, a cushion weight of about 28-34 oz/yd², a cushion density of about 18 lbs. per cubic foot, and an overall product height of about 0.4-0.8 inches. This superior cushion back carpet tile provides excellent resilience and under foot comfort, exhibits performance characteristics that rate it for heavy commercial use, and has achieved a notable status throughout the industry as having excellent look, feel, wear, comfort, and cushion characteristics, performance, properties, and the like. Such cushion backed carpet tile is relatively expensive to produce due to the high quality and quantity of materials utilized.

Although attempts have been made at reducing the cost of floor coverings or carpet by using lower quality materials, such attempts have not been particularly successful. Low quality products tend to have a less than desirable look, feel, wear, comfort, cushion, and the like. Hence, such products have not been accepted in the industry and have failed commercially.

One successful relatively low cost floor covering, carpet, or carpet tile and process for producing such a product is described in U.S. patent application Ser. No. 09/587,654 (hereby incorporated by reference). The 09/587,654 application describes a process for producing a low weight composite structure amenable to in-situ formation as a stable cushion carpet composite. One embodiment of such a low weight cushion carpet composite incorporates a low face weight primary carpet fabric of either tufted or bonded construction which is adhesively bonded to a layer of reinforcement material to form a preliminary composite. This preliminary composite is thereafter laid into a puddle of polyurethane-forming material. The resulting structure is then heated to cure the polyurethane-forming material thereby yielding a cushioned structure.

### SUMMARY OF THE PRESENT INVENTION

At least one embodiment of the present invention provides advantages and/or alternatives over previous textile products, composites or constructions such as surface coverings, wall coverings, or floor coverings by providing a relatively low cost, environmentally friendly, aesthetically pleasing, stable, and/or durable layered cushioned textile product, composite or construction which preferably incorporates a layer of cushioning or foam material incorporating compressible particles bonded together, such as rebond foam or another compressed particle foam. The textile or carpet construction of the present invention is thus equally suitable for manufacture by a wide variety of techniques including lamination of a preformed pre-cured layer of foam material, lamination of a preformed primary carpet and a performed foam layer, or by an in-line application process. It is contemplated that a layer or layers of resilient adhesive material may either be substantially discrete from one another or may be intermixed across a layer of stabilizing material if such stabilizing material is sufficiently porous. Accordingly, by the term “layers” is meant both such discrete and intermixed masses. The construction of the present invention is thus characterized by substantial versatility in that it may be manufactured by both simple and more sophisticated manufacturing techniques.

In view of the foregoing, it is a general object of at least one embodiment of the present invention to provide at least one textile product, composite, or construction, such as a cushion or foam backed surface covering, wall covering, floor covering, flooring material, carpet, or carpet tile having a foam layer or cushion formed of a material made up of compressible particles bonded together, such as rebond foam.

It is a further object of at least one embodiment of the present invention to provide a cushioned or foam backed carpet or carpet tile.

It is another object of at least one embodiment of the present invention to provide a carpet tile having a carpet with a face weight of less than or equal to about 45 oz/yd².

It is another object of at least one embodiment of the present invention to provide a carpet tile having a resilient or hot melt layer of less than or equal to about 70 oz/yd².

It is yet another object of at least one embodiment of the present invention to provide a carpet tile having a lightweight face and/or cushion.

It is a further object of at least one embodiment of the present invention to provide a carpet tile having a lightweight cushion of about 0.04 to 0.50 inches thick, preferably 0.04-0.09 inches thick.

It is still another object of at least one embodiment of the present invention to provide a carpet tile having a rebond foam or compressed particle cushion with a density of less than or equal to about 25 lbs. per cubic foot.

It is yet another object of at least one embodiment of the present invention to provide a carpet tile having a rebond foam or compressed particle cushion with a density of about 4-25 lbs. per cubic foot.

It is a further object of at least one embodiment of the present invention to provide a carpet tile having a lightweight cushion with a weight of less than or equal to about 26 oz/yd².

It is a further object of at least one embodiment of the present invention to provide a carpet product or carpet tile having a foam material with a recycled foam and/or particle content.

It is a further object of at least one embodiment of the present invention to provide a carpet product or carpet tile having a backing with at least one flame laminated junction.

It is a further object of at least one embodiment of the present invention to provide a cushioned or foam backed carpet or carpet tile having a layer of compressible particles bonded together.

It is still another object of at least one embodiment of the present invention to provide a carpet product or carpet tile with at least one rebond foam layer.

It is a further object of at least one embodiment of the present invention to provide a carpet product or carpet tile having a delamination strength greater than 5 lbs. per linear inch per ASTM 3936.

It is a further object of at least one embodiment of the present invention to provide a modular carpet tile having resilience and under foot comfort.

It is still another object of at least one embodiment of the present invention to provide a modular carpet tile exhibiting performance characteristics that rate it for heavy commercial use.

It is a further object of at least one embodiment of the present invention to provide a method of forming foam or cushion backed textile products, such as flooring, carpet, carpet composite, carpet tile, or the like.

It is another object of at least one embodiment of the present invention to provide a method of forming a modular carpet tile having resilience, under foot comfort, and performance characteristics that rate it for commercial use.

It is an object of at least one embodiment of the present invention to provide a foam backed or cushioned carpet composite or tile wherein a reinforcement layer is disposed in or below a primary carpet.

It is a related object of at least one embodiment of the present invention to provide a foam backed or cushioned carpet composite or tile wherein a primary carpet fabric is joined to a reinforcement layer and a foam, compressible, or cushion backing.

It is a further object of at least one embodiment of the present invention to provide a process for the formation of a foam backed or cushioned carpet composite or tile including a primary carpet fabric, a reinforcement layer, a polyurethane cushion material, and a backing layer.

It is still a further related object of at least one embodiment of the present invention to provide a continuous process for the formation of a foam backed or cushioned carpet composite having a reinforcement layer between a primary carpet and a backing layer.

It is a further object of at least one embodiment of the present invention to provide a process for the formation of a foam backed or cushion backed carpet composite or product having a primary carpet fabric and a cushion backing attached thereto by an adhesive layer.

It is still a further related object of at least one embodiment of the present invention to provide an apparatus for carrying out the continuous formation of a foam backed or cushioned carpet composite.

It is yet another object of at least one embodiment of the present invention that the carpet composite and carpet tile of the present invention may be printed with orientation independent designs or designs having the ability to seam properly without cutting the tiles in register with the design and to allow the carpet to be installed monolithically as well as by conventional quarter turn “Parquet” or by ashier (brick) techniques with or without floor adhesives.

In accordance with an exemplary object of at least one embodiment of the present invention, a modular carpet composite which may be cut to form modular carpet tiles includes a primary carpet or greige carpet having, for example, a face weight of less than or equal to about 45 oz/yd², a hot melt layer of less than or equal to about 70 oz/yd², and a cushion of about 0.04-0.50 inches thick. The cushion may have a density of about 25 lbs. per cubic foot or less.

It is still another object of at least one embodiment of the present invention to provide a modular carpet composite or modular carpet tile incorporating compressed particle foam or rebond foam preferably having recycled content and having unexpectedly excellent look, wear, cushion, resilience, under foot comfort, and performance characteristics that rate it for heavy commercial use. Hence, such a carpet composite or carpet tile may be used in place of standard cushion backed or hard backed carpet tile, or broadloom carpet thus reducing cost, reducing material requirements, reducing weight, reducing energy requirements, reducing environmental impact, and/or the like.

In accordance with a particular object of at least one embodiment of the present invention, a modular carpet composite, for example 6 feet or 12 feet wide, is cut into modular carpet tiles or carpet squares, for example, 18 inches×18 inches, 36 inches×36 inches, 50 cm×50 cm, 1 meter×1 meter, 48 inches×48 inches, or the like.

Also, in accordance with another object of at least one embodiment of the present invention, the carpet composite or carpet tile of the present invention may be installed on site or on flooring by all of the conventional installation techniques as well as can be constructed for adhesive-free installation, self-stick, or the like.

Also, in accordance with still another object of at least one embodiment of the present invention, the carpet composite and carpet tile of the present invention may be printed with orientation dependent designs or designs having the ability to seam properly which require the tiles to be cut in register with the design and allow the carpet to be installed monolithically with or without floor adhesives.

In accordance with at least one embodiment of the present invention, it has been unexpectedly discovered that a carpet composite or carpet tile having excellent look, feel, wear, resilience, and underfoot comfort and exhibiting performance characteristics that rate it for heavy commercial use can be formed by combining a primary carpet with a hot melt or resilient layer and a rebond foam cushion.

In accordance with at least one embodiment of the present invention, a low weight modular carpet tile is provided having an overall height of about 0.10 to 0.75 inches thick, preferably 0.20 to 0.50 inches thick, depending on the construction of the carpet tile (the number of layers or components) and which can be cut in any conventional shape or size.

The carpet composite of at least one embodiment of the present invention is especially adapted to be cut for use as modular carpet tiles, but also finds applicability as other carpet or flooring, such as, carpet, broadloom, area rugs, runners, floor mats, or the like.

It is a feature of at least one embodiment of the present invention to provide a cushioned carpet composite or carpet tile including a primary carpet fabric in laminar relation to a reinforcement layer wherein such reinforcement layer is at least partially embedded in a rebond foam layer. The reinforcement layer may be bonded to the base of the primary carpet fabric and/or the polyurethane foam.

It is a feature of at least one embodiment of the present invention to provide a cushioned carpet composite or carpet tile including a primary carpet fabric in laminar relation to a polyurethane foam layer which is disposed adjacent to a non-woven backing layer.

It is a feature of at least one embodiment of the present invention to provide a cushioned carpet composite or carpet tile including a primary carpet fabric in laminar relation to a reinforcement layer and a rebond foam layer. The reinforcement layer may be bonded to the base of the primary carpet fabric and/or the polyurethane foam.

It is a further feature of at least one embodiment of the present invention to provide a process for forming a cushioned carpet composite including the simultaneous continuous steps of adhering at least one reinforcement material to the base of a primary carpet fabric and/or to the upper surface of a cushion layer.

It is a further feature of at least one embodiment of the present invention to provide a process for forming a cushioned carpet composite including the steps of adhering a reinforcement material to the base of a primary carpet fabric and adhering a rebond polyurethane foam and backing layer to the reinforcement material.

It is a further feature of at least one embodiment of the present invention to provide a process for forming a cushioned carpet composite including the steps of forming or obtaining a primary carpet fabric, forming or obtaining a rebond polyurethane foam layer, and adhering the primary carpet fabric to the rebond polyurethane foam layer.

It is yet a further feature of at least one embodiment of the present invention to provide an apparatus for use in the continuous in-line formation of a cushioned carpet composite wherein the apparatus includes at least one adhesive application unit or apparatus for adhering a reinforcement layer to the base of a primary carpet fabric and/or to the upper surface of a foam layer.

It is yet a further feature of at least a selected embodiment of the present invention to provide an apparatus for use in the formation of a cushioned carpet composite wherein the apparatus includes a polymer application unit for depositing an adhesive composition or other suitable polymer to the base of a primary carpet fabric and the upper surface of a foam or cushion layer.

It is yet a further feature of at least one embodiment of the present invention to provide an apparatus for use in the formation of a cushioned carpet composite wherein the apparatus includes an adhesive application apparatus for adhering a reinforcement layer to the base of a primary carpet fabric.

In accordance with at least one embodiment of the present invention, a foam backed or cushioned carpet, composite, or tile is provided. The cushioned carpet includes a primary carpet having a primary base and a plurality of pile-forming yarns projecting outwardly from one side. A layer of reinforcement material is bonded to the primary base on the side away from the pile-forming yarns. The reinforcement material is adjacent to, and attached to a foam or cushion layer such as rebond foam. An optional backing material is preferably disposed on the underside of the cushion layer. The backing material may include an adhesive backing on the side away from the cushion layer.

In accordance with at least one embodiment of the present invention, a foam backed cushioned carpet, composite, or tile is provided. The cushioned carpet includes a primary carpet having a primary base and a plurality of pile-forming yarns projecting outwardly from one side. A layer of reinforcement material is bonded to the primary base on the side away from the pile-forming yarns. The reinforcement material is adjacent to a foam or cushion layer of polymer such as polyurethane rebond foam. An optional backing material is preferably disposed on the underside of the cushion layer. The backing material may include an adhesive backing on the side away from the cushion layer.

In accordance with at least one embodiment of the present invention, a foam backed or cushioned carpet, composite, or tile is provided. The cushioned carpet includes a primary carpet having a primary base and a plurality of pile-forming yarns projecting outwardly from one side. A cushion layer is bonded to the primary base on the side away from the pile-forming yarns. A reinforcement material may be embedded in the cushion layer such as two layers of polyurethane rebond foam. The cushion layer may be bonded to the primary carpet by a layer of adhesive such as hot melt. An optional backing material is preferably disposed on the underside of the cushion layer. The backing material may include an adhesive backing on the side away from the cushion layer.

In accordance with at least one embodiment of the present invention, a process for making a cushioned carpet is provided. The process involves producing or obtaining a primary carpet fabric comprising a plurality of pile-forming yarns extending outwardly from one side of a primary base. A layer of reinforcement material is adhered to the primary carpet fabric on the side, from which the pile-forming yarns do not extend, thereby forming a preliminary composite. The preliminary composite is then adhered to a foam or cushion layer. Following this mating operation, the carpet is rolled, slit, or cut to size or into tiles.

In accordance with at least one embodiment of the present invention, a process for making a foam backed or cushioned carpet is provided. The process involves obtaining a primary carpet fabric comprising a plurality of pile-forming yarns extending outwardly from one side of a primary base. The primary carpet fabric is then attached to a foam or cushion layer. Following this mating operation, the composite is preferably heat cured, coded, and then the carpet is cut into tiles.

In accordance with at least one embodiment of the present invention, a process for making a foam backed or cushioned carpet is provided. The process involves obtaining a primary carpet fabric comprising a plurality of pile-forming yarns extending outwardly from one side of a primary base. A layer of reinforcement material is adhered to the primary carpet fabric on the side from which the pile-forming yarns do not extend, thereby forming a preliminary composite. The preliminary composite is then attached to a rebond foam or cushion layer. Following this mating operation the composite is rolled, slit, or cut into tiles.

In accordance with at least one embodiment of the present invention, an apparatus for use in forming a foam backed or cushioned carpet composite is provided. The apparatus includes a reinforcement bonding unit for bonding a layer of reinforcement material to the underside of a primary carpet fabric to form a preliminary carpet composite, a mating unit for mating the preliminary carpet composite to a foam or cushion layer, and wherein the reinforcement bonding unit and the mating unit are operable in a continuous, simultaneous manner.

In accordance with at least one embodiment of the present invention, an apparatus for use in forming a foam backed or cushioned carpet composite is provided. The apparatus includes a reinforcement bonding unit for bonding a layer of reinforcement material to the underside of a primary carpet fabric to form a preliminary carpet composite, a polymer application unit for dispersing a polymer composition across the surface of a cushion layer, and a mating unit for joining the carpet composite and cushion layer.

In accordance with at least one embodiment of the present invention, an apparatus for use in forming a foam backed or cushioned carpet composite is provided. The apparatus includes a reinforcement bonding unit for bonding a layer of reinforcement material to the underside of a primary carpet fabric and to the top side of a cushion layer to form a carpet composite.

In accordance with at least one embodiment of the present invention, a modular carpet tile is manufactured by:

tufting broadloom at a weight of about 45 oz/yd² or less,

printing a design in broadloom form,

applying a rebond foam or cushion backing system, and

cutting into carpet tiles.

The potentially preferred modular carpet tile of at least one embodiment of the present invention is aesthetically pleasing and exhibits performance characteristics that rate it for commercial, hospitality, and/or residential use. The combination of a carpet fabric, adhesive, and cushion backing also provides resilience and under-foot comfort.

The carpet, composite, and tile of at least one embodiment of the present invention is especially suited for broadloom or roll product because of:

a. Tufted construction carpet

b. Applied design, pattern, or color

c. Attached rebond foam or cushion backing

In at least one embodiment of the present invention, a composite foam backed or cushioned carpet or tile is provided wherein a reinforcement layer is disposed intermediate discrete or intermixed layers of resilient polymeric adhesive below a primary carpet and above a foam or cushion layer such that at least a portion of the polymeric adhesive is disposed on and extends away from either side of the reinforcement layer.

According to at least one embodiment of the present invention, a construction of a foam backed or cushioned carpet composite is provided wherein a reinforcement layer is disposed intermediate discrete or intermixed layers of resilient polymeric adhesive below a primary carpet and adjacent the upper surface of a foam layer such that the polymeric adhesive bonds the primary carpet to the foam layer with the reinforcement layer disposed at an intermediate position between the primary carpet and the foam layer.

According to at least one embodiment of the present invention, a foam backed or cushioned carpet composite is provided wherein a reinforcement layer of fiber glass is disposed intermediate discrete or intermixed layers of resilient polymeric adhesive below a primary carpet and above a foam layer such that at least a portion of the material forming the polymeric adhesive is disposed on at least one side of the reinforcement layer.

According to at least one embodiment of the present invention, a foam backed or cushioned carpet composite is provided wherein a reinforcement or stabilizing layer or material is disposed intermediate discrete or intermixed layers of resilient polymeric adhesive below a primary carpet and above a foam layer such that at least a portion of the material forming the polymeric adhesive is disposed on at least one side of the reinforcement layer.

According to at least one embodiment of the present invention, a foam backed or cushioned carpet composite or tile is provided wherein a reinforcement or stabilizing layer is disposed intermediate discrete or intermixed layers of adhesive below a primary carpet and above a foam or cushion layer such that at least a portion of the adhesive is disposed on at least one side of the reinforcement or stabilizing layer.

According to at least one embodiment of the present invention, a rebond foam backed or cushioned carpet composite is provided wherein at least one reinforcement layer or material is disposed below a primary carpet and above a foam or cushion layer such that at least a portion of adhesive is disposed on at least one side of the reinforcement layer or material.

According to at least one embodiment of the present invention, a cushioned carpet composite is provided wherein a reinforcement layer of glass material is disposed adjacent at least one layer of adhesive below a primary carpet and above a foam layer such that at least a portion of the adhesive is disposed on at least one side of the reinforcement layer.

According to at least one embodiment of the present invention, a foam backed or cushioned carpet composite is provided wherein at least one reinforcement layer is disposed intermediate a primary carpet and a foam or cushion layer.

According to at least one embodiment of the present invention, a foam backed or cushioned carpet composite is provided wherein a reinforcement or stabilizing layer is disposed below a primary carpet.

According to at least one embodiment of the present invention, a foam backed or cushioned carpet composite is provided wherein a reinforcement or stabilizing layer is disposed above a foam or cushion layer.

According to at least one embodiment of the present invention a foam backed or cushioned carpet composite is provided having at least one reinforcement or stabilizing layer.

According to at least one embodiment of the present invention, a foam backed or cushioned carpet composite is provided with a primary carpet above a foam or cushion layer.

According to at least one embodiment of the present invention, a foam backed or cushioned carpet composite is provided wherein a reinforcement or stabilizing material or layer is disposed in or adjacent a primary carpet or a foam or cushion layer.

According to at least one embodiment of the present invention, a foam backed or cushioned carpet composite is provided with at least one layer of a thermoplastic or thermoset adhesive.

According to at least one embodiment of the present invention, a process is provided to form a foam backed or cushioned carpet composite.

According to at least one embodiment of the present invention, a lamination process is provided to form a foam backed or cushioned carpet.

According to at least one aspect of the present invention an in-line process is provided to form a foam backed or cushioned carpet composite.

In accordance with at least one embodiment of the present invention, a cushioned carpet composite or tile is provided wherein a reinforcement layer of non-woven glass is disposed between layers of a hot melt polymeric adhesive below a primary carpet and above a foam layer such that the hot melt polymeric adhesive extends in joining relation between the primary carpet and one side of the foam layer with the reinforcement layer being held within the hot melt polymeric adhesive at a position between the foam layer and the primary carpet such that at least a portion of the hot melt polymeric adhesive extends away from either side of the reinforcement layer. An optional backing material or multi-component backing composite may be disposed on the underside of the cushion layer.

In accordance with at least one particular example or embodiment of the present invention, a preformed rebond foam or pad is used to manufacture a commercial grade cushion carpet tile. A rebond pad of approximately 13 pounds/cubic foot density is modified by, for example, flame lamination to have a respective non-woven material bonded to each of the upper and lower surfaces thereof. The composite rebond pad has a thickness of approximately 0.25″ and is slit in half, producing two foam backings, each approximately 0.125″ thick with a non-woven material attached to one surface. Next, each of the slit backings is directly bonded using a hotmelt adhesive to either pre-coated tufted carpet or latex based bonded carpet and then cut into tiles.

In accordance with at least one embodiment of the present invention, a cushioned carpet composite or tile is provided with a friction or adhesion enhancing backing surface, material, or composite such as a textured or embossed surface, a tacky surface, an adhesive surface, a magnetic sheet, magnetic strips, and/or the like.

In accordance with at least one embodiment of the present invention, there is provided a foam or cushion backed carpet or flooring composite such as 6 foot wide cushioned broadloom, 12 foot wide cushioned broadloom, 4 foot×8 foot cushioned sheets or tiles, 4 foot×4 foot cushioned sheets or tiles, 36 inch×36 inch tiles, 1 meter×1 meter tiles, and the like.

### BRIEF DESCRIPTION OF THE DRAWINGS

Certain exemplary embodiments or examples of the present invention will be presented below with reference to the accompanying drawings which are incorporated in and which constitute a part of this specification and in which:

FIG. 1A is a cut-away side view of a tufted carpet with a cushioned composite structure;

FIG. 1B is a cut-away side view of a bonded carpet incorporating a cushioned composite structure;

FIG. 2 is a schematic process diagram illustrating an assembly process for forming a carpet construction according to one embodiment of the present invention;

FIG. 3A is a cut-away side view of a carpet construction according to an embodiment of the present invention incorporating a loop pile tufted primary carpet surface;

FIG. 3B is a cut-away side view of a carpet construction according to another embodiment of the present invention incorporating a cut loop tufted primary carpet surface;

FIG. 3C is a cut-away side view of a carpet construction according to still another embodiment of the present invention incorporating a bonded primary carpet surface;

FIG. 4 is a schematic process diagram illustrating an assembly process for forming a carpet construction according to another embodiment of the present invention;

FIG. 5 is a schematic of a process line for assembly of a carpet construction according to still another embodiment of the present invention;

FIG. 5A is a schematic of a process line for assembly of a carpet construction according to yet another embodiment of the present invention;

FIG. 5B is a view similar to FIG. 5 and illustrating an alternative process line for assembly of a carpet construction according to still yet another embodiment of the present invention;

FIG. 6A is a cut-away side view of an alternative embodiment of a loop pile tufted carpet construction having no separate adhesive pre-coat;

FIG. 6B is a cut-away side view of an alternative embodiment of a cut pile tufted carpet construction having no separate adhesive pre-coat;

FIG. 7A is a cut-away side view of an alternative embodiment of a loop pile tufted carpet construction having a reinforcement layer disposed between two different adhesive layers;

FIG. 7B is a cut-away side view of an alternative embodiment of a cut pile tufted carpet construction having a reinforcement layer disposed between two different adhesive layers;

FIG. 7C is a cut-away side view of an alternative embodiment of a bonded carpet construction having a reinforcement layer disposed between two different adhesive layers;

FIG. 8A is a cut-away side view of an alternative embodiment of a loop pile tufted carpet construction having a reinforcement layer disposed between two layers of latex adhesive;

FIG. 8B is a cut-away side view of an alternative embodiment of a cut pile tufted carpet construction having a reinforcement layer disposed between two layers of latex adhesive;

FIG. 9A is a cut-away side view of an alternative embodiment of a loop pile tufted carpet construction having glass reinforcement disposed across the underside of the primary backing;

FIG. 9B is a cut-away side view of an alternative embodiment of a cut pile tufted carpet construction having glass reinforcement disposed across the underside of the primary backing;

FIG. 10A is a cut-away side view of an alternative embodiment of a loop pile tufted carpet construction including a multi-component backing composite;

FIG. 10B is a cut-away side view of an alternative embodiment of a cut pile tufted carpet construction including a multi-component backing composite;

FIG. 10C is a cut-away side view of an alternative embodiment of a bonded carpet construction including a multi-component backing composite;

FIG. 11A is a cut-away side view of an alternative embodiment of a loop pile tufted carpet construction including a foam cushion with no backing;

FIG. 11B is a cut-away side view of an alternative embodiment of a cut pile tufted carpet construction including a foam cushion with no backing;

FIG. 11C is a cut-away side view of an alternative embodiment of a bonded carpet construction including a foam cushion with no backing;

FIG. 12A is a cut-away side view of an alternative embodiment of a loop pile tufted carpet construction including a foam cushion with a releasable adhesive backing;

FIG. 12B is a cut-away side view of an alternative embodiment of a cut pile tufted carpet construction including a foam cushion with a releasable adhesive backing;

FIG. 12C is a cut-away side view of an alternative embodiment of a bonded carpet construction including a foam cushion with a releasable adhesive backing;

FIG. 13A is a cut-away side view of an alternative embodiment of a loop pile tufted carpet construction including a multi-component composite backing including a releasable adhesive underside;

FIG. 13B is a cut-away side view of an alternative embodiment of a cut pile tufted carpet construction including a multi-component composite backing including a releasable adhesive underside;

FIG. 13C is a cut-away side view of an alternative embodiment of a bonded carpet construction including a multi-component composite backing including a releasable adhesive underside;

FIG. 14A is a cut-away view of another embodiment of a tufted carpet construction with a cushioned composite structure.

FIG. 14B is a cut-away side view of another embodiment of a bonded carpet construction incorporating a cushioned composite structure;

FIG. 15A is a cut-away side view of still another embodiment of a tufted carpet construction incorporating a structure formed by the apparatus and process of the present invention;

FIG. 15B is a cut-away side view of still another embodiment of a bonded carpet construction incorporating a structure formed by the apparatus and process of the present invention;

FIG. 16A is a cut-away side view of an alternative embodiment of a tufted carpet construction having no reinforcement layer;

FIG. 16B is a cut-away side view of an alternative embodiment of a bonded carpet construction having no reinforcement layer;

FIG. 17A is a cut-away side view of an alternative structure for a tufted carpet construction;

FIG. 17B is a cut-away side view of an alternative structure for a bonded carpet construction;

FIGS. 18A and 18B are respective simple and more complex schematic flow diagrams of the production of modular carpet tiles in accordance with selected embodiments of the present invention;

FIGS. 19-27 are cut-away side view construction or layer diagrams of respective tufted and bonded carpet, composite, or tiles in accordance with different embodiments, examples, or aspects of the present invention;

Although FIGS. 19A and 20-27 show a tufted looped pile in the primary carpet and FIG. 19B shows a bonded cut pile primary carpet, it is to be understood that a tufted or bonded looped and/or cut pile may be used and that the pile may be sculptured, printed, dyed, and/or the like as desired;

FIGS. 28-30 relate to one embodiment of a process for producing a rebond foam sheet or pad useful in the carpet constructions of the present invention;

FIG. 28 is a schematic illustration of the process and apparatus for forming a rebond precursor or slurry of chips and binder;

FIGS. 29A and 29B are respective schematic illustrations of the production of a rebond foam block or log from the slurry of FIG. 28;

FIG. 30 is a schematic illustration of the production of a rebond foam sheet or layer in accordance with an exemplary embodiment;

FIGS. 31-32 represent an exemplary process for assembly of a carpet construction from the rebond foam sheet of FIG. 30;

FIG. 31 is a schematic representation of the production of a flame laminated cushion or foam composite including the foam layer of FIG. 30 in accordance with an exemplary embodiment of the present invention;

FIG. 32 is a schematic illustration of an exemplary process line for assembly of a carpet construction including the cushion or foam composite of FIG. 31;

FIG. 33 is a micrograph illustration of the cross-section of a conventional polyurethane foam cushion material;

FIG. 34 is a micrograph illustration of the cross-section of a small chip size, polyurethane rebond foam material in accordance with at least one embodiment of the present invention;

FIG. 35 is a graphical representation of the Hexapod rating comparison of several products;

FIGS. 36 and 37 are cut-away side views of respective alternative embodiments of woven and non-woven carpet or flooring constructions;

FIG. 38 is a schematic process diagram illustration of an assembly process for forming a carpet construction in accordance with another embodiment of the present invention; and,

FIGS. 39 and 40 are cut-away side views of respective tufted and bonded carpet constructions in accordance with other selected embodiments of the present invention.

FIG. 41 is a cut-away side view of an alternative embodiment of a tufted carpet construction including a composite backing including a magnetic sheet.

FIGS. 42 and 43 are respective cut-away side and end view construction or layer diagrams of a tufted carpet composite or tile including a backing having embedded magnetic strips.

FIGS. 44 and 45 are respective cut-away side view construction or layer diagrams of tufted carpet composites or tiles including a backing of a coating or film material.

While the invention has been illustrated and will hereinafter be described and disclosed in connection with certain preferred embodiments, examples, practices and procedures, it is by no means intended to limit the invention to such specific embodiments, examples, practices and procedures. Rather it is intended to cover all such alternatives and modifications thereto as may fall within the true spirit and scope of the invention and all equivalents thereto as defined and limited only by the claims appended hereto.

### DETAILED DESCRIPTION OF PREFERRED EMBODIMENTS

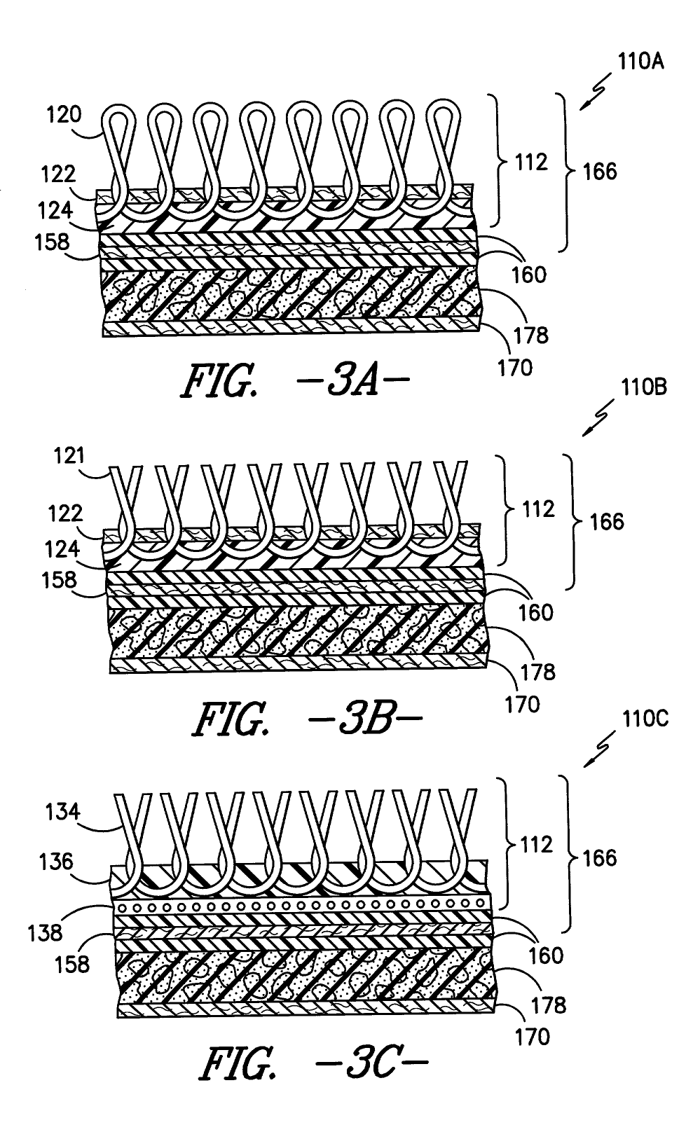

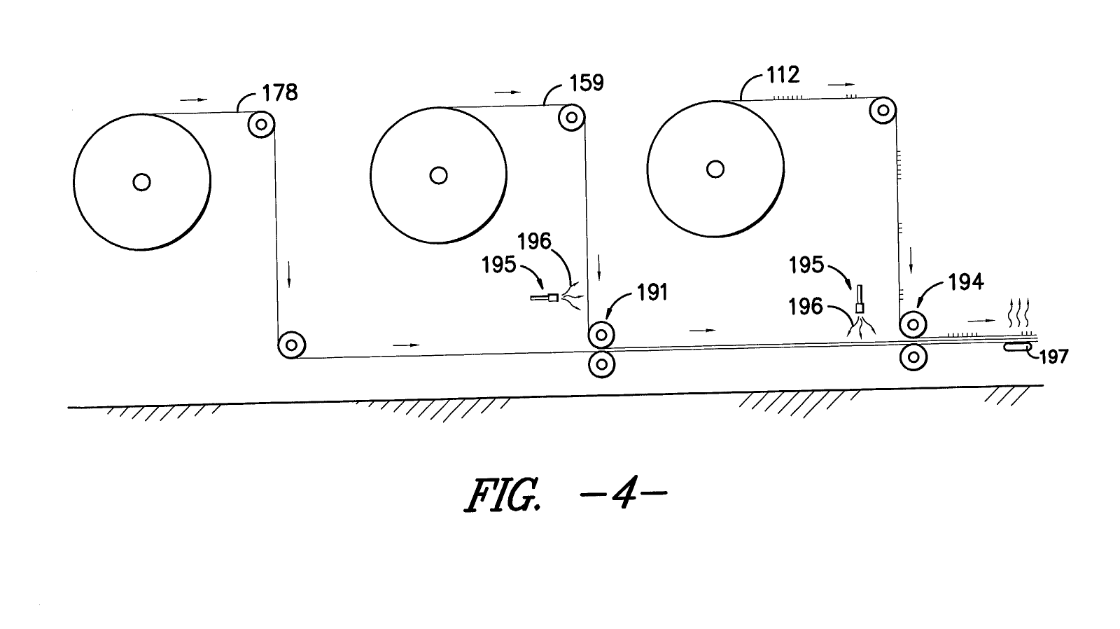

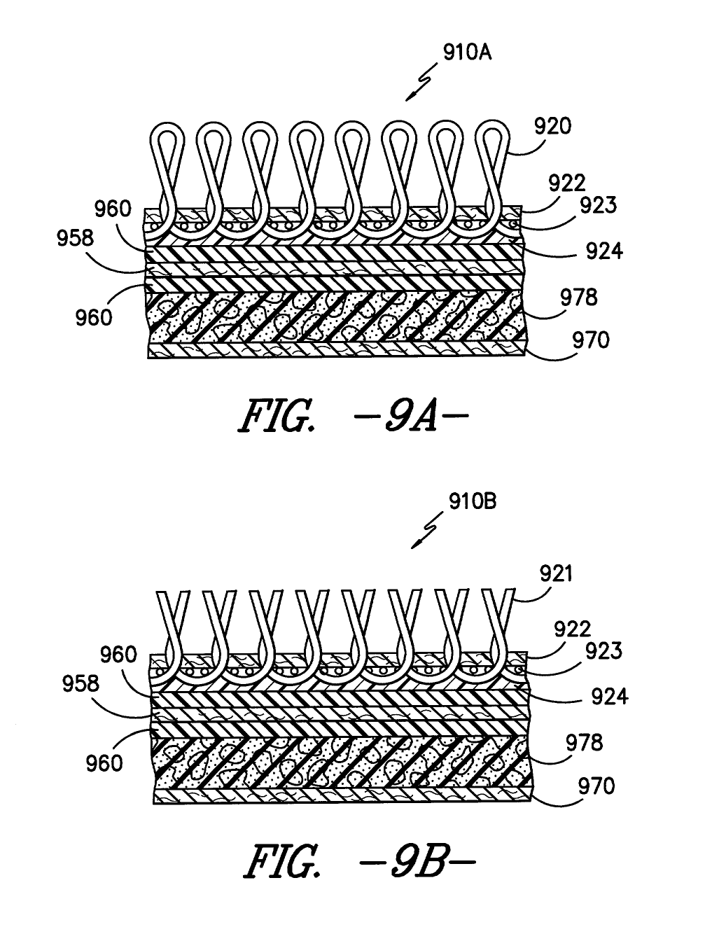

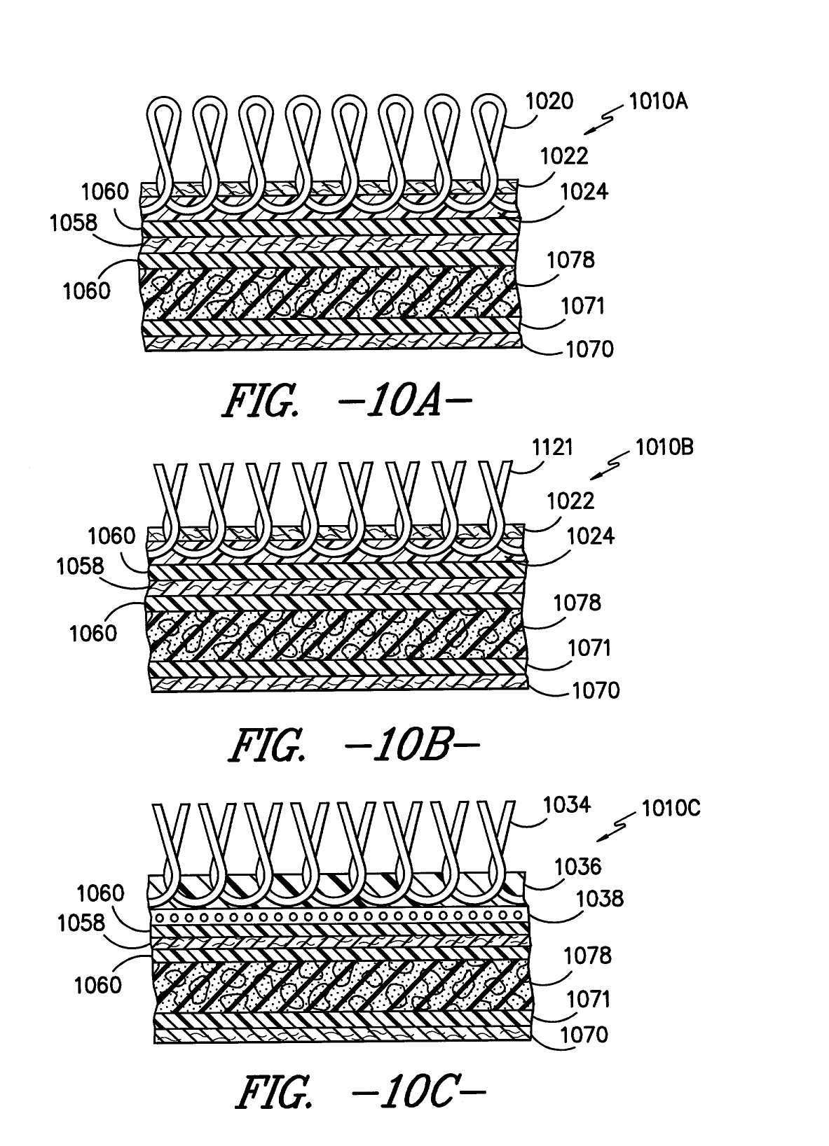

In accordance with at least one embodiment of the present invention, a cushioned composite or construction suitable for use in covering surfaces or products such as surface coverings, wall coverings and floor coverings or products including broadloom carpeting or flooring or modular carpet tile is provided. Referring to FIGS. 2, 3A, 3B and 3C of the drawings, a basic assembly procedure of components within a carpet construction according to the present invention is provided. As illustrated and according to a potentially preferred embodiment, the tufted and bonded carpet constructions 110A, 110B, 110C of the present invention incorporate a layered arrangement of a pile forming primary carpet fabric 112 in overlying relation to a sheet of reinforcement material 158, which in turn is disposed in overlying relation to a layer of cushioning or foam 178, such as rebond foam or compressed particle foam which may include an optional backing layer 170 (FIGS. 3A, 3B, 3C) or multi-component backing composite (FIGS. 10A-C and 13A-C) as will be described further hereinafter. The optional backing layer 170 is preferably a woven or non-woven textile fabric of polyester, polypropylene, polyester/polypropylene, polyester/polypropylene/acrylic, or other appropriate fibers or blends and may contain a colorant, binder, or the like. A non-woven structure of about 80% polyester fiber and about 20% polypropylene fiber, about 50% polyester fiber and about 50% polypropylene fiber, or about 100% polyester fiber may be particularly preferred depending on the face construction of the composite.

Also, a blend of 50% polyester fiber, 20% polypropylene, and 30% acrylic fibers may be used. The polyester, polypropylene and/or acrylic fibers may be of one or more selected colors to give the backing a desired color or appearance. In one embodiment, the foam and backing have a similar color. In a particular example, the foam and/or backing have a green, blue, purple, or gold color. The color of the backing can be achieved, for example, by using a white polyester fiber and a colored acrylic fiber or by using colored polyester and/or polypropylene fibers.

The sheet of reinforcement material 158 is preferably embedded between layers of adhesive 160 such as a thermoplastic adhesive or thermoset adhesive, preferably a hot melt adhesive or the like extending on either side of the sheet of reinforcement material 158 to establish a bonding relationship between the primary carpet fabric 112 and the rebond cushioning or foam 178. As previously indicated, such layers of adhesive 160 may be either substantially discrete with the reinforcement material 158 establishing a barrier between such layers or the layers of adhesive 160 may be at least partially intermixed across the reinforcement material 158. In either event, due to the intimate bonding relationship between the reinforcement material 158 and the layers of adhesive 160, the layers of adhesive 160 in combination with the reinforcement material 158 forms a bridging composite of substantial stability extending between the cushioning foam or rebond foam 178 and the primary carpet fabric 112.

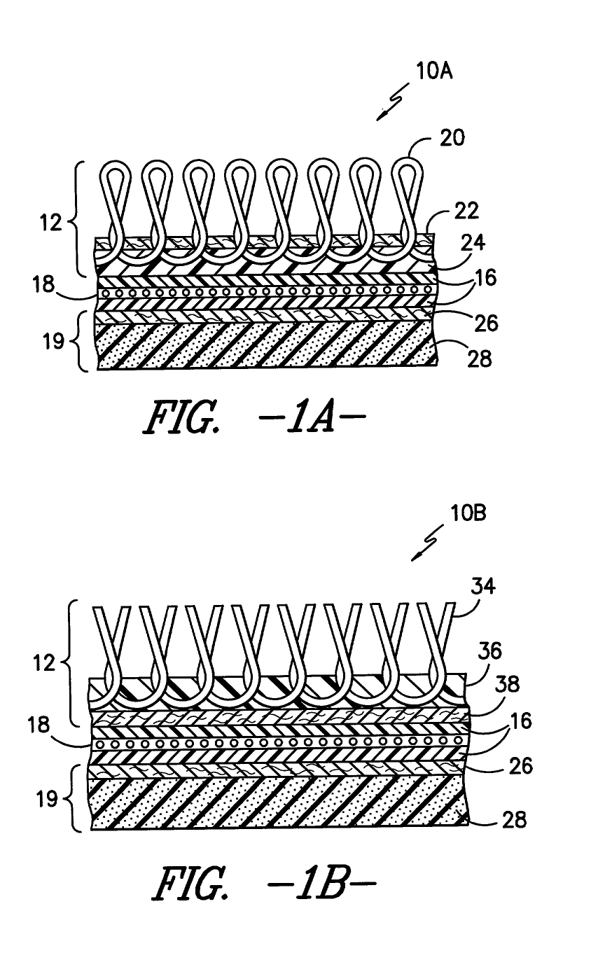

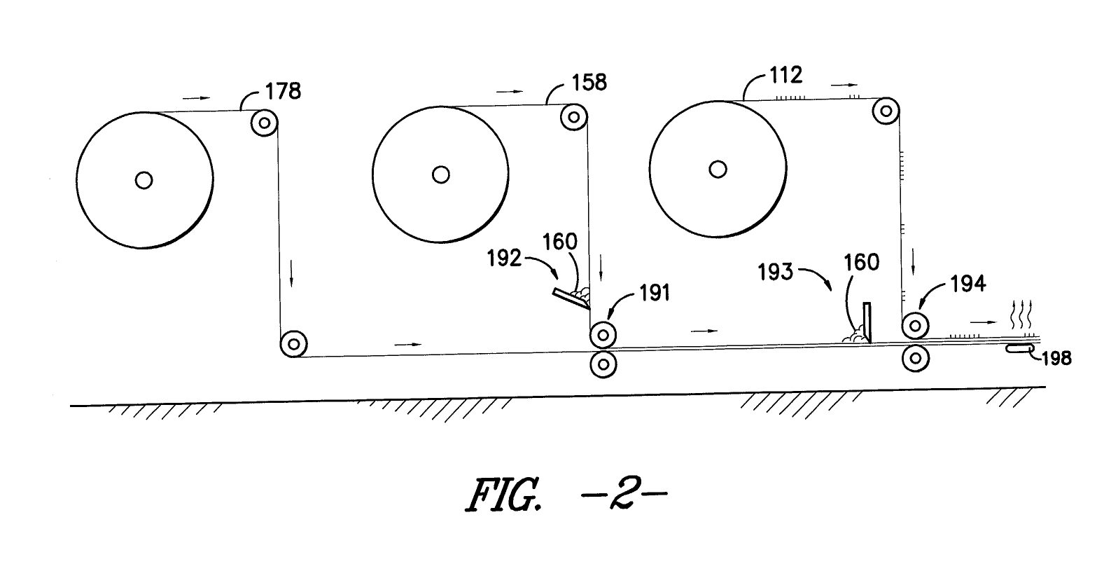

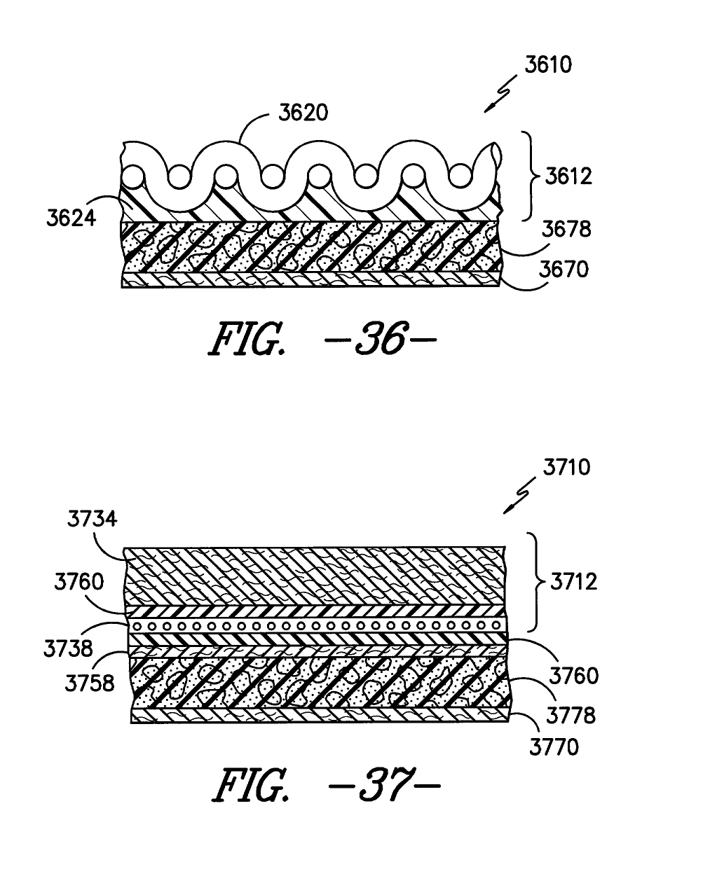

It is contemplated that the primary carpet fabric 112 may incorporate either a tufted or a bonded configuration (with loop and/or cut pile) as described in relation to FIGS. 1A and 1B and FIGS. 3A, 3B, and 3C. It is also contemplated that the primary carpet 112 may take on any number of other pile forming or non-pile forming constructions including by way of example only and not limitation, flat or textured fabrics having woven, knit, or non-woven constructions (FIGS. 36-37).

According to one potentially preferred embodiment, the primary carpet fabric 112 preferably includes a plurality of pile-forming yarns projecting outwardly from one side of a primary base. If the primary carpet 112 used in the present invention is a tufted carpet as illustrated in FIGS. 3A and 3B, its configuration will preferably conform substantially to that of the primary carpet 12 illustrated in FIG. 1A, with the difference that the pile forming yarns 121 of the embodiment shown in FIG. 3B have undergone a tip shearing or loop cutting operation to yield a cut pile construction. If the primary carpet 112 used in the present invention is a bonded product as illustrated in FIG. 3C, its configuration will preferably be that of the bonded primary carpet 12 illustrated in FIG. 1B. It is contemplated that the primary carpet may include one or more backing or base layers.

It is to be understood that as the primary tufted or bonded carpet fabric 12 may have different embodiments, the component structure of the primary carpet fabric 112 is not critical to the present invention. Rather it is intended that any primary carpet fabric having a pile forming portion and a primary base or backing may be utilized as the primary carpet fabric. By “primary base” is meant any single layer or composite structure including, inter alia, the commonly used layered composite of primary backing 22 and latex pre-coat 24 previously described in relation to the tufted product (FIG. 1A) and the adhesive layer 36 with reinforcement substrate 38 previously described in relation to the bonded product (FIG. 1B). As will be appreciated, the use of polyester or a stabilized material in the primary base structure may be desirable due to the eventual heat curing such structure may undergo. Other embodiments as may occur to those of skill in the art may, of course, also be utilized. For example, in the bonded product, the pile forming yarns can be heat tacked to the substrate 38 as described in U.S. Pat. No. 5,443,881 (hereby incorporated by reference herein) to permit simplified construction of a primary carpet.

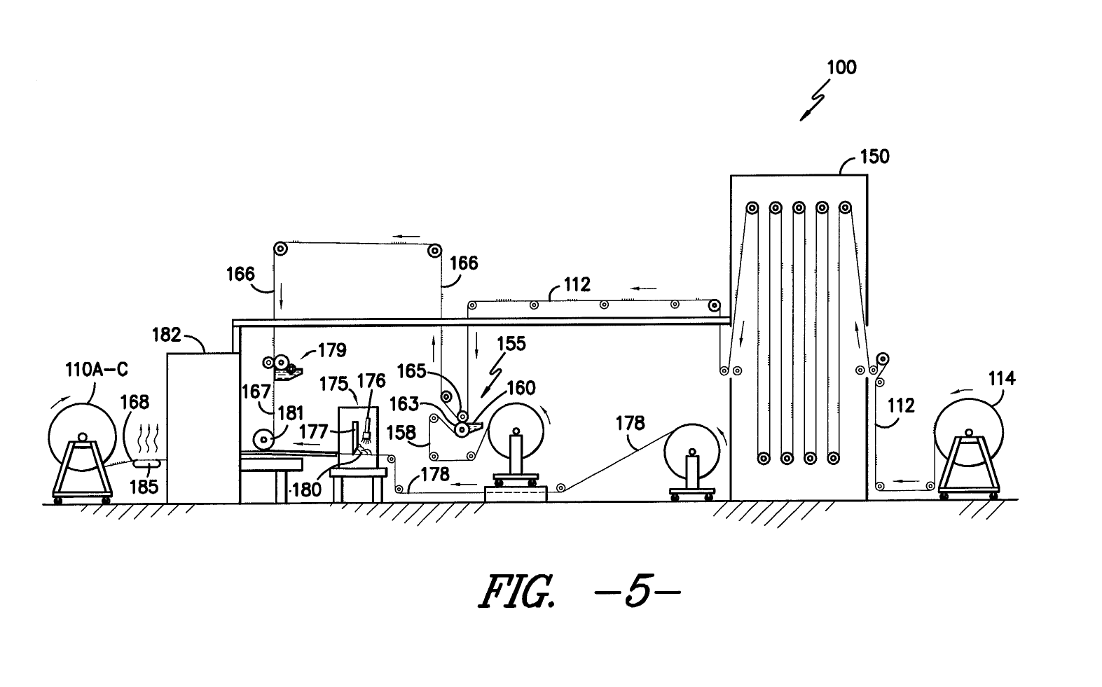

Alternative embodiments including those disclosed in U.S. Pat. No. 4,576,665 to Machell (incorporated by reference) may likewise be utilized. For example, it is contemplated that specialized primary backings such as non-woven structures comprising fiberglass sandwiched between layers of polyester may be utilized in the primary tufted carpet to impart the desired properties relating to stability thereby potentially reducing or even eliminating the need for the secondary backing or the latex pre-coat presently utilized in the manner to be described further hereinafter. Moreover, it is contemplated that if a pre-coat is to be utilized, it may be added directly in-line in an operation prior to any adhesive bonding operation (FIG. 5A).

With regard to one embodiment, in the tufted carpet construction 110A of the present invention (FIG. 3A), the primary carpet fabric 112 preferably comprises a loop pile layer of pile-forming yarns 120 tufted into a primary backing 122 as is well known and held in place by a pre-coat layer 124 of a bonding material or adhesive such as latex, a hot melt adhesive or a urethane based adhesive. It is contemplated that the pre-coat layer 124 may be applied to the primary backing 122 either in a preliminary processing step during formation of the primary carpet fabric 112 or may be added in-line during formation of the cushioned carpet construction in a manner to be described further hereinafter in reference to FIG. 5A. The primary carpet fabric 112 may be steamed and/or heated after addition of the pre-coat layer 124 to facilitate subsequent printing operations, such as direct or indirect jet dying or printing, and/or if desired to reduce stresses. Further, the primary carpet fabric 112 may be printed or dyed prior to addition of the reinforcement material 158 and/or layer of cushioning material or foam 178.

The two basic primary backing constructions are woven polypropylene and non-woven polyester. Each material may have a variety of construction characteristics engineered for a specific end use. According to one potentially preferred embodiment, the preferred primary backing material 122 is 20 pick per inch, woven polypropylene, with needle punched nylon fleece.

With regard to another embodiment, in the cut pile tufted carpet construction 110B of the present invention (FIG. 3B), the primary carpet fabric 112 preferably comprises a loop pile layer of pile-forming yarns 120 tufted into a primary backing 122 as is well known and held in place by a pre-coat layer 124 of a bonding material such as latex, a hot melt adhesive or a urethane based adhesive. The pile forming yarns 120 are subjected to a tip shearing or loop cutting operation to yield the cut pile construction as shown. It is contemplated that the pre-coat layer 124 may be applied to the primary backing 122 either in a preliminary processing step during formation of the primary carpet fabric 112 or may be added in-line during formation of the cushioned carpet construction in a manner to be described further hereinafter in reference to FIG. 5A. The primary carpet fabric 112 may be steamed and/or heated after addition of the pre-coat layer 124 to facilitate subsequent printing operations, such as direct or indirect jet dying or printing, and/or if desired to reduce stresses.

The two basic primary backing constructions are woven polypropylene and non-woven polyester. Each material may have a variety of construction characteristics engineered for a specific end use. According to one potentially preferred embodiment, the preferred primary backing material 122 is 20 pick per inch, woven polypropylene, with needle punched nylon fleece.

In the bonded carpet construction 110C of the present invention (FIG. 3C), the primary carpet fabric 112 preferably comprises a plurality of cut pile yarns 134 implanted in an adhesive 136 such as a latex or hot melt adhesive which is laminated to a reinforcement or substrate layer 138 of a woven or non-woven material including fiberglass, nylon, polyester or polypropylene. It is contemplated that this substrate layer 138 may be pre-coated with latex or other thermoplastic polymers to permit melting adhesion with the cut pile yarns 134 upon the application of heat, thereby potentially reducing or eliminating the need for the adhesive 136.

The yarns 120, 121, and 134 may be either spun or filament yarns and are preferably formed from a polyamide polymer such as nylon 6 staple, nylon 6 filament, nylon 6,6 staple, or nylon 6,6 filament, available from companies like DuPont in Wilmington, Del. or Solutia Fibers of St. Louis, Mo., although other suitable natural or synthetic yarns or blends may likewise be employed as will be recognized by those of skill in the art. By way of example only and not limitation, other materials, which might be used, include polyester staple or filament, polyethylene terephthalate (PET), and polybutylene terephthalate (PBT); polyolefins, such as polyethylene and polypropylene staple or filament; rayon; and polyvinyl polymers such as polyacrylonitrile. A variety of deniers, plies, twist levels, air entanglement, and heatset characteristics can be used to construct the yarn. Potentially preferred materials include nylon 6,6, filament, 1360 denier, 1 ply, no twist, no entanglement, and no heatset; nylon 6,6, staple, 3.15 cotton count, 2 ply, twisted, and heat set; nylon 6,6, mixed filament with a total yarn denier of about 1360; nylon 6,6, mixed filament with a total yarn denier of about 2400; and nylon 6,6, spun fiber with a cotton count of about 1.8 cc, and 2 ply.

Although it is preferred that the yarn (or fiber) be a white or light color to facilitate injection dyeing or printing thereof, it is to be understood that the yarn may be of any nature and color such as solution dyed, naturally colored, and the like, and be adapted for dye injection printing, screen printing, transfer printing, graphics tufting, weaving, knitting, or the like.

According to one embodiment, the face weight of the yarn across the carpet will be less than about 20 ounces per square yard and will more preferably be not greater than about 15 ounces per square yard and will most preferably be not greater than about 12 ounces per square yard. It is believed that the use of no twist yarn of sufficient denier (in the range of about 1000 d to 1400 d) in non-heatset form may facilitate the achievement of plush coverage even at such relatively low face weights due to bulking which takes place during subsequent dying and steaming operations.

According to another embodiment, the face weight of the yarns across the carpet will be in the range of about 20 to 60 ounces per square yard and will preferably be in the range of about 20 to 28 ounces per square yard.

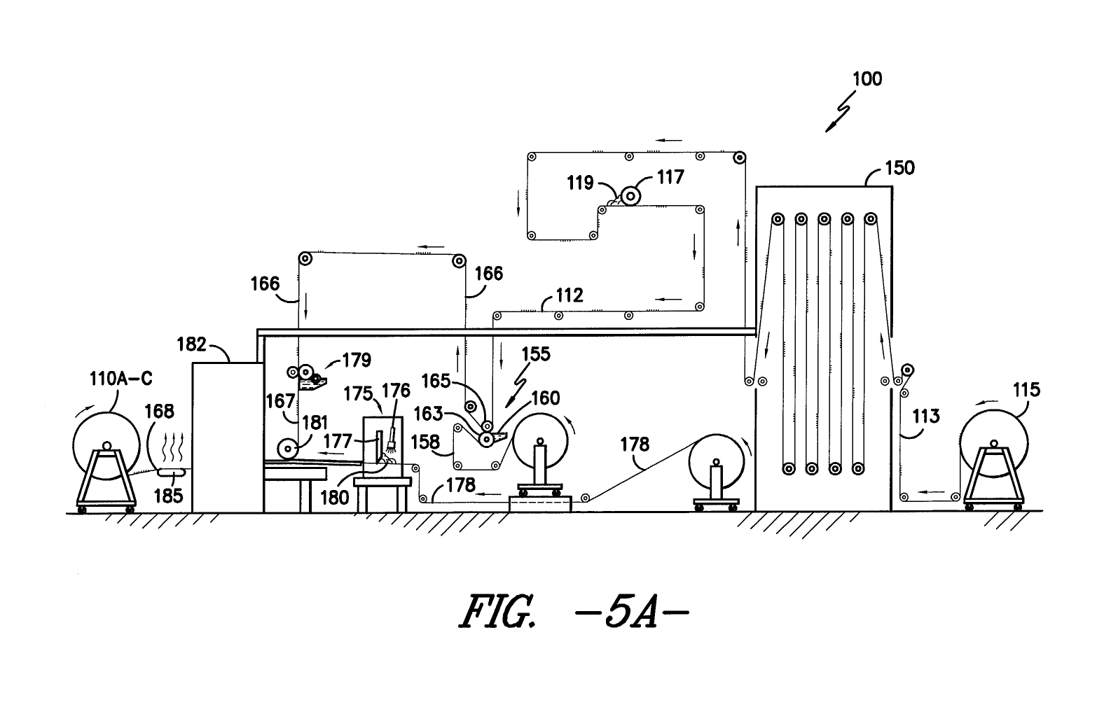

In the tufted product, the adhesive pre-coat 124 is preferably styrene butadiene rubber (SBR) latex but other suitable materials such as styrene acrylate, polyvinyl chloride (PVC), ethylene vinyl acetate (EVA), acrylic, and hot melt adhesives such as bitumen, polyurethane, polyester, polyamide, EVA, or based hot melt adhesives or blends thereof may likewise be utilized. As will be described further hereinafter, in the event that a hot melt adhesive is utilized, it is contemplated that a reinforcement material such as a fiberglass, nylon or polyester scrim woven or non-woven can be directly attached to form a composite laminate without the use of additional adhesive layers. Moreover, it is contemplated that the adhesive pre-coat 124 may be entirely eliminated in the tufted product if the loop pile 120 is tufted in suitably stable relation to the primary backing 122 thereby yielding a composite structure as illustrated in FIGS. 6A and 6B.

It is contemplated that a carpet construction according to the present invention including either a tufted or a bonded pile forming primary carpet fabric 112 may be adjoined to an underlying sheet of reinforcement material 158 by one or more layers of a resilient polymeric adhesive material 160. The polymeric adhesive material 160 may be of either a thermoplastic or a thermosetting composition. Hot melt materials may be particularly preferred. By way of example only and not limitation, useful hot melts may include bitumen, polyolefin-based thermoplastics. One potentially preferred hot melt material is polyolefin based thermoplastic. Useful thermosetting adhesives may include polyurethanes. It is contemplated that the total mass of hot melt adhesive utilized within both layers adjacent the reinforcement material will preferably be in the range of about 20 to about 100 ounces per square yard of carpet and will more preferably be present at a level of about 35 to about 90 ounces per square yard of fabric.

The reinforcement material 158 serves to enhance dimensional stability across the carpet construction to substantially prevent the various layers from undergoing disproportionate dimensional change as the carpet construction is subjected to compressive forces during use and temperature changes during use and/or processing. The reinforcement material is preferably a sheet, mat or tissue incorporating multiple fiberglass (glass) fibers entangled in a non-woven construction such as a 2 oz/yd² construction and may be held together by one or more binders such as an acrylic binder. Such a construction is believed to provide substantially uniform load bearing characteristics in all directions, which may be beneficial in some instances. Other materials as may be utilized include glass scrim materials as well as woven or non-woven textile materials such as polyester or nylon.

As illustrated in FIGS. 2, 3A, 3B and 3C, the polymeric adhesive material 160 is preferably disposed in covering relation on either side of the reinforcement material 158. It is contemplated that such an embedded relation may be achieved by any number of manual or automated techniques. By way of example only, and not limitation, one such technique as may be employed is the direct application of the adhesive material 160 to each side of the reinforcement material 158 preceding insertion between the layer of rebond cushioning or foam 178 and the primary carpet fabric 112. Of course it is contemplated that such application may be conducted by any appropriate means as may be known to those of skill in the art including by way of example only and not limitation, spray coating, dip coating, roll coating, or manual application. However, notwithstanding the actual application mechanism as may be utilized, it is contemplated that the adhesive material 160 will extend in covering relation away from each side of the reinforcement material 158. In this regard, it is contemplated that the adhesive material will preferably perform the dual functions of securing the reinforcement material 158 in place while simultaneously forming a bonding bridge between the underside of the primary carpet fabric 112 and the upper surface of the cushioning foam or rebond foam 178.

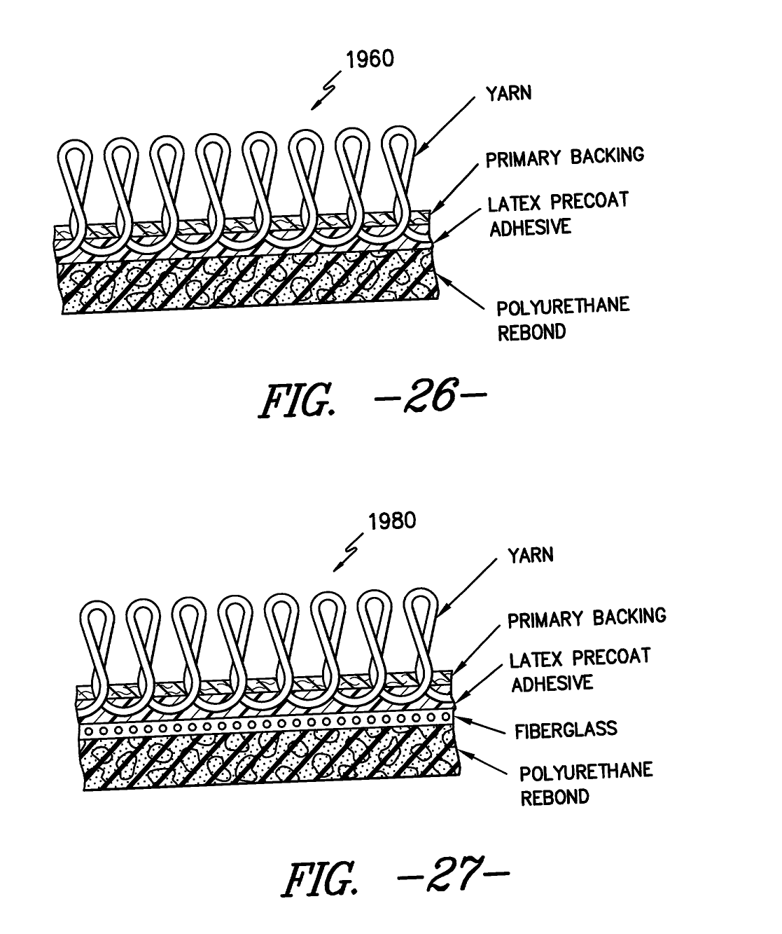

According to a simplified processing arrangement as illustrated in FIG. 2, a preformed layer of, for example, polyurethane rebond foam or compressed particle foam 178 either with or without a backing layer 170 (FIGS. 3A and 3B) or a multi-component backing composite (FIGS. 10A-C) is conveyed along a travel path to a first mating calender 191 for joinder to, for example, a non-woven sheet of glass tissue, reinforcement material 158 which has been covered on its underside with a lower coating of hot melt polymeric adhesive material 160 at a first coating station 192. An additional upper coating of hot melt polymeric adhesive 160 is thereafter applied across the upper surface of the reinforcement material 158 at a second coating station 193. Due to the high surface area and relatively porous nature of the non-woven reinforcement material, the polymeric adhesive 160 may extend at least partially through the reinforcement material while at the same time establishing a stable mechanical bond therewith. A preformed pile forming primary carpet fabric 112 as previously described is thereafter applied in overlying relation to the coated reinforcement material 158 at a second mating calender 194 such that the polymeric adhesive material 160 establishes a bond extending between the cushioning foam or rebond foam 178 and the underside of the primary carpet fabric 112. The resulting construction may be heated or cured at 198 and is substantially as illustrated in FIGS. 3A, 3B or 3C (or 6A-9B, 11A-12C, 14A-14B, or 37). By adding another coating station and mating calendar, another layer of adhesive (1071, 1371, hot melt tie-coat) can be used to attach a backing material or composite to the bottom of the foam 178 (FIGS. 10A-10C, 13A-13C, 23, 41, 42, or 43).

As described in U.S. Pat. Nos. 5,312,888; 5,817,703; 5,880,165; and 6,136,870 (hereby incorporated by reference) rebond foam or rebond polyurethane foam is known in the art of isocyanate-based polymeric foams. Specifically, it is known to mix pieces of foam with a binder which serves to bond the pieces to one another. Rebonding technology has been used for a number of years to recycle, inter alia, polyurethane foams. Generally, a large chip size, low density, non-uniform density, rather frangible, rebonded polyurethane foam product has been used as broadloom carpet underlayment or pad, and in specific seating and cushioning applications. Given the non-uniform and fragile nature as well as prior applications for such rebond foam, it is not surprising that these foams have not been used in cushion back carpet tile applications.

Polymer foams, particularly flexible polymer foams, can be fabricated into sheets, pads, blocks, or objects having useful shapes. For example, flexible foams can be molded or machined into shapes useful for preparing automobile seats, bedding, and the like. Flexible foams can be used in carpet and furniture production, as well as in the manufacture of toys and the like. However, in processes for preparing foam sheets, pads, blocks, or shaped polymer foams, waste foam can be produced. The waste foam can be from the fabricating process and represent the area/volume of the foam removed from the starting block stock (or loaf) such as the crust to form the shaped foam object. The waste foam can also be the crust, trimmings, scrapes, or off-specification products which are occasionally produced in some fabricating processes.

Whatever its source, waste foam production is usually undesirable. The waste foam can represent materials which must be discarded and not sold. In some areas, landfill space has become scarce and the cost of disposing of waste foam has become very high.

There have been efforts to recycle or re-use waste foam production, particularly waste, trim and scrap from the production of flexible foams. Flexible polyurethane foam scrap can be chopped or chipped and then coated with a binder consisting of a polyisocyanate prepolymer having isocyanate functionality and a catalyst. The coated, chopped foam is compressed and then treated with steam to cure the binder to form a rebond foam sheet or other shape.

In another process for recycling or using flexible polyurethane foam waste, the flexible foam waste is cryogenically ground and blended back into the formulation used to prepare it. The ground flexible foam can be used at a level of about 20 percent within the polyol component of the polyurethane foam formulation.

In accordance with the present invention, it is preferred to use at least about 10-90% recycled foam or rebond foam containing at least about 10-100% recycled foam chips, chunks, pieces, grounds, particles, or the like and a binder, adhesive, or prepolymer (and one or more additives) to produce a cushioned carpet composite or carpet tile having at least about 10-100% recycled foam or cushion content (especially post industrial reclaimed foam or cushion content) in the foam or cushion layer thereof.

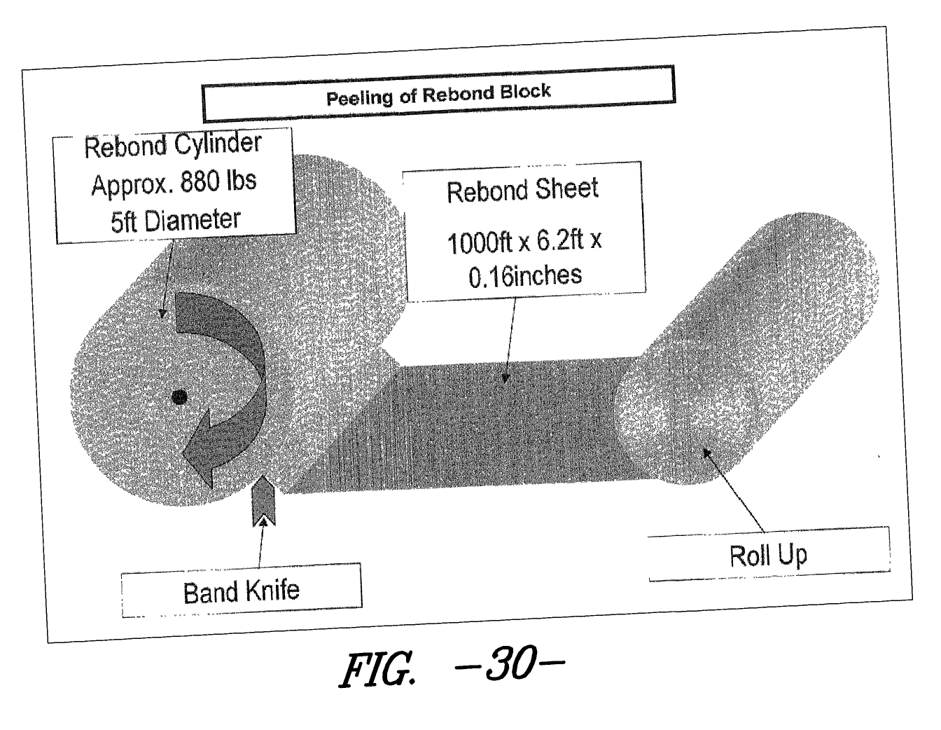

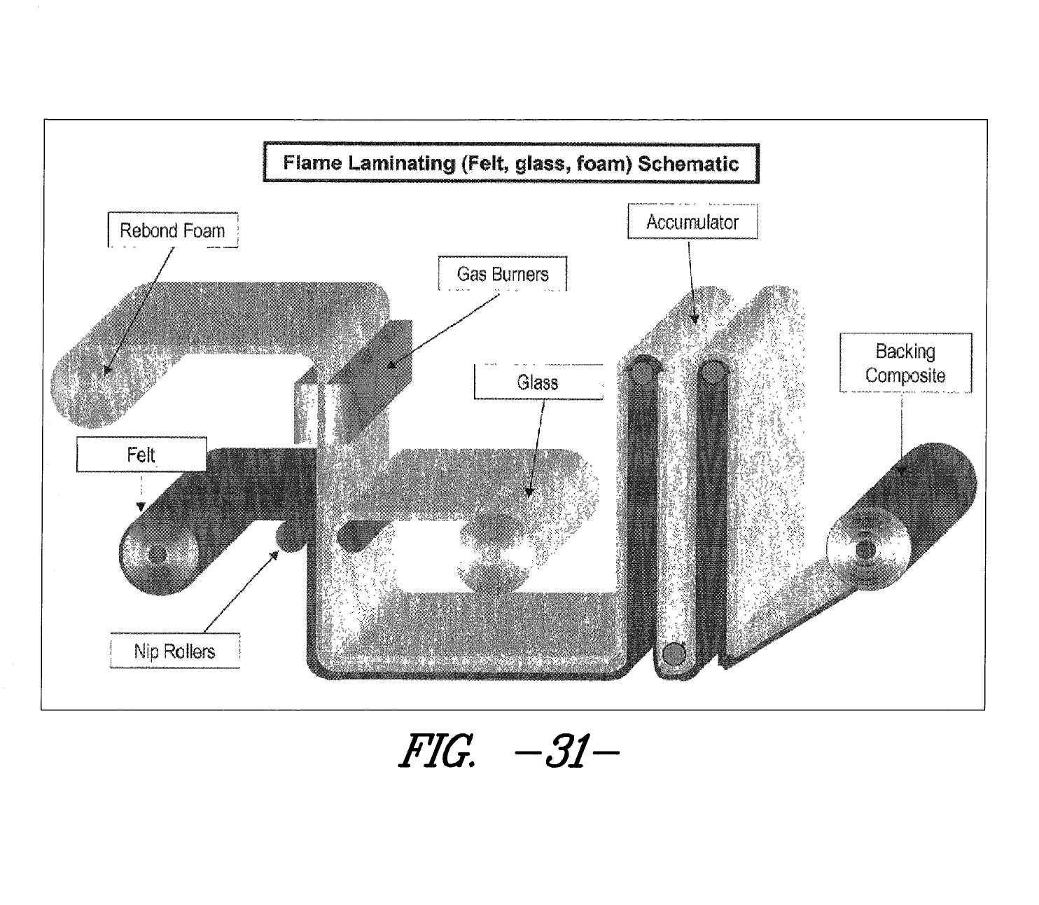

With reference to FIGS. 28-30 of the drawings and in accordance with one embodiment of the present invention, it is preferred to use a small chip size relatively high density rebond foam material formed by a process of shredding or grinding foam materials such as foam scrap or waste in a foam shredder to form foam chips, crumbs, particles which are fed to one or more storage hoppers (different densities, colors, types of foam chips can be stored in respective hoppers). The foam chips are fed from the hoppers to a blend tank wherein different colors, densities, types of chips are blended and mixed with one or more binders, adhesives, prepolymers and/or additives from one or more reactors or tanks to form a blended, mixed, chip and binder slurry (for example about 85% chips, 15% binder). The slurry is fed to a large compression cylinder or vessel, is compressed (for example 2:1-4:1) and treated with heat and steam to set or cure the rebond foam in its compressed state (compressed particle foam). After cooling, the rebond foam log or block is removed from the cylinder and mounted in a peeling or slicing apparatus having a band knife or other blade or device for cutting, slitting or peeling a rebond foam sheet or pad from the exterior of the log or roll.

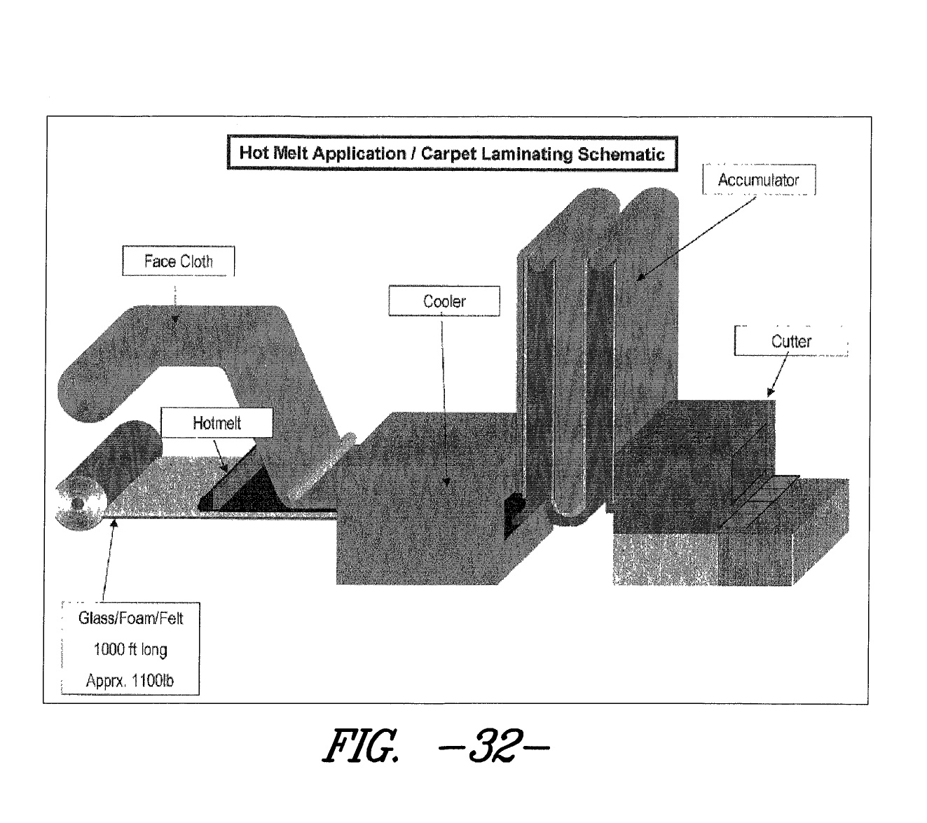

With reference to FIGS. 31 and 32, the rebond foam sheet may have one or more materials laminated to the top and/or bottom surface thereof to form a foam or cushion composite which is laminated or attached to at least a carpet or tile material or face to form a carpet composite or product.

In accordance with the present invention, it is preferred to use a rebond foam having a backing, such as a scrim, woven or non-woven material on at least one surface.

In accordance with the present invention, it is preferred to use a rebond foam or polyurethane rebond foam with a density of about 1 to 25 lbs per cubic foot, more preferably about 3-22 lbs. per cubic foot, still more preferably 10-13 lbs. per cubic foot, and most preferably 8-12 lbs. per cubic foot; a thickness of about 2-20 mm, more preferably about 2-21 mm, and most preferably about 2-7 mm; a rebond chip size (uncompressed chip size) of about 2-25 mm, more preferably about 5-15 mm, most preferably about 7-10 mm round or square hole mesh; and, a backing material or backing composite on at least one side thereof.

By way of another example, as illustrated in FIG. 4, it is contemplated that a preformed reinforcement material composite 159 including a pre-applied hot melt coating on one or both sides may be laminated to a preformed rebond foam layer 178 and primary carpet fabric 112 by heating the upper and lower surfaces of the composite 159 with heating elements 195 such as a flame 196 or the like and pressing the three preformed materials 112, 159, 178 together. If desired, heat may be applied to the resulting construction or composite at 197 to form a product such as shown in, for example, FIGS. 3A-3C, 6A-14B, and 23).

As previously indicated, due to the relatively porous nature of the reinforcement material 158, it is contemplated that the hot melt adhesive 160 may be pressed through such material. Thus, it is contemplated that the first coating station 192 in FIG. 2 may be replaced with a forced spray, roll or the like if desired to deposit hot melt adhesive 160 across both sides of the reinforcement material 158 prior to lamination.

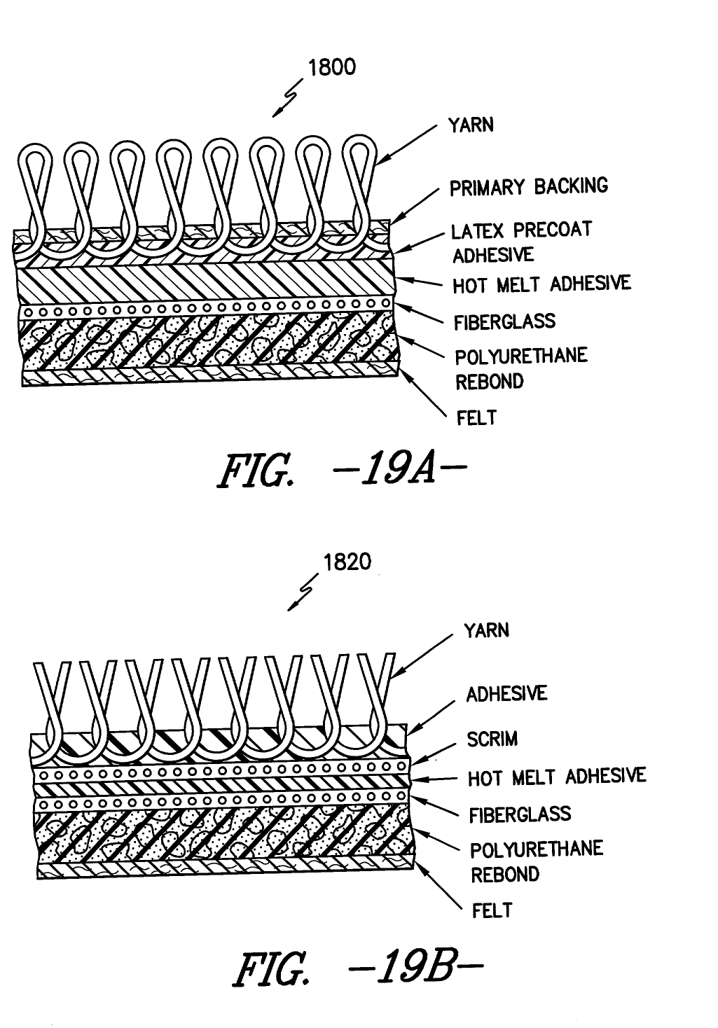

While the carpet construction according to the present invention may be formed utilizing the eloquently simple assembly or lamination processes as illustrated and described above in relation to FIGS. 2 and 4, it is contemplated that a degree of efficiency may be realized by utilizing in-situ or in-line processes for formation thereof. Referring to FIGS. 5, 17A, and 17B according to one exemplary in-line process, a primary carpet fabric 112, with or without a pre-coat underlayer, is conveyed by means of a plurality of rolls through an accumulator 150 to a reinforcement bonding unit 155. Simultaneously with the conveyance of the primary carpet fabric 112 to the reinforcement bonding unit 155, a sheet of reinforcement material 158 is likewise conveyed to the reinforcement bonding unit 155. The reinforcement material 158 is preferably fiberglass non-woven material such as a 2.0 oz/yd² fiberglass containing a urea formaldehyde binder, acrylic binder or the like although alternative materials may include by way of example only, woven glass, woven polyester, non-woven glass, and non-woven polyester.

At the reinforcement bonding unit 155, an adhesive material 160 such as a hot melt polymeric adhesive is preferably applied to at least the top surface of the reinforcement material 158 by means of a film coater or other such unit as are well known. The coated reinforcement material 158 and the primary carpet fabric 112 are thereafter preferably passed in mating relation between joining members such as rolls 163, 165, thereby bonding the coated reinforcement material 158 to the underside of the primary carpet fabric 112. That is, the reinforcement material 158 is bonded on the side of the primary carpet fabric 112 from which the pile forming yarns do not project. The bonding of the reinforcement material 158 to the underside of the primary carpet fabric produces a stabilized preliminary composite 166 to the underside of which another coating of adhesive material 160 is applied at a coating station 179 to substantially enclose the reinforcement material 158 within such adhesive material and to form a stabilized intermediate composite 167 which is thereafter laid into an adhesive, hotmelt, or a polyurethane-forming composition layer 180 on top of a preformed rebond foam layer 178 or directly onto the bare top surface of the foam layer 178 as described below.

Although the reinforcement bonding unit 155 is illustrated as incorporating a film coater, and the coating station 179 is illustrated as incorporating a vertical application roll, it is to be understood that any number of alternative means such as spray coaters, blade coaters, dip coaters, or the like may also be utilized. By way of example only, and not limitation several alternative means for the application of adhesive 160 are disclosed in U.S. Pat. No. 4,576,665 to Machell.

According to a potentially preferred practice, while the preliminary composite 166 is being formed, a preformed rebond foam layer, composite, or sheet 178 is passed through a polymer application unit 175 which preferably includes a polymer discharge unit 176 and a doctor blade 177. The foam layer 178 is coated with an adhesive or polymer 180 such as a polyurethane-forming composition as disclosed more fully below.

In the preferred embodiment, the preformed foam layer 178 may include a backing material 170 such as woven or non-woven about 10% to 100% polyester/90%-0% polypropylene, preferably about 50% polyester/50% polypropylene non-woven fibrous material or felt such as is available from Synthetic Industries of Ringold, Ga. and which may contain a colorant or binder such as acrylic binder. While this represents the backing material of preference, it is to be understood that any number of alternative compositions or composites may likewise be utilized as dictated by requirements regarding shrinkage and installation. The commonly used secondary backing materials include non-woven polyester, non-woven polyester and polypropylene blends, or woven polypropylene. By way of example only, in instances where very little or no shrinkage may be tolerated, the backing material may be up to 100% polyester. Further, while a non-woven backing material may be preferred, it is contemplated that either woven or non-woven constructions may be utilized as can materials other than the polyester/polypropylene mix such as acrylic, nylon, fiberglass, and the like.

As indicated, in the preferred practice the polymer application unit 175 applies a deposit of a polymer 180 on the top of the cushion or foam layer 178 (FIGS. 5, 5A, 17A, 17B) after which the height of the polymer layer is doctored to a desired level. In the preferred practice, the polymer applied is a polyurethane-forming composition based on a so-called soft segment pre-polymer of MDI (diphenylmethane diisocyanate) or an MDI derivative. The polyurethane-forming composition also preferably incorporates a silicone surfactant to improve both the frothability and stability of the polyurethane layer or “puddle” 180 which is spread across the surface of the preformed foam layer 178.

The foam density of the preformed foam layer 178 is preferably in the range of about 1-25 lbs. per cubit foot, preferably about 6 to about 20 lbs. per cubic foot with a thickness of about 0.04 to about 0.5 inches, preferably about 0.04 to about 0.12 inches. According to one potentially preferred arrangement, the foam density is about 16 lbs. per cubic foot or less with a thickness of about 0.06 inches although it is contemplated that such levels may vary greatly depending upon desired product characteristics.

It is contemplated that the material forming the layer 180 and the preformed foam or rebond cushion 178 may be the subject of a broad range of alternatives. By way of example only and not limitation, at least four options or examples of the layer 180 and/or foam cushion material 178 are believed to be viable to yield commercially acceptable foam products using virgin polyurethane and/or recycled polyurethane chips, chunks, granules, etc.

1. Use of standard filled Polyurethane system as the virgin and/or rebond polyurethane. One polyurethane foam contains 110 parts of filler and is applied at a density of about 15 lbs/cu. ft. If the thickness is in the range of 0.04-0.12 and we determine polymer weight only, using the density and filler levels above, the weight range of the polymer would be 4.32 oz/sq yd to 12.96 oz/sq yd.

2. A second option which would also work for the virgin and/or rebond polyurethane would be to increase the filler levels to 190 and reduce the density to 13 lbs/cu. ft. At the same thickness limits the polymer weights would then be 2.72-8.24 oz/sq. yd.

3. A third option for the virgin and/or rebond polyurethane would be to use an unfilled polyurethane (Prime urethane) system. High densities such as above are not possible with prime however, they perform because of the wall structure and the fact that no filler is present. If we consider a prime to be at 6 lbs/cu. ft. applied at the thickness limits above the polymer weight would be 2.88-8.64 oz/sq. yd.

4. A fourth option for the virgin and/or rebond polyurethane is also possible. Textile Rubber has a polyurethane system available under the trade designation KANGAHIDE which has only 15 parts of a filler material and is applied at 6-9 lbs/cu. ft. density, if a polymer calculation is again made at the described thickness limits it would be 4.3-13.02 oz/sq. yd.

Although the above examples have to do with polyurethane, a water based foam system can also be used. Although a polyurethane rebond foam or compressed particle foam (formed of compressible particles, chips, crumbs, etc.) is preferred, it is understood that other compressible particles made from other foams (open cell, closed cell) or materials such as SBR foam, PVC foam, polyethylene foam, cork, rubber, and/or the like may be used.

A potentially preferred polyurethane-forming composition for use as the polymer 180 and the virgin and/or rebond polyurethane chips in the rebond foam 178 of the present invention is disclosed in U.S. Pat. No. 5,104,693 to Jenkines the teachings of which are incorporated herein by reference. Specifically, the preferred polyurethane-forming composition which is used as the virgin and/or rebond polyurethane in the rebond foam and/or which is applied across the surface of the foam layer 178 includes:

A. At least one isocyanate-reactive material having an average equivalent weight of about 1000 to about 5000;

B. An effective amount of blowing agent; and

C. A polyisocyanate in an amount to provide an isocyanate index of between about 90 and about 130, wherein at least 30 percent by weight of such polyisocyanate is a soft segment pre-polymer reaction product of a stoichiometric excess of diphenylmethane diisocyanate (MDI) or a derivative thereof and an isocyanate-reactive organic polymer having an equivalent weight of from about 500 to about 5,000 and wherein the a prepolymer has an NCO content of about 10 to about 30 percent by weight.

The polyurethane-forming composition also preferably contains a silicone surfactant to improve frothability and stability in the form of an Organo-silicone polymer such as are disclosed generally in U.S. Pat. No. 4,022,941 to Prokai et al. the teachings of which are incorporated herein by reference. Specifically, the preferred surfactant is preferably a linear siloxane-polyoxyalkylene (AB) block copolymer and specifically a polyalkyleneoxidemethylsiloxane copolymer. One such silicone surfactant which is particularly useful is available under the trade designation L-5614 from OSI Specialties, Inc. whose business address is believed to be 6525 Corners Parkway, Suite 311, Norcross, Ga. 30092.

A sufficient level of the silicone surfactant is used to stabilize the cells of the foaming reaction mixture until curing occurs to allow the preliminary composite 166 to be laid into the uncured polyurethane-forming composition puddle 180 without destabilizing the layer of such polyurethane-forming composition disposed across the surface of the foam layer 178. In general, the silicone surfactants are preferably used in amounts ranging from about 0.01 to about 2 parts per hundred parts by weight of component (A) and more preferably from about 0.35 parts to about 1.0 parts by weight of component (A) and most preferably from about 0.4 to 0.75 parts per hundred parts by weight of component (A).

As previously indicated, after disposition of the polyurethane-forming polymer 180 across the foam layer 178 the layer or “puddle” of the polymer deposited is preferably doctored to a pre-determined height by means of a doctor blade located at the polymer application unit 175. While a simple mechanical doctor blade is preferred, alternative equivalent means such as an air knife, spay coating, roller coating, or the like may also be used. Such an air knife is disclosed, for example, in U.S. Pat. No. 4,512,831 to Tillotson (incorporated by reference).

In one embodiment of the present invention, the intermediate composite 167 of the primary carpet fabric 112, which is preferably joined to the coated reinforcement material 158, can be laid directly into the polyurethane-forming composition 180 immediately after it is doctored to the appropriate level without any need to significantly heat either the intermediate composite 167 or the polyurethane-forming composition 180. Accordingly, the intermediate composite 167 and the foam layer 178 with the applied polyurethane-forming composition 180 may be simultaneously delivered at room temperature to a mating roll 181 immediately following the application and doctoring of the polyurethane-forming composition. As will be appreciated, the use of rebond foam 178 reduces cost and produces a composite having a high recycled foam content. In the preferred process, at least one side of the intermediate composite 167 may be slightly preheated to improve operating control during lamination and curing but such preheat is not essential to formation of the desired product.

In the illustrated embodiment of the in-line or in-situ carpet construction, the process described above results in the adhesive material 160 being laid adjacent to and extending away from the layer of cushioning foam 178 to the underside of the primary carpet fabric 112 with the layer of reinforcement material being embedded in intimate relation within the adhesive material 160 at a location intermediate the cushioning foam and the primary carpet fabric 112. Thus, at least a portion of the adhesive material 160 extends away from either side of the reinforcement layer 158.

Once the intermediate composite 167 has been laid into the polyurethane-forming composition 180, the resulting final composite 168 may be heated or cured in a heating unit 182 by means of conduction, radiant, or convection heaters as are well known in the art. Contact conduction heaters may be preferred. Such heating may be carried out at a temperature of between about 250° F. and about 325° F. for between about 2 minutes and 8 minutes. Following the heat curing operation, the final cushioned carpet composite 168 that is formed may be passed over a unidirectional heat source 185 such as a plate heater or roll heater at about 400° F. to fuse any outstanding fibers on the backing material 170 into a sooth surface. The carpet composite 110A, 110B, 110C (FIGS. 3A-3C) that is formed will thereafter be cooled, rolled, cut, sliced, or the like. When making carpet tiles, it is preferred that it be cut into carpet tiles almost immediately (rather than rolled) to avoid any undesired cupping or curl. After the carpet tiles are cut from the composite 168, they are printed or dyed, washed, fixed, dried, cooled, stacked, packaged, stored, and/or shipped to the customer.

It will be appreciated that a number of alternative practices may be incorporated into the present invention yielding a finished construction wherein the reinforcement layer 158 is enclosed within the adhesive material 160. In accordance with another example of the present invention, the primary carpet 112 is a loop pile tufted carpet formed by tufting, for example, a non-heatset yarn through the primary backing, then washing, steaming, drying, and injection or jet dying thereon a, preferably, monolithic or orientation independent design, color, or pattern to form, for example, a 12 foot wide primary carpet precursor of loop pile 120 and primary backing 122. By using a non-heatset yarn, and originally tufting the yarn at a rather long loop length, the washing, steaming, drying, and dying steps shrink the yarn to form smaller, tighter loops and provide a denser surface to the primary carpet precursor. Next, this primary carpet precursor is split in half and rolled to form, two separate six foot wide rolls 115 of split primary carpet precursor 113 (FIG. 5A).

Next, one roll 115 of the split primary carpet precursor 113 is used as the initial carpet feed in the apparatus of FIG. 5A. A latex pre-coat or hot melt adhesive coat 124 is added to the back of the primary carpet precursor 113 to form a primary carpet fabric 112 in the upper run of the apparatus of FIG. 5A downstream of the accumulator 150 and upstream of the reinforcement bonding unit 155. For example, a thin layer of latex pre-coat 119 is applied to the back of the primary carpet precursor 113 using a coating roller 117. The remainder of the process proceeds as described above in relation to FIG. 5.

In accordance with yet another potential practice and as shown in FIG. 5B, it is contemplated that the cushioning foam or rebond foam 178 may be delivered in a preformed condition to the mating roll 181 for bonding to the intermediate composite 167 which may be formed as previously described in relation to FIGS. 5 and 5A. As will be appreciated, such a preformed cushioning foam 178 may be formed with the desired backing material 170 or multi-component backing composite (FIGS. 10A-C and 13A-C) disposed across its underside. Also, the upper surface of the preformed foam layer 178 may be heated by, for example, heater 195 and flame 196 to heat or melt the upper surface and enhance the attachment of composite 167 to foam layer 178.

Further, roll applicator 179 of FIG. 5B may be eliminated and heater 195 and flame 196 can be used to cause the foam layer 178 to adhere to the reinforcement material 158 of composite 166.

Similarly, the polymer application unit 175 or roll applicator 179 of FIGS. 5 and 5A may be eliminated and the composite 166 or 167 may be joined to the foam layer 178 by the adhesive 160 or polymer 180.

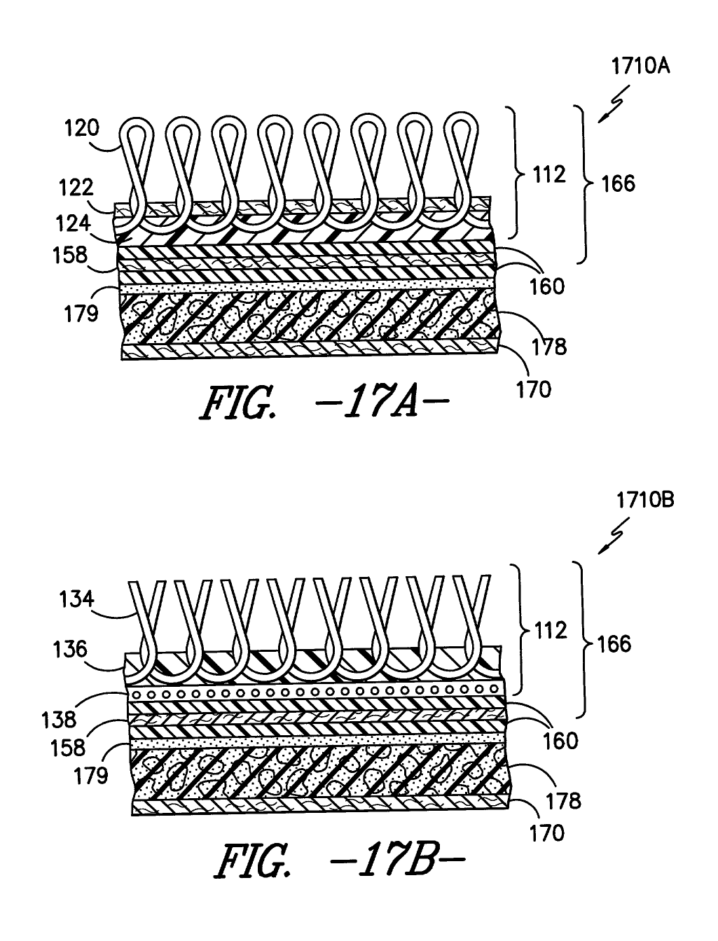

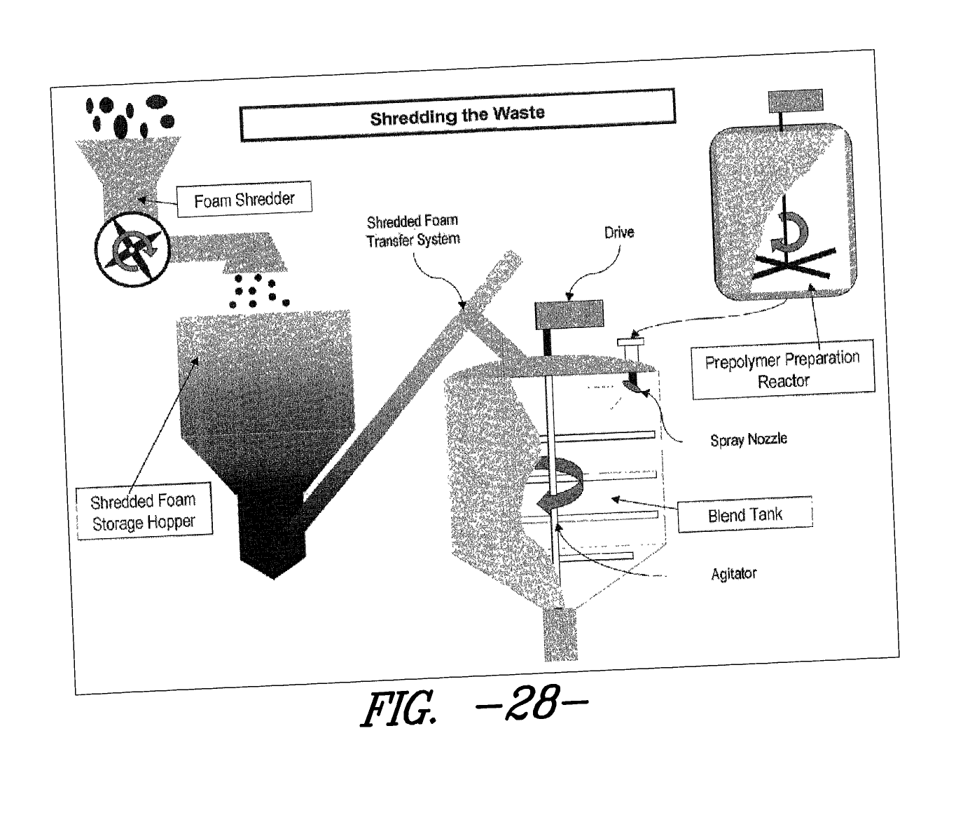

Also, reinforcement material 158 or composite 159 and its associated coating bonding unit may be eliminated from the process of FIGS. 2, 4, 5, 5A, and/or 5B when an additional reinforcement layer or material is not needed or desired or when the reinforcement material is already attached to or part of the carpet and/or foam or cushion (FIGS. 15A, 15B, 16A, 19A, 19B, 20, 21, 22, 24, 25, and 36).

It is contemplated that the apparatus of the present invention may include the entire assembly process from tufting the yarn in the primary backing, dying the tufted yarn, latex pre-coating the back of the primary backing, hot-melt coating the fiberglass reinforcing material, forming the cushion or foam with or without the felt secondary backing, laminating the primary carpet, reinforcing fiberglass, and foam or cushioning layer, heating or curing the laminate, and cutting the resultant carpet composite into carpet tiles, runners, area rugs, or the like, dying or printing the cut tiles, and packaging the resulting products. Also, it is contemplated that in accordance with the present invention the process may be broken down into its respective steps and done in a batch rather than a continuous mode. For example, the primary carpet may be formed in one operation and placed on rolls or folded into bins. The cushion, backing or foam layer may be formed in a separate operation and placed on rolls or folded into bins. The preformed primary carpet and cushion backing may be joined by a mating unit using an adhesive, hot melt, hot melt with reinforcing layer, or the like. Also, the hot melt and reinforcing material composite may be preformed and placed on rolls or folded into bins. Still further, the preliminary composite 166, intermediate composite 167, or final composite 168 (FIGS. 5, 5A, 5B) may be preformed and placed on rolls or folded into bins.

As will be appreciated, there exist a substantial number of alternative embodiments and configurations for foam backed or cushioned carpeting or carpet tile that may incorporate features of the present invention. As illustrated in FIGS. 6A and 6B, wherein like components to those previously described are designated by corresponding reference numerals within a 600 series, it is contemplated that tufted loop pile and tufted cut pile constructions 610A and 610B include a first layer of hot melt adhesive 660 which extends away from the primary backing 622 and into contact with a sheet of reinforcement material 658 such as the non-woven glass or scrim material previously described. Thus, the first layer of hot melt adhesive 660 serves the function of securing the tufts 620, 621 in place relative to the primary backing 622 thereby avoiding the need to utilize a separate latex or hot melt pre-coat. A second layer of hot melt adhesive 660 extends away from the reinforcement material 658 into contacting relation with the foam cushion or rebond material 678 to establish a bonding relation between the primary carpet 612 and the foam cushion or rebond material 678. Accordingly, a single adhesive layer extends between the upper surface of the reinforcement material 658 and the underside of the primary backing 622. By way of example only and not limitation, it is contemplated that such a construction may be realized as shown in FIGS. 2, 4, 5, or 5B or by eliminating the latex pre-coat 119 in FIG. 5A, but otherwise carrying out the operation in the manner as previously described.

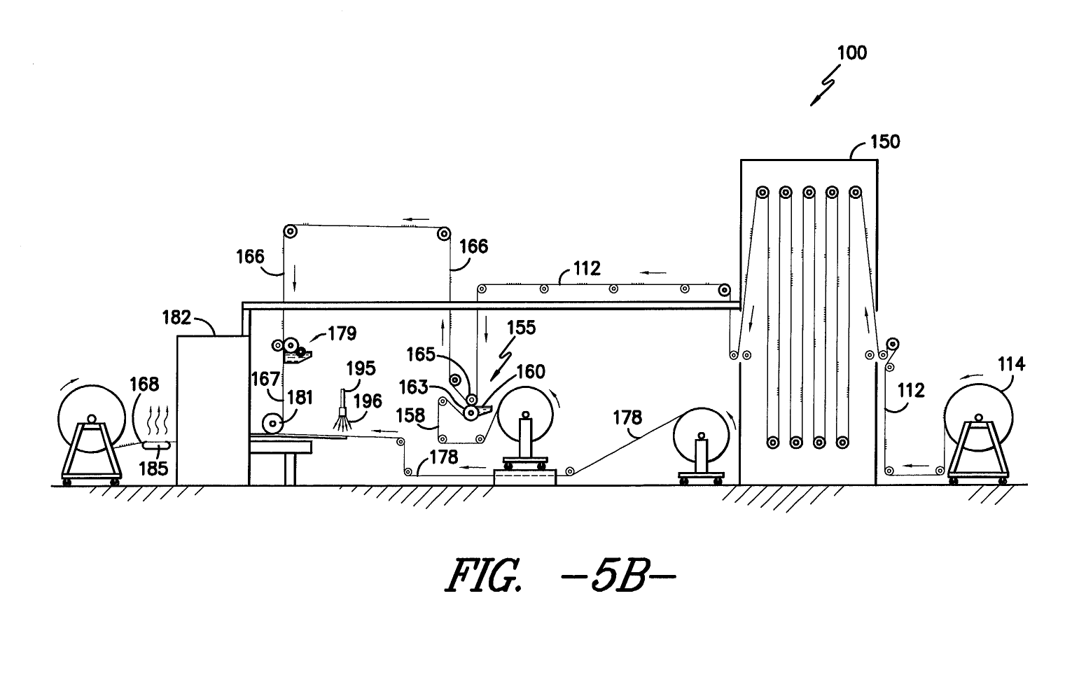

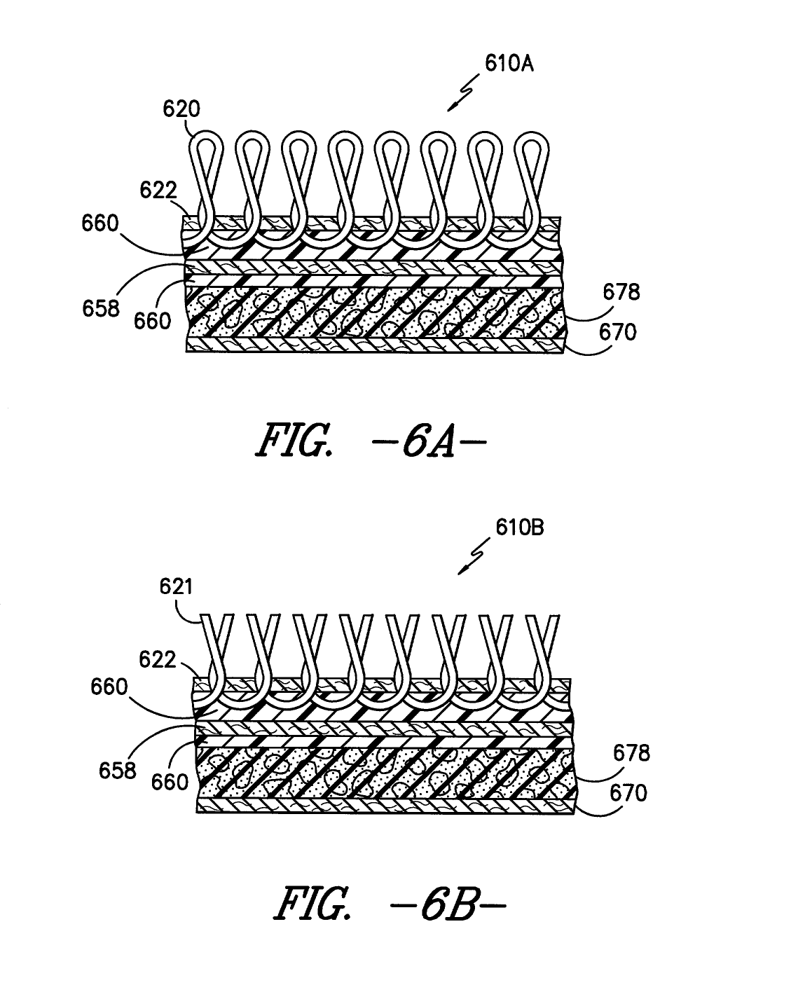

As illustrated in FIGS. 7A, 7B and 7C wherein like components to those previously described are designated by corresponding reference numerals within a 700 series, it is contemplated that tufted loop pile construction 710A, tufted cut pile construction 710B, and bonded cut pile construction 710C include a first layer of resilient adhesive 760 extending away from the upper surface of a layer of reinforcement material 758 and which may be of a different character from a second layer of resilient adhesive 760′ extending away from the lower surface of the reinforcement material. In all other respects, the configuration is substantially as illustrated and described in relation to FIGS. 3A, 3B and 3C or 6A and 6B with assembly being carried out by any of the techniques illustrated and previously described in relation to FIGS. 2, 4 and 5A-C. By way of example only and not limitation, in the event that the reinforcement material 758 is disposed between two different adhesives, it is contemplated that the adhesive 760 extending away from the upper surface of the reinforcement material 758 may be, for example, hotmelt, while the adhesive 760′ extending away from the lower surface of the reinforcement material 758 may be, for example, polyurethane forming composition. Also, adhesive 760 of FIGS. 7A and 7B may be multiple layers of the same adhesive.

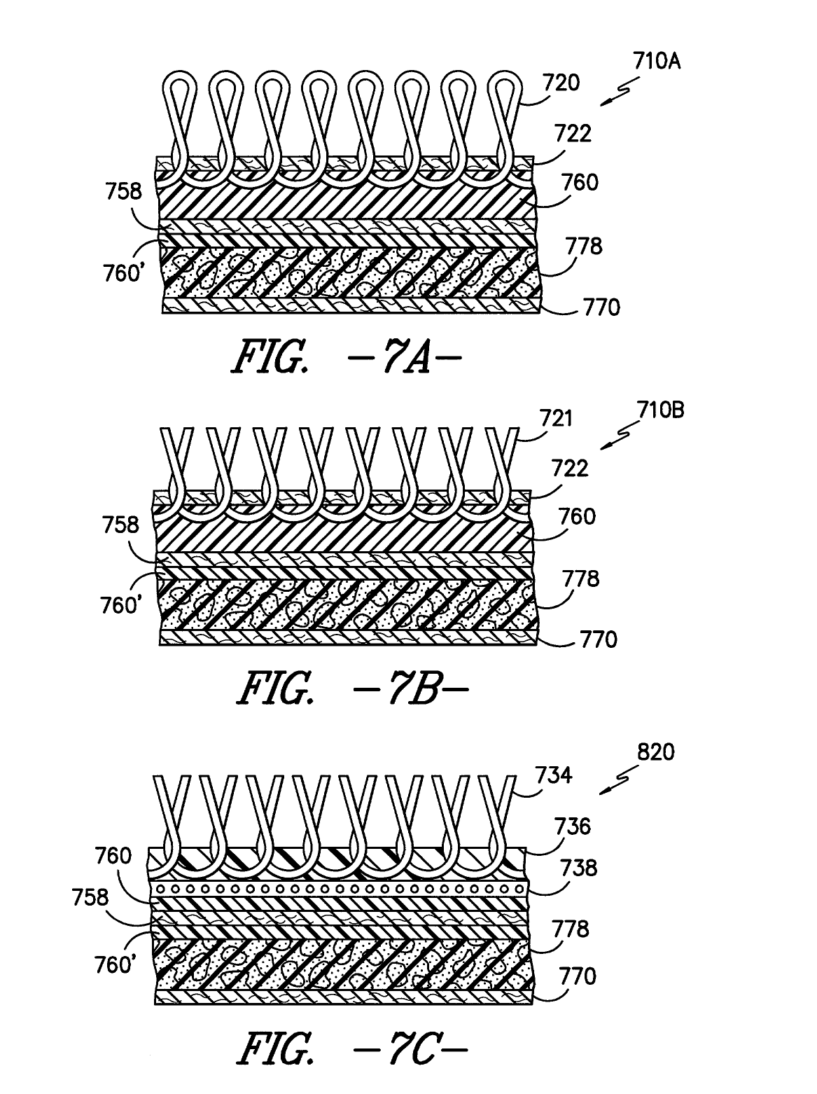

In FIGS. 8A and 8B wherein like components to those previously described are designated by corresponding reference numerals within an 800 series, there are illustrated yet additional potential embodiments of the present invention. In such embodiments, tufted loop pile construction 810A and tufted cut pile construction 810B include a layer of reinforcement material 858 disposed between a first layer of latex adhesive 824 extending away from the upper side of the reinforcement material 858 and a second layer of latex adhesive 824 extending away from the lower side of the reinforcement material 858. Thus, latex extends substantially between the upper surface of the cushion or foam 878 and the primary backing 822 with the layer of reinforcement material 858 disposed within such latex at an intermediate position. Such latex is preferably a carboxilated styrene butadiene rubber (SBR) latex. Of course it is also contemplated that similar constructions utilizing other adhesives such as Polyvinyl Chloride (PVC), ethylene vinyl acetate (EVA), and acrylics as well as hot melts or polyurethanes as previously described may be useful.

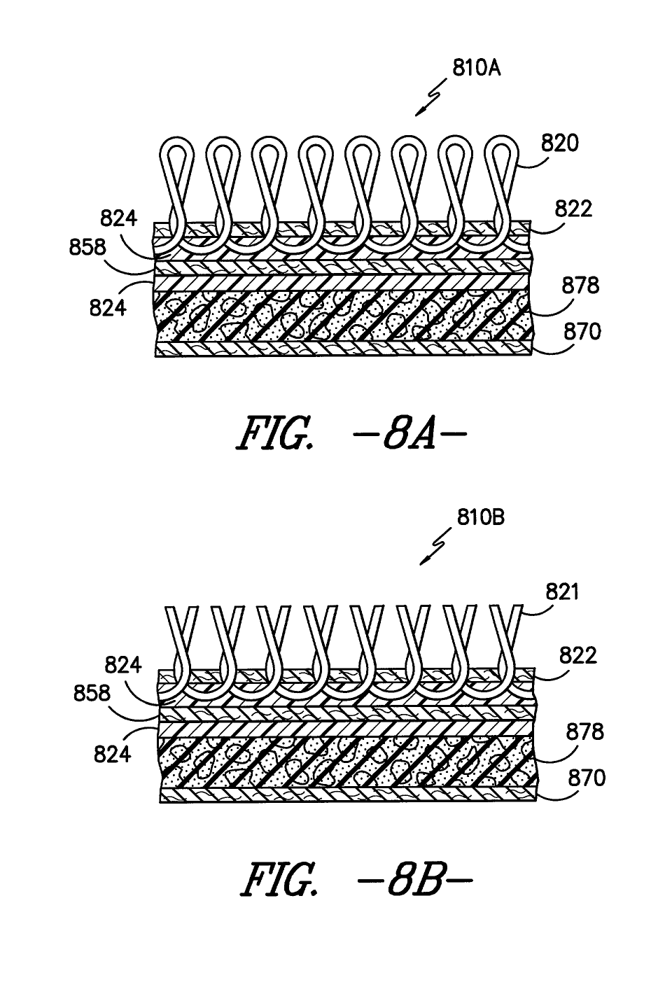

As previously indicated, it is contemplated that additional stability may be applied to the construction of the present invention by incorporating stabilizing elements in intimate relation to the primary backing of a tufted primary carpet. Exemplary embodiments incorporating such configuration are illustrated in FIGS. 9A and 9B wherein like components to those previously described are designated by corresponding reference numerals within a 900 series. As illustrated therein, tufted loop pile construction 910A and tufted cut pile construction 910B include pile forming yarns 920, 921 tufted through a primary backing 922 which incorporates therein a non-woven or scrim primary backing stabilizing layer 923. The primary backing stabilizing layer 923 may be adjoined to the primary backing 922 by a needling or calendering operation. In addition, point bonding may be achieved between the structures by incorporating heat activated adhesive fibers within the non-woven construction. In the event that a construction incorporating a primary backing stabilizing layer is utilized, it is contemplated that the pre-coat 924 and/or the reinforcement material 958 may be substantially reduced or even eliminated entirely if desired due to the stability imparted to the enhanced primary backing 922, 923.

In FIGS. 10A-C there are illustrated several potential preferred embodiments 1010A, 1010B, 1010C wherein like components to those previously described are designated by corresponding reference numerals within a 1000 series. As will be appreciated, such embodiments correspond substantially to those illustrated and described in relation to FIGS. 3A-C with the exception that the backing material 1070 is not in direct contacting relation to the foam cushion or rebond foam 1078. Rather the backing is bonded or laminated to the foam by an adhesive or a multi-component composite backing is applied across the underside of the foam cushion 1078. According to the relatively simple embodiment illustrated, such composite backing 1070, 1071 includes a relatively thin layer of hot melt or other resilient adhesive 1071 extending in bonding relation between the underside of the foam cushion 1078 and the backing material 1070 of woven or non-woven construction as previously described. The thickness of such hot melt or other resilient adhesive is preferably not greater than about 40 oz/yd² and will most preferably be about 20 oz/yd² or less. As will be appreciated, it is contemplated that the multi-component composite may include virtually any number of layers of different materials including by way of example only and not limitation, release layers, additional adhesive layers, and/or stabilizing layers in various arrangements as may be deemed useful. Moreover, while the multi-component composite backing has been illustrated in relation to carpet constructions substantially corresponding to those illustrated and described in FIGS. 3A-C it is to be understood that such composite backings may likewise be used in any number of other constructions including, for example, those of FIGS. 6A-B, 7A-C, 8A-B, or 9A-B, but not limited to those previously described hereinabove.

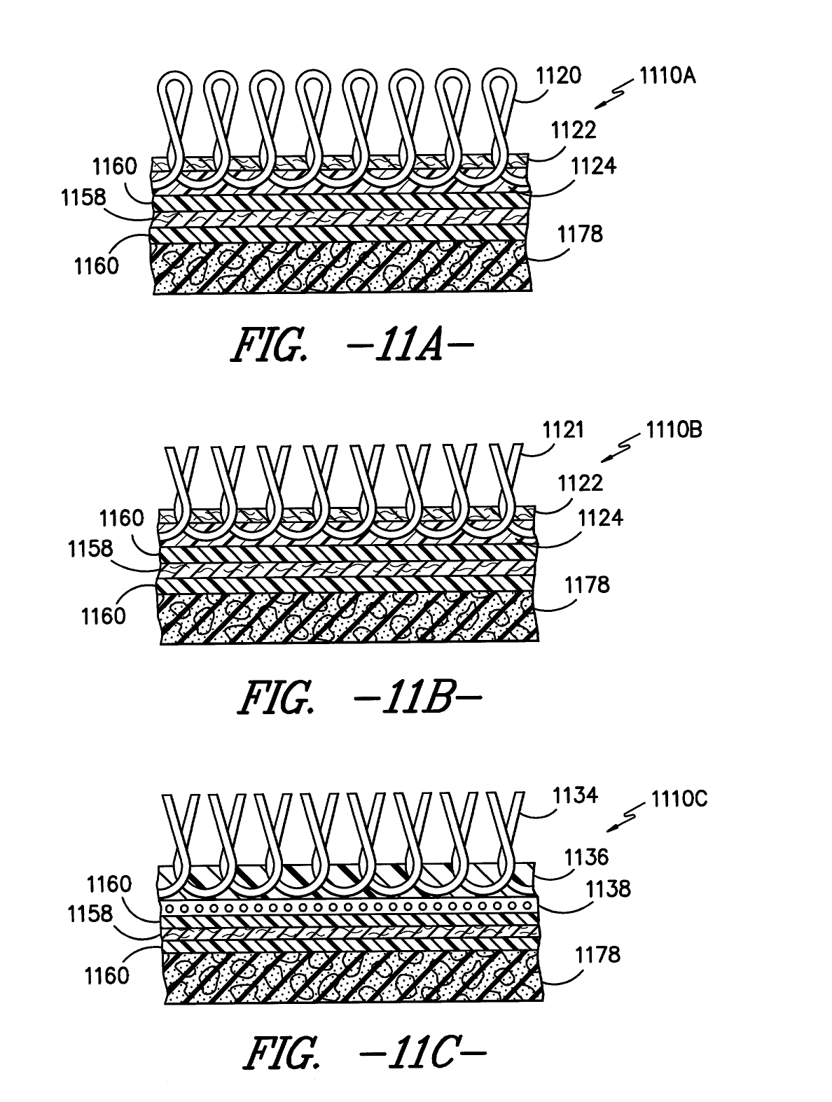

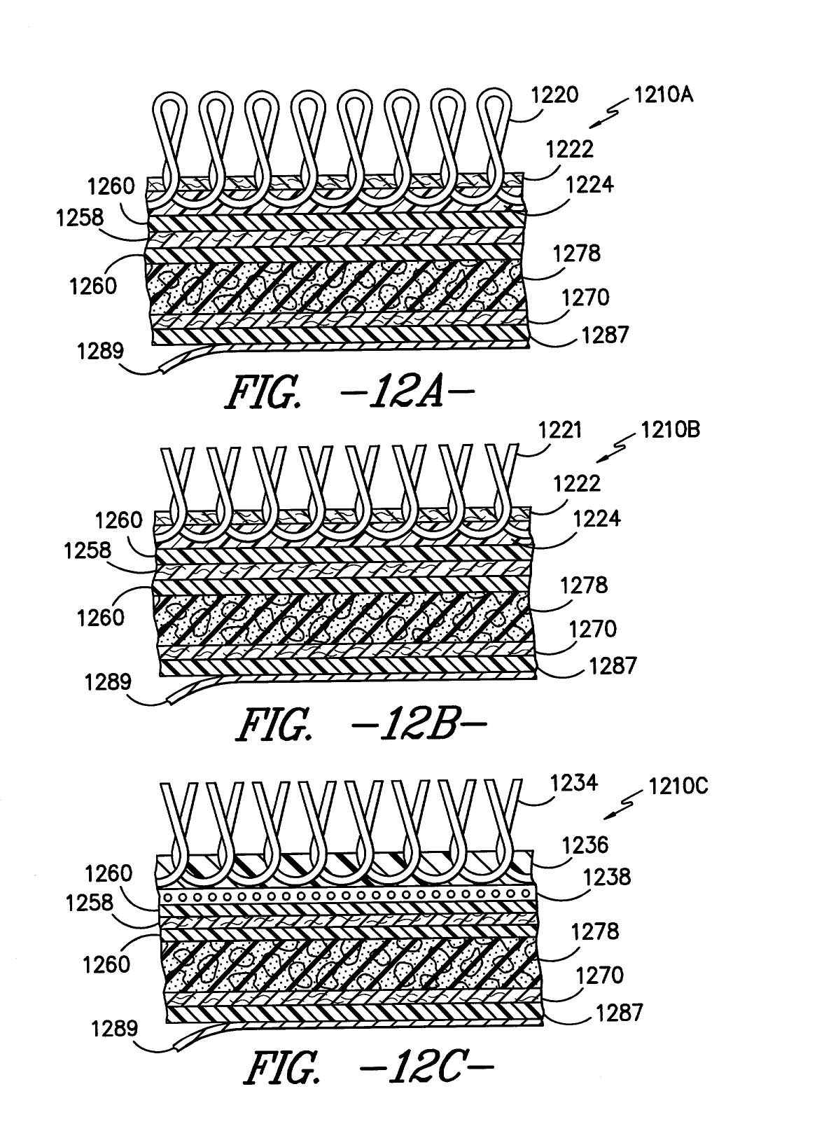

Yet another set of alternative configurations are illustrated in FIGS. 11A-C wherein like components to those previously described are designated by corresponding reference numerals within an 1100 series. As illustrated, these embodiments 1110A, 1110B, 1110C correspond substantially with those of FIGS. 3A-C except that the foam cushion or rebond foam 1178 is substantially free of any supplemental backing. As will be appreciated, while the absence of a supplemental backing has been illustrated in relation to carpet constructions substantially corresponding to those illustrated and described in FIGS. 3A-C it is to be understood that such practices may likewise be used in any number of other constructions including, for example, those of FIGS. 6A-B, 7A-C, 8A-B, 9A-B, or 10A-C but not limited to those previously described.

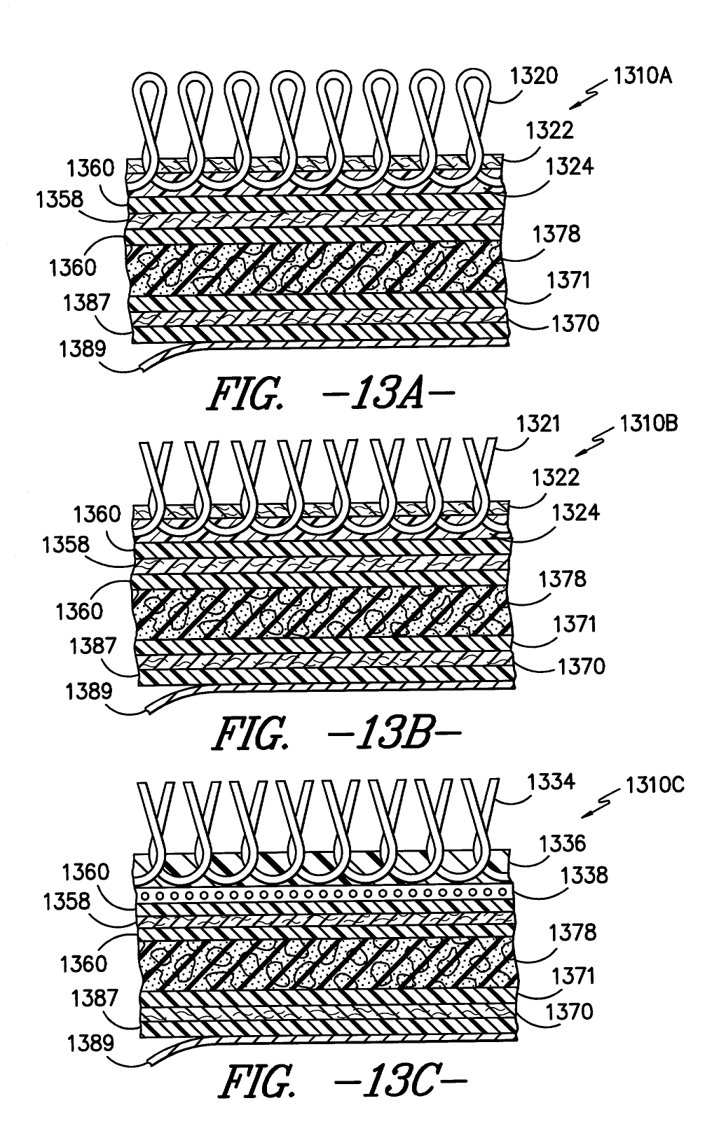

In FIGS. 12A-C there are illustrated several alternative embodiments wherein like components to those previously described are designated by corresponding reference numerals within a 1200 series. As will be appreciated, such embodiments 1210A, 1210B, 1210C correspond substantially to those illustrated and described in relation to FIGS. 3A-C with the exception that the backing material 1270 includes a thin layer of tacky releasable adhesive 1287 and access layer 1289 disposed across the undersurface. The thin access layer 1289 of paper or other suitable film or material is disposed in peel-away relation below the releasable adhesive so as to permit an installer to expose the releasable adhesive during installation. As will be appreciated, such releasable or peel and stick adhesive provides a relatively weak bond in tension while providing a stronger bond in shear such that a carpet element such as a carpet tile can be pulled away from an underlying surface but will be substantially resistant to undesired sliding movement. The thickness of such releasable adhesive is preferably not greater than about 20 oz/yd² and will most preferably be about 5 oz/yd² or less. As will be appreciated, while the releasable adhesive backing has been illustrated in relation to carpet constructions substantially corresponding to those illustrated and described in FIGS. 3A-C it is to be understood that adhesive backings may likewise be used in any number of other constructions including but not limited to the constructions of FIGS. 6A-B, 7A-C, 8A-B, and 9A-B as well as those having bare foam undersides in FIGS. 11A-C.

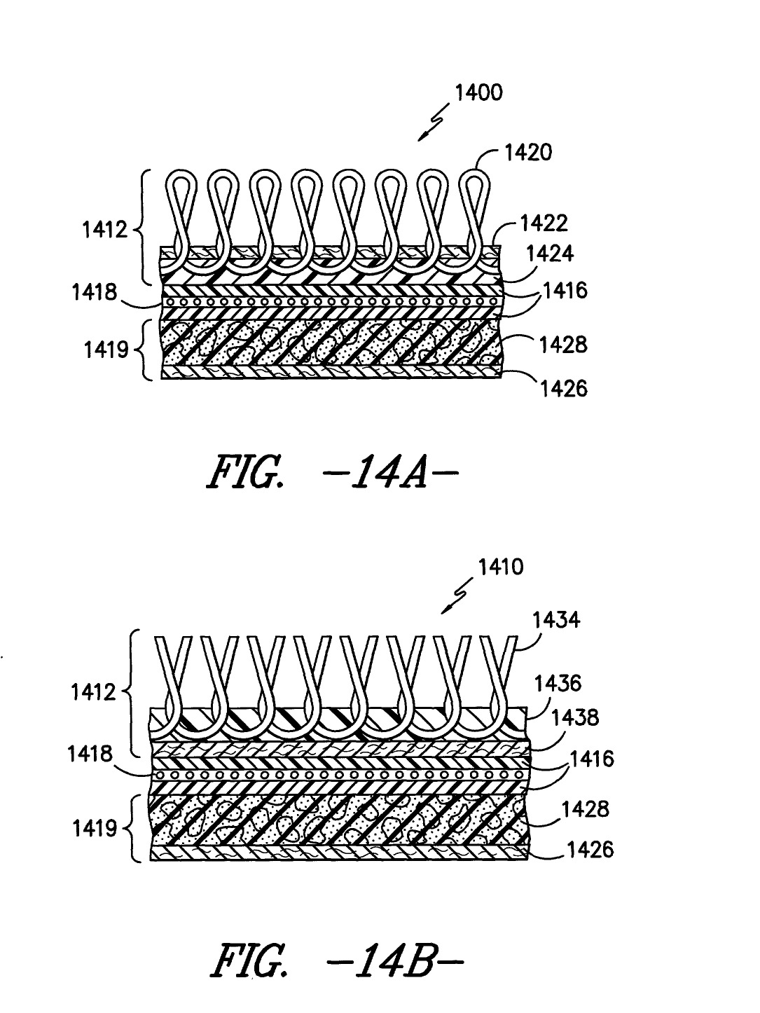

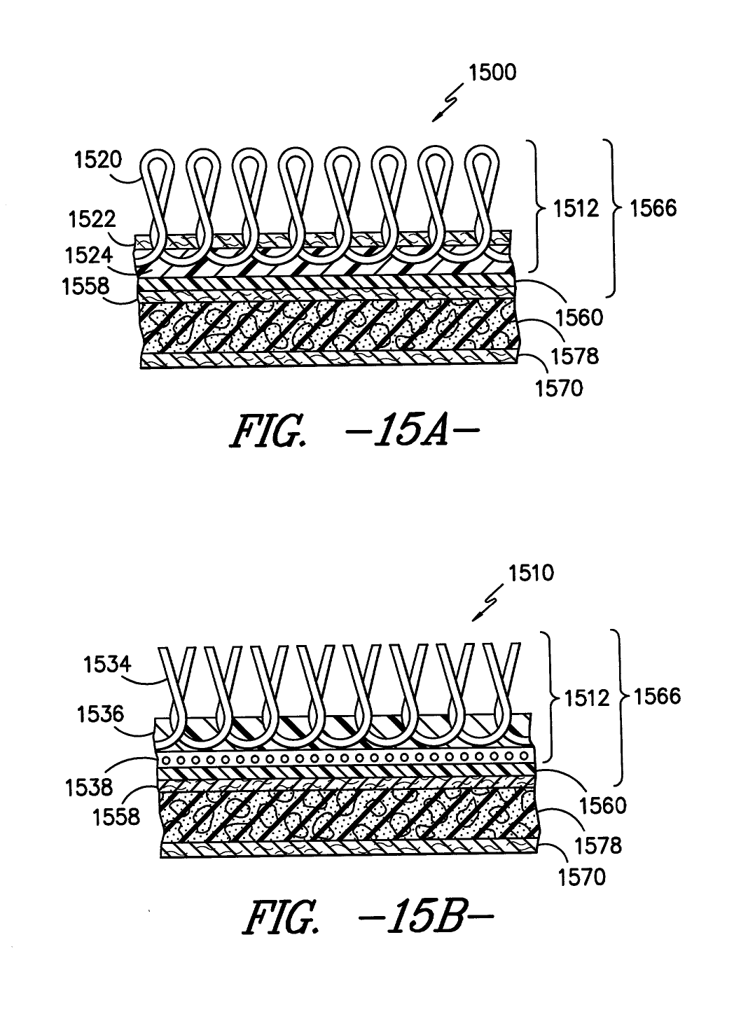

As shown in FIGS. 13A-C wherein like components to those previously described are designated by corresponding reference numerals within a 1300 series, it is contemplated that carpet constructions 1310A, 1310B, 1310C include a releasable adhesive backing 1387, and access layer 1389 may be incorporated as the lower surface elements of a multi-component composite backing 1370, 1371 as previously described in relation to FIGS. 10A-C.

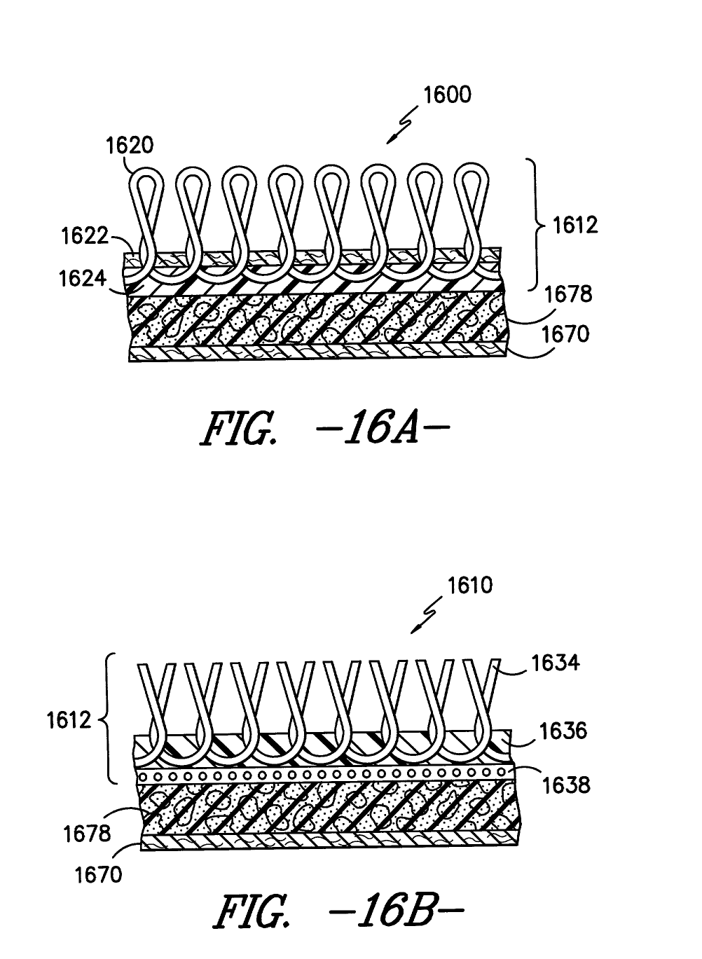

Alternative examples of a tufted carpet product 1400 is illustrated in FIG. 14A and of a bonded carpet product 1410 is illustrated in FIG. 14B.

In the tufted carpet of FIG. 14A, a primary carpet fabric 1412 is embedded in an adhesive layer 1416 in which is embedded a layer of glass scrim 1418. A rebond foam base composite 1419 is likewise adhesively bonded to the adhesive layer 1416. In the tufted carpet illustrated in FIG. 14A, the primary carpet fabric 1412 includes a loop pile layer 1420 tufted through a primary backing 1422 by a conventional tufting process and held in place by a pre-coat backing layer of latex 1424 or other appropriate adhesives including a hot melt adhesive or the like. The rebond foam base composite 1419 of the tufted carpet product 1400 includes a backing layer 1426 molded, bonded, or laminated to a layer of urethane rebond foam 1428 as illustrated.

The bonded carpet product 1410 (FIG. 14B) employs the same type of rebond foam base composite 1419 adhesively bonded by adhesive laminate layers 1416. However, the primary bonded carpet fabric 1412 has somewhat different components from that of the tufted product in that it has cut pile yarns 1434 implanted in a PVC, latex, or hot melt adhesive 1436 having a glass scrim reinforcement layer 1438.

It is preferred that the backing layer or material 1626 be laminated to the foam 1428 by flame lamination (FIG. 31). Alternatively, it may be attached by one or more adhesives (FIGS. 10A-10C).

Alternative examples of a tufted carpet product 1500 is illustrated in FIG. 15A and of a bonded carpet product 1510 is illustrated in FIG. 158.

In the tufted carpet of FIG. 15A, a primary carpet fabric 1512 is attached to an adhesive layer 1560. A rebond foam base composite is likewise adhesively bonded to the adhesive layer 1560. In the tufted carpet illustrated in FIG. 15A, the primary carpet fabric 15412 includes a loop pile layer 1520 tufted through a primary backing 1522 by a conventional tufting process and held in place by a pre-coat backing layer of latex 1524 or other appropriate adhesives including a hot melt adhesive or the like. The rebond foam base composite of the tufted carpet product 1500 includes a reinforcement layer 1558 and a backing layer 1570 molded, bonded, or laminated to respective sides of a layer of urethane rebond foam 1528 (FIGS. 31 and 32).

In at least one bonded carpet construction of the present invention (FIG. 15B), the primary carpet fabric 1512 preferably comprises a plurality of cut pile yarns 1534 implanted in a latex or hot melt adhesive 1536 which is laminated to a glass scrim reinforcement or substrate layer 1538. It is contemplated that this substrate layer 1538 may be pre-coated with latex or other thermoplastic polymers to permit melting adhesion with the cut pile yarns 1534 upon the application of heat, thereby potentially reducing or eliminating the need for the latex or hot melt adhesive 1536.

An adhesive 1560 (FIGS. 15A, 15B) such as a hot melt adhesive is preferably applied to the carpet 1512 or the reinforcement material 1558 by means of a film coater or other such unit as are well known.

In the illustrated embodiment of FIGS. 15A, 15B, the layer of reinforcement material 1558 is adjacent to and preferably at least partially embedded in the layer of rebond polyurethane 1578. That is, the reinforcement material 1558 is in intimate contact with the polyurethane 1578 such that the polymer material will hold the reinforcement in place (FIG. 31).

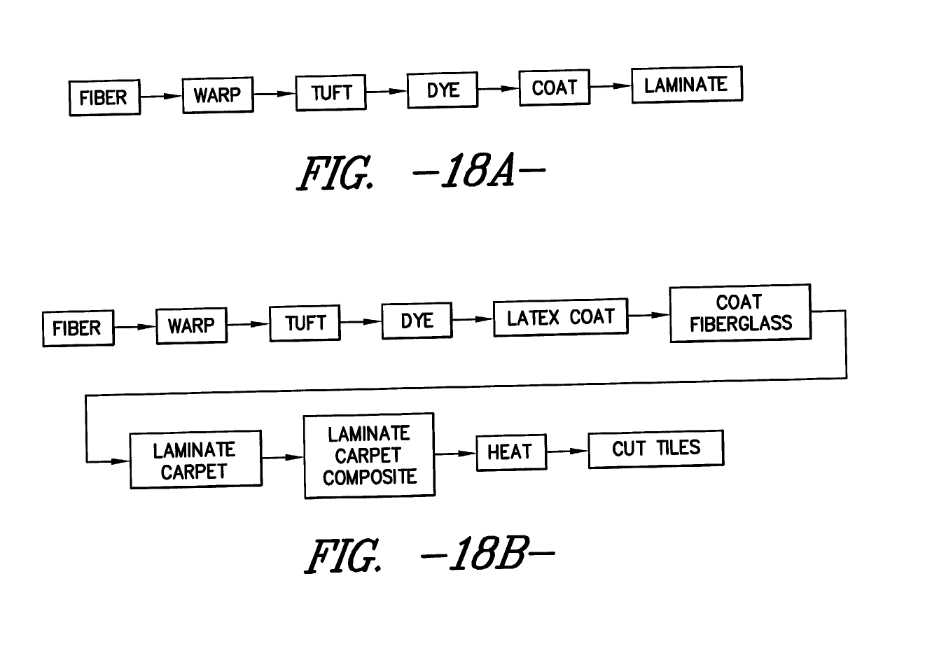

It will be appreciated that a number of alternative practices may be incorporated into the present invention yielding slightly different products. By way of example only, the reinforcement material may be left completely out of the process thereby making the use of at least one adhesive application apparatus or adhesive layer completely unnecessary. In such instances, the primary carpet fabric may be positioned adjacent the rebond cushion or cushion composite thereby yielding a composite structure as illustrated in FIGS. 16A, 16B, 26, and 27 with the polyurethane rebond foam 1678 or upper layer (fiberglass) immediately adjacent to the primary carpet fabric 1612. It is preferred that the rebond foam be laminated to the carpet by flame lamination (FIG. 31).

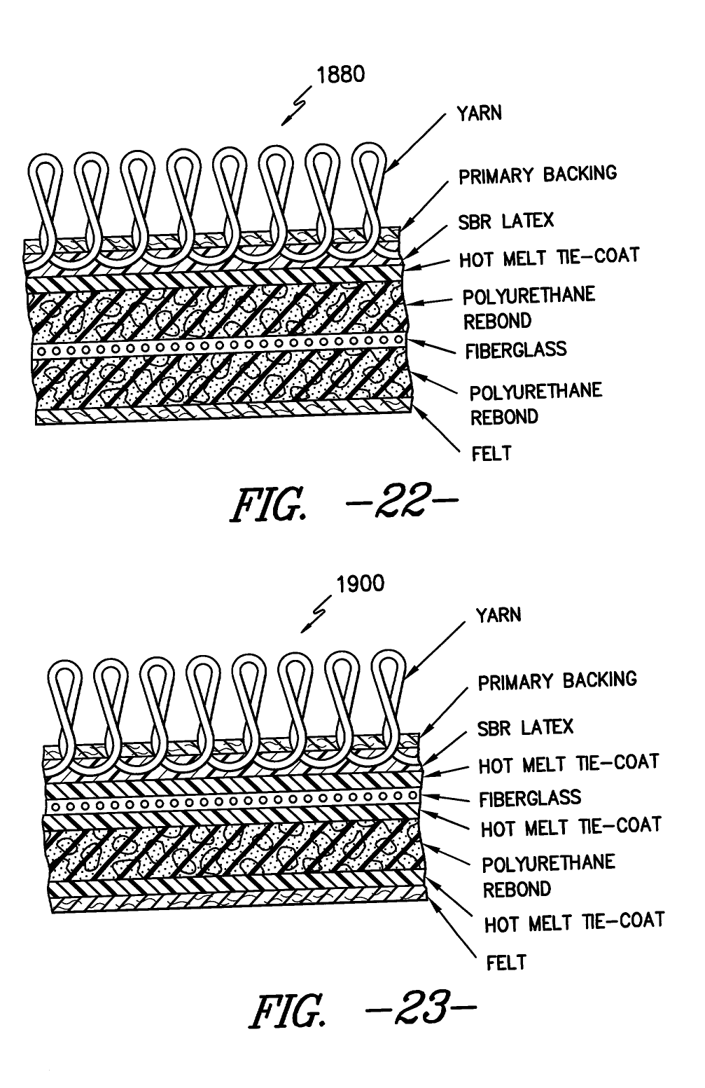

In accordance with another embodiment, a hot melt or adhesive layer may be used to mate the primary carpet to the cushion layer with or without the reinforcement material (FIGS. 19A, 19B, 22, 23, 24, 25, 42, 43, 44, 45).

In yet another alternative, the cushion backing may have an adhesive quick release backing attached to the face to which the polyurethane-forming composition is not applied. Moreover, it is contemplated that in some instances the backing might be completely eliminated such that the polyurethane rebond cushion would directly contact the flooring (FIGS. 25, 26, 27) as disclosed in relation to U.S. Pat. No. 4,286,003 which is incorporated herein by reference.

Also, an adhesive-free carpet and method is described for example in U.S. patent application Ser. No. 09/513,020, filed Feb. 25, 2000, and entitled Adhesive-Free Carpet Tiles and Carpet Tile Installations (hereby incorporated by reference herein).

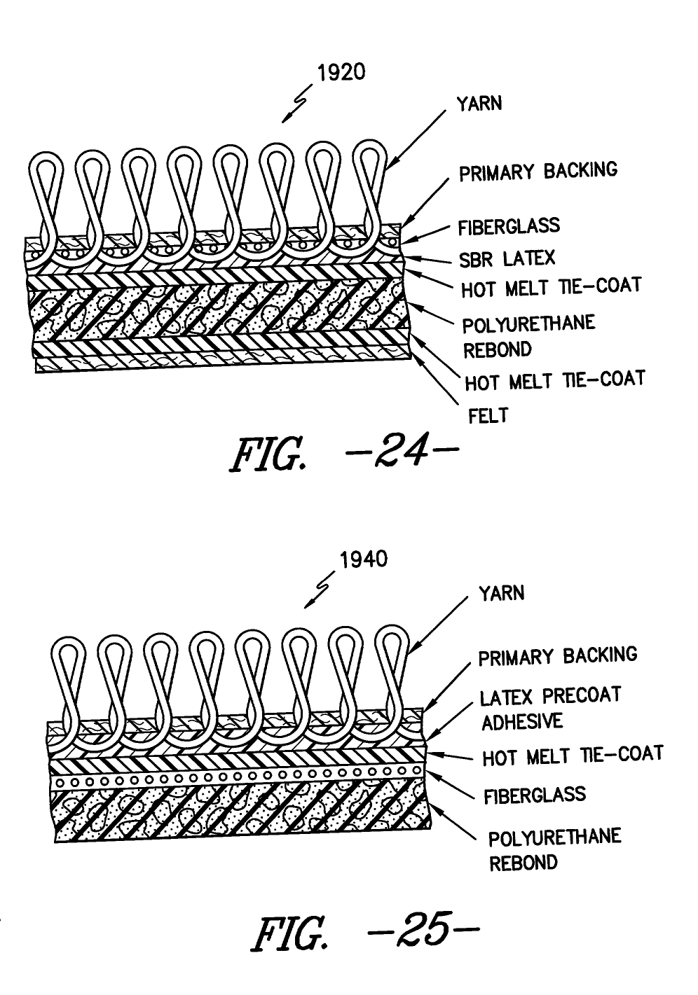

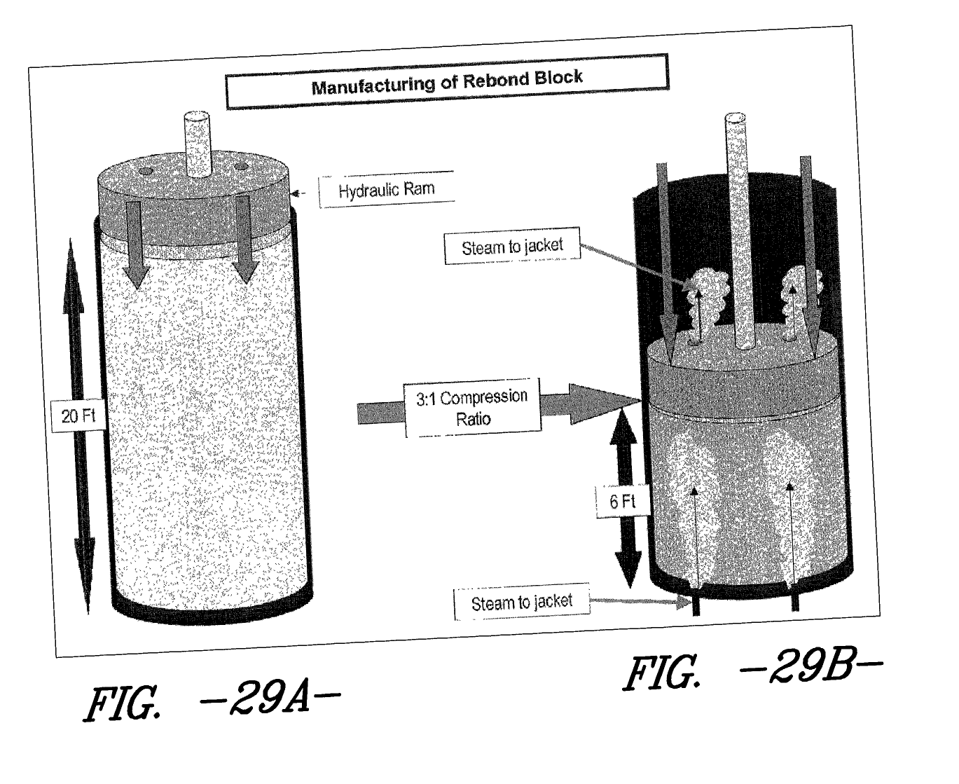

Although it is preferred for the tufted modular carpet or modular carpet tile of the present invention to have at least the following layers: yarn, primary backing, latex pre-coat adhesive, hot melt adhesive, fiberglass, rebond foam, and felt (FIG. 14A), it is contemplated that one or more of these layers may be eliminated or substituted for and still provide a carpet or tile having the desired properties or characteristics. For example, the latex pre-coat adhesive layer may be replaced by a bitumen hot melt layer (FIG. 20), the felt layer may be eliminated on a free lay (no floor adhesive) installation product (FIGS. 25, 26, 27), the glass layer may be eliminated (FIGS. 21, 26), or the like.

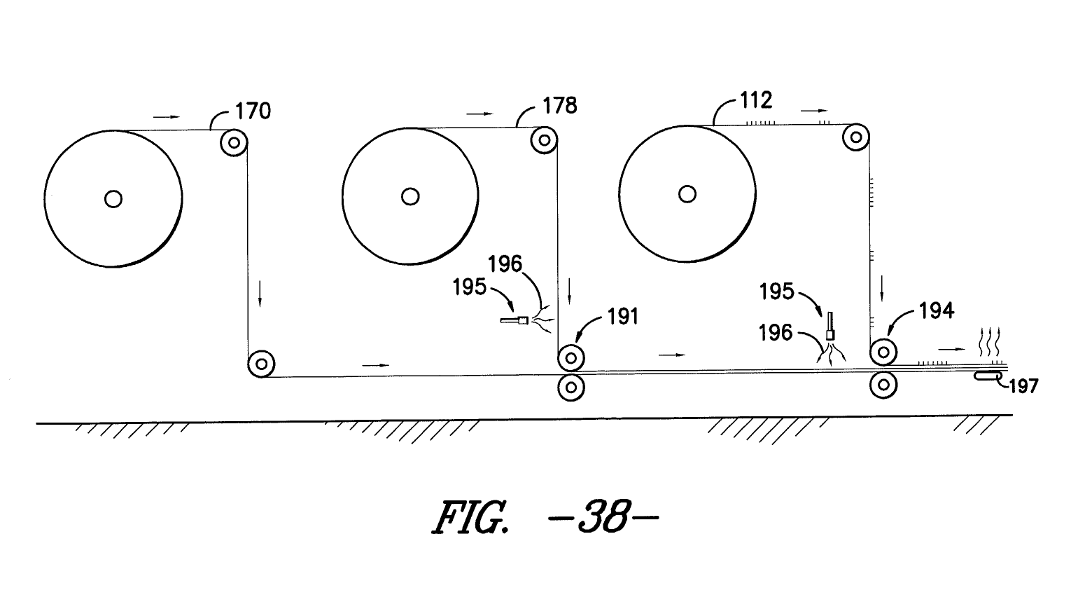

With reference to FIG. 22, the carpet construction may include two or more layers of rebond foam. In particular, the foam backing of FIG. 22 includes a fiberglass layer sandwiched between two rebond foam layers and a felt backing on the bottom. Such a foam composite may be formed by flame lamination of the layers one to another (FIGS. 31 and 38).

With reference to FIG. 36 of the drawings, a woven carpet construction or product 3610 includes a woven material 3620 attached to a rebond foam layer 3678 by an adhesive or pre-coat 3624. Further, a backing material 3670 is attached to the foam layer 3678 by, for example, flame lamination.

With reference to FIG. 37, a non-woven carpet construction or product 3710 includes a non-woven material 3734, two adhesive layers 3760, a scrim material 3738, a reinforcement material 3758, a rebond foam layer 3778, and a backing material 3770. Adhesive layers 3760 attach the non-woven material 3734 to the backing composite 3758, 3778, 3770 (FIGS. 31 and 32).

As shown in FIG. 38, a backing material 170 (or composite) may be attached to the bottom side of a rebond foam layer 178 and a carpet 112 may be attached to the top of the rebond foam layer 178 by heat or flame (flame lamination) to form a carpet construction or product as shown for example in FIGS. 16A, 16B, 20, 21, and 36. The carpet 112 may or may not include a pre-coat layer 124 and may be tufted, bonded, woven, non-woven, etc.

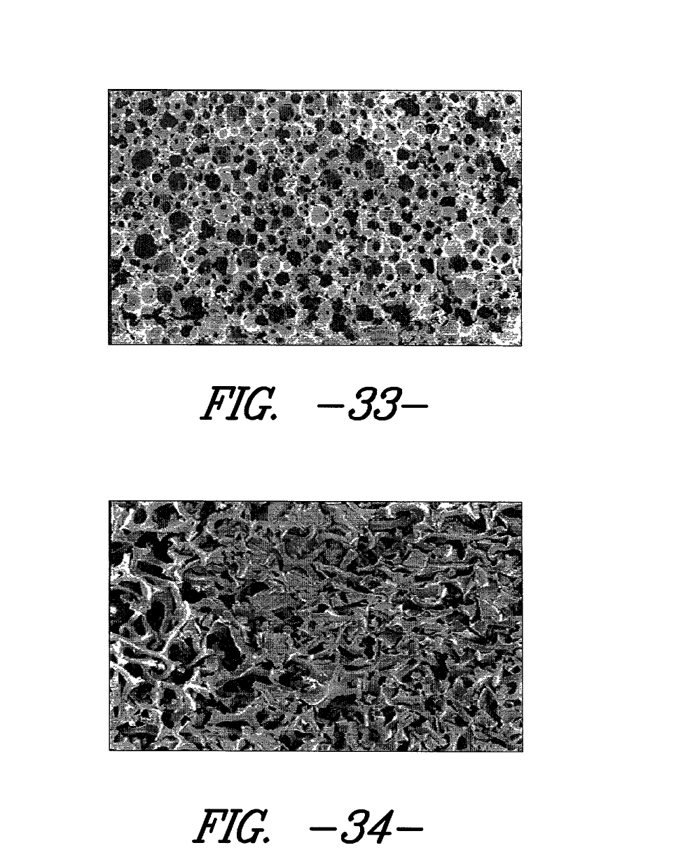

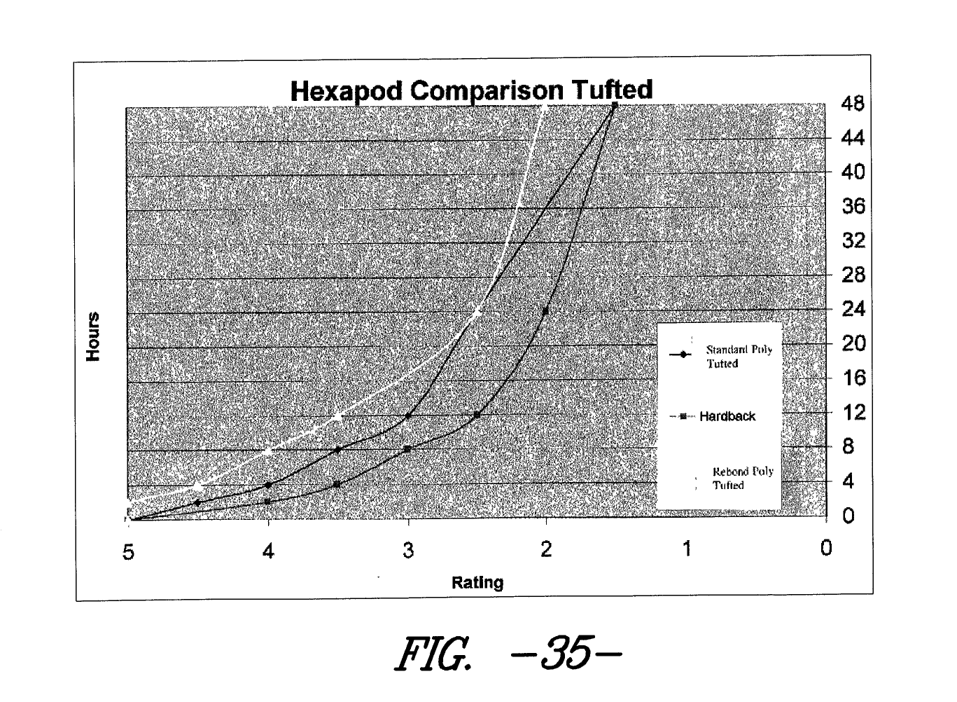

With reference to FIGS. 33 and 34, a conventional filled polyurethane foam carpet tile cushion comprises an open cell or substantially open cell polyurethane foam formed by mechanical frothing and heat curing (FIG. 33). A preferred rebond foam material of the present invention such as a small chip size, high density polyurethane rebond foam has a reticulated or skeletal structure with substantially all of the cell walls blown out (FIG. 34). FIGS. 33 and 34 are cross-section micrographs taken at about 30 times magnification.

In accordance with the present invention, it was unexpectedly discovered that a small chip size, high density rebond foam layer or sheet made an excellent cushion back carpet tile construction in place of conventional filled polyurethane foam. Also, it was unexpectedly discovered that a carpet tile containing such a rebond foam layer exhibited excellent comfort, wear, durability, sound deadening, cushion, comfort, resiliency, look, feel, seamability, and the like characteristics or performance. In other words, such a rebond foam containing carpet tile performed substantially as well as or better than conventional carpet tiles containing filled polyurethane foam or other conventional foams or cushions.

With reference to FIG. 35, the polyurethane rebond foam containing tufted carpet tile of the present invention performed as well as or better than a conventional filled polyurethane containing tufted carpet tile (same face). Also, both cushioned tiles performed better than a hardback tile. The cushion backing tends to save the face of the tile, as well as provides under foot comfort, sound deadening, and anti-fatigue properties.

As shown in FIG. 41 wherein like components to those previously described are designated by corresponding reference numerals within a 4100 series, it is contemplated that carpet construction 4110 includes an adhesive layer 4187, and a magnetic sheet or layer 4190 incorporated as the lower surface of a multi-component or composite backing.

The magnetic sheet 4190 provides for releasable attachment of the carpet composite or tile 4110 to, for example, metal raised access floors or flooring panels. The magnetic sheet may be attached to the backing material (secondary backing) 4170 by one or more adhesive layers 4187 such as a hot melt adhesive or the adhesive on a self-stick magnetic sheet material. It is preferred that the magnetic sheet or layer 4190 be a flexible magnetic material such as strontium ferrite (about 80%-97%) and a bonding agent (about 20% -30%) which is made magnetic or magnetized by passing it over a strong magnet. Such a material is available from Flexmag Industries, Marietta, Ohio. Although it is preferred in this embodiment that the magnetic sheet or layer 4190 be continuous, it is contemplated that the magnetic material may be strips, pieces, or tapes.

U.S. Pat. No. 4,397,900 is directed to a Magnetic Carpet Tile (and method) having a strip of magnetic material embedded in a PVC layer, and is hereby incorporated by reference herein. In this patent, the strip of magnetic material is placed on a conveyor and the PVC layer is formed thereover.

In accordance with one embodiment of the present invention, the magnetic sheet or layer 4190 is part of a composite backing (of backing material 4170, hot melt 4187, and magnetic sheet 4190) and is joined to the foam or cushion layer 4178 by a hot melt or adhesive layer 4171.

In accordance with another embodiment of the present invention, the magnetic sheet or layer 4190 already has the adhesive 4187 on one side thereof and is placed adhesive side up and joined to backing material 4170 by pressure and/or heat.

Moreover, while the multi-component backings of FIGS. 41-43 have been shown in connection with a loop pile tufted carpet construction, it is to be understood that such composite backings may be used in connection with any tufted or bonded carpet construction or other face textiles or materials such as woven, knitted or non-woven.

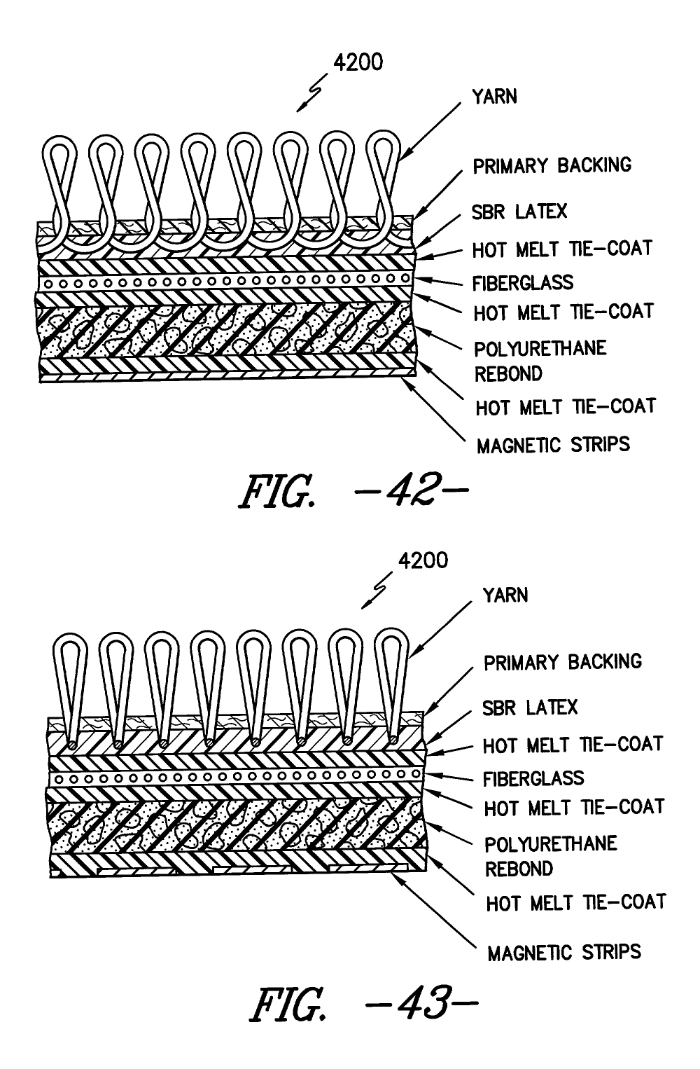

In accordance with other embodiments as shown in FIGS. 42-45, a hot melt or adhesive layer may be used to mate the primary carpet to the cushion layer with or without the reinforcement material. The carpet composite or tile 4200 of FIGS. 42 and 43 includes a lower hot melt or adhesive layer having embedded therein one or more magnetic material strips which like the magnetic sheet of carpet composite 4110 serve to releasably adhere the carpet to metal flooring, metal raised access flooring, or raised flooring panels. The magnetic strips of FIGS. 42 and 43 are preferably flexible magnetic strips which at least provide for flexibility along their length.

The flexible magnetic strips may be formed of strontium ferrite in a binder, styrene butyldiene base thermoplastic material with magnetic particles embedded therein, or the like providing sufficient holding power to the metallic surface upon which the tile is laid. The magnetic strips are preferably supplied from rolls and are embedded in a layer of hot melt adhesive which is attached to the foam layer (rebond foam) to form a cushion back carpet composite or tile having magnetic strips on the lower surface thereof.

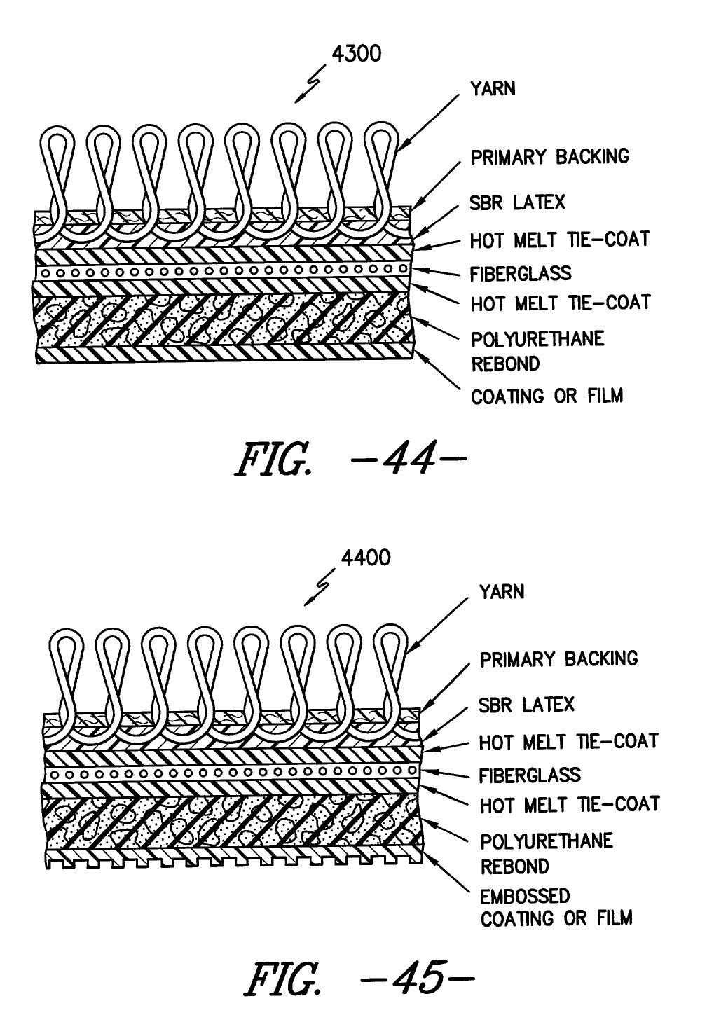

FIGS. 44 and 45 are directed to alternative constructions 4300 and 4400 each having a lower coating or film layer such as a hot melt or adhesive layer as the lower surface thereof. This lower coating or film layer may provide additional adhesion to the floor and protects the lower surface of the foam layer (rebond foam). This lower coating or film layer may be applied with a spray coater, knife coater or roll coater such as a three roll coater, or may otherwise be laminated to the foam layer. It is preferred that this lower coating or film be relatively thin and flexible. The lower coating or film layer may be embossed or textured (FIG. 45) to increase the friction with the floor, such as raised access panels or concrete surface, to enhance the adhesive-free installation of the tiles. Such friction coatings may be acrylic, urethane, any adhesive which dries to a “soft hand” to form a friction coating, any releasable adhesive, any tacky or sticky adhesive, resin or polymer, and/or the like.

Moreover while the coated or laminated backings of FIGS. 44 and 45 have been shown in connection with a loop pile tufted carpet construction, it is to be understood that such backings can be used in connection with any tufted or bonded carpet constructions or other face materials or textiles such as woven, knitted, or non-woven.

Another added feature of the present invention is that it incorporates rebond or recycled product and can be sold as such in the open market. As shown in FIGS. 28-30, rebonding is a process by which manufacturers can receive waste polyurethane (typically furniture pad, waste generated through the manufacture of the virgin material, etc.), grind or chip the waste urethane into specific size chips, and then through a compression technique inject pure urethane and glue the chips back together the result of which is a large log of compressed urethane.

In accordance with the present invention, the urethane chips are usually a low density variety such as 1-3 lb/cu. ft. and may contain a low amount of high density foam crust pieces. After the compression and gluing takes place, the density can be as high as 15 lb/cu. ft. or more. Then this log is cut, slit or peeled into roll lengths of almost any thickness. Then the lengths of foam are taken to a flame laminator and the non-woven secondary and the glass is bonded to each side of the rebond cushion and again rolled up. The only step required from this point is the lamination of this composite to the pre-coated tufted carpet or to use a hot melt adhesive and the result is a cushion tile using waste or recycled foam material.

For rebond carpet tile we have found that it is preferred to use as close a density and thickness as other cushion back carpet tile as possible and also to decrease substantially the chip size. As chip size is decreased, the foam backing is much more attractive, stronger, and more uniform.

In accordance with one particular embodiment of the present invention, a preformed rebond foam or pad is used to manufacture a commercial grade cushion carpet tile. A rebond pad of approximately 13 pounds/cubic foot density is modified to have a respective non-woven material bonded to each of the upper and lower surfaces thereof. The composite rebond pad has a thickness of approximately 0.25″ and is slit in half, producing two foam backings, each approximately 0.125″ thick with a non-woven material attached to one surface. Next, each backing is directly bonded using a hotmelt adhesive to either pre-coated tufted carpet or latex based bonded carpet and then cut into tiles.

There are several additional alternative ways of laminating the fabric to the rebond in the composite of the present invention. Such as:

1. Non-woven and/or glass can be first bonded to the rebond foam (since it is urethane) by flame lamination and then this composite is laminated to the carpet by use of an adhesive. This adhesive can be hotmelt of many natures or it can also be a urethane either reactive or water based.

2. These composites can also be laminated using an adhesive film.

3. These composites can be laminated to the rebond foam by use of urethanes, water based adhesives or hotmelts. This lamination can either occur off-line to form the composite or they can occur as an in-line operation as the carpet is laminated to the composite.

As well as other ways of laminating fabric to urethane foam, for example, using light reactive materials.

Rebond foam may be made by several methods such as forming a compressed cylindrical log and slitting or cutting a sheet therefrom, forming a rectangular block or loaf and slitting or cutting sheets therefrom, or other batch processes or continuous process such as extruding chips and binder, compressing the extrusion, and curing the compressed extrusion. In accordance with one continuous formation process of the present invention, the chips and binder are mixed together and placed between a backing material and a reinforcement material, then compressed and set or cured.

The following tables represent exemplary embodiments or examples of foam layer specifications of the present invention.

A. Commercial Carpet Tile Rebond Foam Specifications

| | |
|---|---|
| Foam Weight | 14.5 oz/yd² |
| Foam Density | 8 lbs./ft³ |
| Foam Thickness (prelamination) | 4 mm |
| Uncompressed Chip Size | 7 mm |
| Chip Material | Polyurethane Foam |
| Binder or Prepolymer | 15% by weight |
| Chips | 82-85% by weight |
| Binder Material | Polyurethane Prepolymer |
| Compression Ratio | 3:1 |
| Colorant (may be added) | Milliken Reactint polyurethane |
| | colorant at about 3% |

B. Commercial Carpet Tile Rebond Foam Specifications

| | |
|---|---|
| Foam Weight | 14.5 oz/yd² |
| Foam Density | 8 lbs./ft³ |
| Foam Thickness (prelamination) | 2 mm |
| Uncompressed Chip Size | 7 mm |
| Chip Material | Polyurethane Foam |
| Binder or Prepolymer | 15% by weight |
| Chips | 82-85% by weight |
| Binder Material | Polyurethane Prepolymer |
| Compression Ratio | 3:1 |
| Colorant (may be added) | Milliken Reactint polyurethane |
| | colorant at about 3% |

C. Residential/Hospitality Carpet Tile Rebond Foam Specifications

| | |
|---|---|
| Foam Weight | 14.5 oz/yd² |
| Foam Density | 8 lbs./ft³ |
| Foam Thickness (prelamination) | 7 mm |
| Uncompressed Chip Size | 7 mm |
| Chip Material | Polyurethane Foam |
| Binder or Prepolymer | 15% |
| Chips | 82-85% |
| Binder Material | Polyurethane Prepolymer |
| Compression Ratio | 3:1 |
| Colorant (may be added) | Milliken Reactint polyurethane |
| | colorant at about 3% |

D. Commercial Carpet Tile Rebond Foam Specification Ranges

| Foam Weight | 7-50 oz/yd² |
|---|---|
| Foam Density | 4-16 lbs./ft³ |
| Foam Thickness (prelamination) | 2-7 mm |
| Uncompressed Chip Size | 2-14 mm |
| Chip Material | Polyurethane Foam (polyester |
| | or polyether) |
| Binder or Prepolymer | 5-20% |
| Chips | 60-95% |
| Binder Material | Polyurethane Prepolymer |
| | (polyester or polyether) |
| Compression Ratio | 2:1-5:1 |
| Additives such as colorant, fiber, fill, etc. | 0-20% |

E. Preferred Commercial Carpet Tile Rebond Foam Specification Ranges

| Foam Weight | 10-18 oz/yd² |
|---|---|
| Foam Density | 7-12 lbs./ft³ |
| Foam Thickness (prelamination) | 3-5 mm |
| Uncompressed Chip Size | 5-8 mm |
| Chip Material | Polyurethane Foam (polyester |
| | or polyether) |
| Binder or Prepolymer | 12-17% |
| Chips | 78-88% |
| Binder Material | Polyurethane Prepolymer |
| | (polyester or polyether) |
| Compression Ratio | 3:1 |
| Additives such as colorant, fill, fiber, etc. | 0-5% |

F. Residential/Hospitality Carpet Tile Rebond Foam Specification Ranges

| Foam Weight | 7-84 oz/yd² |
|---|---|
| Foam Density | 4-16 lbs./ft³ |
| Foam Thickness (prelamination) | 2-10 mm |
| Uncompressed Chip Size | 2-14 mm |
| Chip Material | Polyurethane Foam (polyester |
| | or polyether) |
| Binder or Prepolymer | 5-20% |
| Chips | 60-95% |
| Binder Material | Polyurethane Prepolymer |
| | (polyester or polyether) |
| Compression Ratio | 2:1-5:1 |
| Additives such as colorant, fill, fiber, etc. | 0-20% |

G. Preferred Residential/Hospitality Carpet Tile Rebond Foam Specification Ranges

| Foam Weight | 10-28 oz/yd² |
|---|---|
| Foam Density | 6-10 lbs./ft³ |
| Foam Thickness (prelamination) | 5-8 mm |
| Uncompressed Chip Size | 5-8 mm |
| Chip Material | Polyurethane Foam (polyester |
| | or polyether) |
| Binder or Prepolymer | 12-17% |
| Chips | 83-88% |
| Binder Material | Polyurethane Prepolymer |
| | (polyester or polyether) |
| Compression Ratio | 3:1 |
| Additives such as colorant, fill, fiber, etc. | 0-5% |

H. Carpet Tile Rebond Foam Specifications

| Foam Weight | 14.5 oz/yd² |
|---|---|
| Foam Density | 8 lbs./ft³ |
| Foam Thickness (prelamination) | 4 mm |
| Uncompressed Chip Size | 7 mm |
| Chip Material | Polyurethane Foam |
| Binder or Prepolymer | 15% |
| Chips | 80-85% |
| Binder Material | Polyurethane Prepolymer |
| Compression Ratio | 3:1 |
| Additives such as filler, colorant, fiber, etc. | 0-5% |

I. Flame Laminated Carpet Tile Rebond Foam Specifications

| Foam Density | 9 lbs./ft³ |
|---|---|
| Foam Thickness (prelamination) | 4-4.5 mm |
| Uncompressed Chip Size | 7 mm |
| Chip Material | Polyurethane Foam (minimum |
| | 25% polyester) |
| Binder or Prepolymer | 10-15% |
| Chips | 85-90% |
| Binder Material | Polyurethane Prepolymer |
| Compression Ratio | 3:1 |

J. Hot Melt Laminated Carpet Tile Rebond Foam Specifications

| Foam Density | 9 lbs./ft³ |
|---|---|
| Foam Thickness (prelamination) | 4 mm |
| Uncompressed Chip Size | 7 mm |
| Chip Material | Polyurethane Foam (can be |
| | 100% polyether) |
| Binder or Prepolymer | 10-15% |
| Chips | 85-90% |
| Binder Material | Polyurethane Prepolymer |
| Compression Ratio | 3:1 |

K. Carpet Tile Rebond Foam Specifications

| | |
|---|---|
| Foam Weight | 14.5 oz/yd² |
| Foam Density | 8 lbs./ft³ |
| Foam Thickness (prelamination) | 4 mm |
| Uncompressed Chip Size | 7 mm |
| Chip Material | Polyurethane Foam |
| Binder or Prepolymer | 10-20% |
| Chips | 80-90% |
| Binder Material | Polyurethane Prepolymer |
| Compression Ratio | 3:1 |
| Additives (colorant, filler, anti-microbial | 0-10% |
| agent, flame retardant, anti-fungal agent, | |
| fillers, solid particles, and/or the like) | |

L. Broadloom Rebond Foam Specifications

| | |
|---|---|
| Foam Weight | 14.5 oz/yd² |
| Foam Density | 8 lbs./ft³ |
| Foam Thickness (prelamination) | 7 mm |
| Uncompressed Chip Size | 7 mm |
| Chip Material | Polyurethane Foam |
| Binder or Prepolymer | 15% |
| Chips | 82-85% |
| Binder Material | Polyurethane Prepolymer |
| Compression Ratio | 3:1 |
| Colorant | Milliken Reactint polyurethane |
| | colorant (at about 3%) |

U.S. Pat. No. 5,929,145 describes bitumen backed carpet tile and bitumen compositions suitable for carpet tile backing and is hereby incorporated by reference.

The foam backed or cushion backed carpet composite, carpet product or carpet tile of the present invention preferably provides sound deadening especially over raised access flooring, reduced drum head noise, comfort, durability, anti-fatigue, cushioning, excellent design or pattern registration, hidden seams, recycled content, and/or the like.

In accordance with one production process of the present invention, the latex pre-coat is replaced with a hot melt pre-coat such as shown in FIGS. 6A, 6B, 7A, 7B, 39, and with the backing attached to the foam by an adhesive as shown in FIGS. 10A, 10B, 39, and 40.

In one embodiment, the first hot melt coating or pre-coat would be directly to the carpet with some type of physical motion to press the hot melt into the yarn bundle before it has a chance to cool. As hot melt cools it rises very quickly in viscosity. This coater would be a roll coater or the like such that the roll would directly turn on the backside of the yarn and push the coating into the yarn or a curtain coater which would have a static bar to roll or push the coating into the yarn. The hot melt formulation viscosity would be as low as possible and range from about 200 cps to 5000 cps. This low viscosity has been reached by taking filler out of the hot melt formula. When filler is still present in hot melt and the viscosity is lowered then “filler fall out” becomes a problem. The hot melt would then be constantly circulated in some manner to prevent the filler from settling.

Immediately after this coating is pushed into the yarn, a cooled nip roll would press the yarn flat and instantaneously cool the hot melt which would hold the bulky yarn flat. This would minimize both the amount of pre-coat and the amount of subsequent coatings required. At this same nip point or even with a cooled drum, a layer of non-woven glass reinforcement would be laminated to the pre-coated carpet. Application rate for the hot melt pre-coat would be between about 10 oz/sq. yd to 50 oz/sq. yd, preferably about 10-20 oz/sq. yd.

This coated/laminated carpet composite would then proceed to the next hot melt coater where a very light weight high viscosity hot melt adhesive layer would be applied. This formula could be again a modified hot melt adhesive but would need to be high viscosity to prevent penetration of the hot melt into the rebond foam. This modification can be made by decreasing the particle size of the filler or adding ground up carpet waste. By increasing the surface area of the filler or by introducing fiber to the compound raises the viscosity. The ideal viscosity would be from about 50,000 cps to 200,000 cps. The adhesive layer hot melt application rate would be from about 3 oz/sq yd, to 8 oz/sq yd, preferably about 5 oz/sq yd. This should be a lightweight coating applied to the glass side of the carpet laminate. This could be done with a curtain coater, an engraved roll or a doctor blade coater. Either coater could be supplied by use of a small extruder to handle the high viscosity and also to add the recycled carpet waste at the same time. After this lightweight coating is applied at high viscosity, then the rebond foam could be laminated to the carpet/glass composite again around a cooling drum.

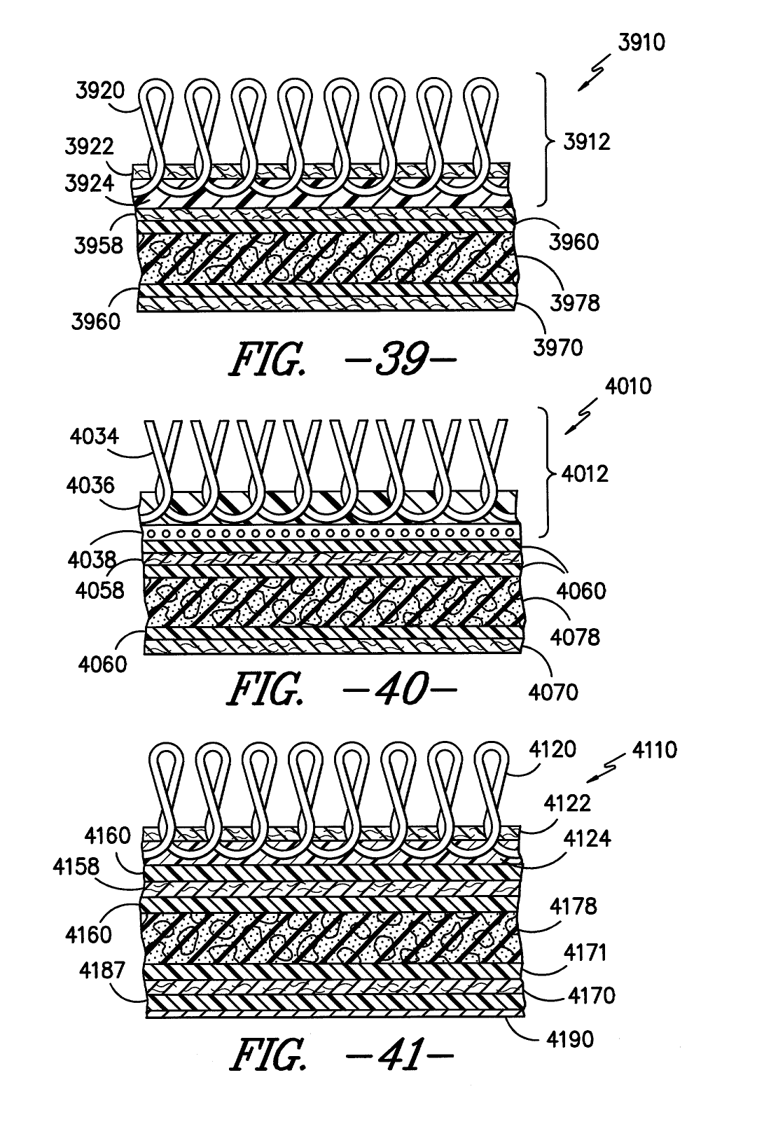

The third and last hot melt coater would be an engraved roll coating the rebond foam side directly and then applying the nonwoven fabric or coating the nonwoven backing and pressing the composite into the coating. The formula for this hot melt adhesive application would be the same as for the adhesive between the glass and rebond foam since again minimum penetration into the foam is desired. A curtain coater on the nonwoven side might also be considered. Again carpet waste could be introduced. Application rates and viscosity would be the same as for the other hot melt adhesive layer (FIGS. 39 and 40).

Flame lamination rather than coating is desired for an attached cushion broadloom product to allow the composite to be rolled up.

In a process having a hot melt pre-coat a polyester primary backing or a heat stabilized primary backing is preferred to withstand the heat from hot melt pre-coating.

The invention may be further understood by reference to the following examples which are not to be construed as unduly limiting the invention which is to be defined and construed in light of the appended claims.

### EXAMPLE I

A tufted carpet is produced by the apparatus and process as illustrated and described in relation to FIG. 2. The carpet has the configuration illustrated and described in relation to FIG. 3A. The production parameters are as follows:

| | |
|---|---|
| Yarn | 15 ounces per sq. yd. |
| | nylon 6,6 loop pile |
| | continuous filament |
| Primary Backing | 4 ounces per sq. yd. |
| | non-woven polyester |
| Pre-coat | 16 ounces per sq. yd. |
| | SBR Latex filled with |
| | 100 parts CaCO.sub.2. |
| Hot Melt Adhesive | 42 ounces per sq. yd. |
| Laminate | modified poly- |
| | propylene |
| Reinforcement | 2 ounces per sq. yd. |
| | Non-woven glass with |
| | acrylic binder |
| Urethane Rebond Foam Coverage | 20 ounces per sq. yd. |
| Urethane Rebond Foam Density | 16 pounds per |
| | cubic foot |
| Backing Material | 4 ounces per sq. yd. |
| | Non-woven (50% |
| | polypropylene, |
| | 50% polyester) |
| EXAMPLE II | |
| Construction | Tufted, Textured |
| | Loop Pile |
| Face Fiber | 100% Milliken |
| | Certified |
| WearOn ® Nylon | MilliGuard ® |
| Soil Protectant | |
| Antimicrobial | BioCare ® |
| Dye Method | Millitron ® Dye |
| | Injection Printing |
| Gauge | 1/10 in. (39.4/10 cm.) |
| Rows | 14.4/in. (56.7/10 cm.) |
| Tufts | 143.9/sq. in. (2230.3/ |
| | 100 sq. cm.) |
| Standard Backing | PVC-Free |
| cushion | UNDERSCORE ™ |
| Nominal Total Thickness | 0.34 in. (8.6 mm) |
| Total Weight | 99.9 oz/sq. yd. |
| | (3,387.4 g./sq. m.) |
| Tile Size | 36 X 36 in. (914.4 X |
| | 914.4 mm) |
| Flammability (Radiant Panel ASTM-E-648) | ≧0.45 (Class I) |
| Smoke Density (NFPA-258-T or ASTM-E-662) | ≦450 |
| Methenamine Pill Test | Self-Extinguishing |
| (CPSC FF-1-70 or ASTM D 2859) | |
| Lightfastness (AATCC 16E) | ≧4.0 at 80 hrs. |
| Crocking (AATCC 165) | ≧4.0 wet or dry |
| Static Electricity (AATCC-134) 20% R.H.,70° F. | ≦3.5 KV |
| Dimensional Stability-Aachener test | ≦0.2% |
| (DIN Standard 54318) | |
| Recommended Traffic | Heavy Commercial |
| Recommended Maintenance | Millicare ® |
| CRI Indoor Air Quality | Product Type: |
| | 12200793 |
| Foam | Rebond Foam |
| EXAMPLE III | |
| Construction | Tufted, Textured |
| | Loop Pile |
| Face Fiber | 100% Milliken |
| | Certified |
| WearOn ® Nylon | MilliGuard ® |
| Soil Protectant | |
| Antimicrobial | BioCare ® |
| Dye Method | Millitron ® |
| Gauge | 1/10 in. (39.4/10 cm.) |
| Rows | 14.4/in. (56.7/10 cm.) |
| Tufts | 143.9/sq. in. (2230.3/ |
| | 100 sq. cm.) |
| Standard Backing | PVC-Free |
| cushion | UNDERSCORE ™ |
| Nominal Total Thickness | 0.34 in. (8.6 mm.) |
| Total Weight | 99.9 oz./sq. yd. |
| | (3,387.4 g./sq. m.) |
| Tile size | 36 X 36 in. (914.4 X |
| | 914.4 mm.) |
| Flammability (Radiant Panel ASTM-E-648) | ≧0.45 (Class I) |
| Smoke Density (NFPA-258-T or ASTM-E-662) | ≦450 |
| Methenamine Pill Test | Self-Extinguishing |
| (CPSCFF-1-770 or ASTM D 2859) | |
| Lightfastness (AATCC 16E) | ≧4.0 at 80 hrs. |
| Crocking (AATCC 165) | ≧4.0 wet or dry |
| Static Electricity (AATCC-134) 20% R.H., 70° F. | ≦3.5 KV |
| Dimensional Stability-Aachener Text | ≦0.2% |
| (DIN Standard 54318) | |
| Recommended Traffic | Heavy Commercial |
| Recommended Maintenance | MilliCare ® |
| CRI Indoor Air Quality | Product Type: |
| | 12200793 |
| Foam | Rebond Foam |

### EXAMPLE IV

A tufted carpet is produced by the apparatus and process as illustrated and described in relation to FIG. 2. The carpet has the configuration illustrated and described in relation to FIG. 3A. The production parameters are as follows:

| | |
|---|---|
| Yarn | 29 ounces per sq. yd. nylon 6,6 loop pile continuous |
| | filament, white, 1350 denier, not plied, not twisted, |
| | not heat set |
| Primary Backing | 4 ounces per sq. yd. non-woven polyester |
| Pre-coat | 16 ounces per sq. yd. SBR Latex filled with 100 |
| | parts CaCO.sub.2. |
| Hot Melt Adhesive | 36 ounces per sq. yd. modified polypropylene |
| Laminate | |
| Reinforcement | 2 ounces per sq. yd. Non-woven glass with |
| | acrylic binder |
| Urethane Rebond | 15 ounces per sq. yd. |
| Foam Coverage | |
| Urethane Rebond | 16 pounds per cubic foot |
| Foam Density | |
| Backing Material | 4 ounces per sq. yd. Non-woven (50% |
| | polypropylene, 50% polyester) |

### EXAMPLE V

A tufted carpet is produced by the apparatus and process as illustrated and described in relation to FIG. 2. The carpet has the configuration illustrated and described in relation to FIG. 3A. The production parameters are as follows:

| | |
|---|---|
| Yarn | 24 ounces per sq. yd. nylon 6,6 loop pile continuous |
| | filament |
| Primary Backing | 2 ounces per sq. yd. non-woven polyester |
| Pre-coat | 14 ounces per sq. yd. SBR Latex filled with 100 |
| | parts CaCO.sub.2. |
| Hot Melt Adhesive | 38 ounces per sq. yd. modified polypropylene |
| Laminate | |
| Reinforcement | 3 ounces per sq. yd. Non-woven glass with |
| | acrylic binder |
| Urethane Rebond | 22 ounces per sq. yd. |
| Foam Coverage | |
| Urethane Rebond | 9 pounds per cubic foot |
| Foam Density | |
| Backing Material | 2 ounces per sq. yd. Non-woven (50% |
| | polypropylene, 50% polyester) |

### EXAMPLE VI

A tufted carpet is produced by the apparatus and process as illustrated and described in relation to FIG. 5. The carpet has the configuration illustrated and described in relation to FIG. 6A. The production parameters are as follows:

| | |
|---|---|
| Yarn | 40 ounces per sq. yd. nylon 6,6 loop pile |
| Primary Backing | 4 ounces per sq. yd. non-woven polyester |
| Laminate | |
| Reinforcement | 2 ounces per sq. yd. Non-woven glass with |
| | acrylic binder |
| Urethane Rebond | 36 ounces per sq. yd. |
| Foam Coverage | |
| Urethane Rebond | 16 pounds per cubic foot |
| Foam Density | |
| Backing Material | 4 ounces per sq. yd. Non-woven (50% |
| | polypropylene, 50% polyester) |

### EXAMPLE VII

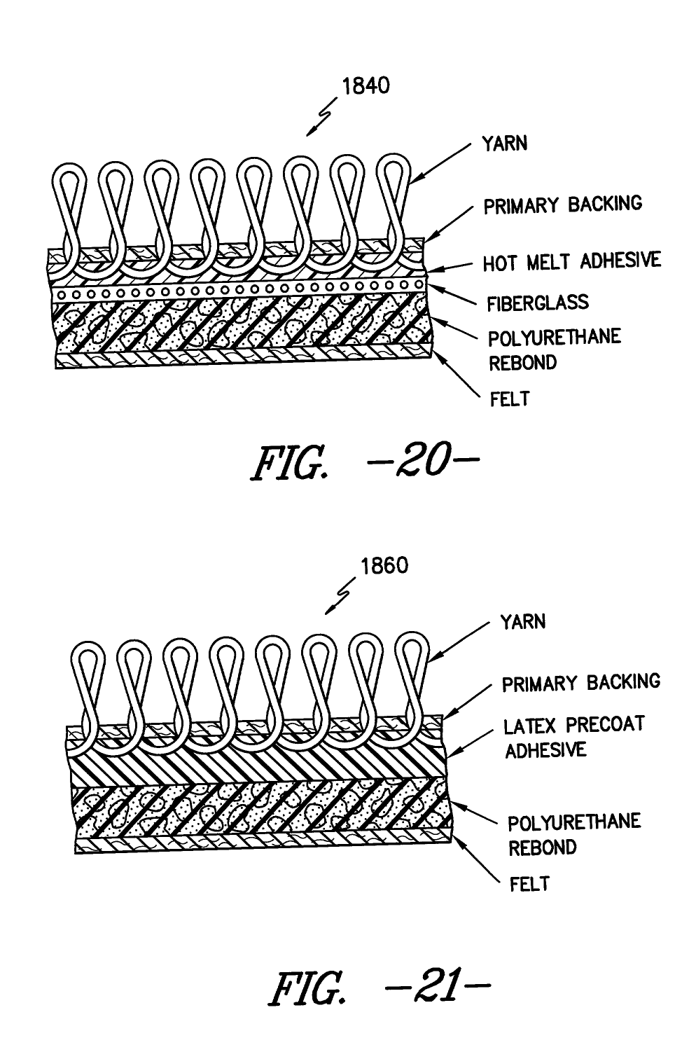

A tufted carpet is produced by the apparatus and process as illustrated and described in relation to FIG. 19. The carpet has the configuration illustrated and described in relation to FIG. 18. The production parameters are as follows:

| | |
|---|---|
| Yarn | 15 ounces per sq. yd. nylon 6,6 loop pile continuous |
| | filament, white, 1350 denier, not plied, not twisted, |
| | not heat set |
| Primary Backing | 4 ounces per sq. yd. non-woven polyester |
| Pre-coat | 16 ounces per sq. yd. SBR Latex filled with 100 |
| | parts CaCO.sub.2. |
| Reinforcement | 2 ounces per sq. yd. Non-woven glass with |
| Material | acrylic binder |
| Urethane Rebond | 20 ounces per sq. yd. |
| Foam Coverage | |
| Urethane Rebond | 16 pounds per cubic foot |
| Foam Density | |

In one survey of 64 people rating carpet tiles for walking and standing comfort, the rebond foam containing bonded carpet tiles of the present invention scored higher for comfort (over 75% of the participants ranked the rebond tiles as their number one choice for comfort) than conventional filled polyurethane containing bonded carpet tiles or conventional bonded hard back carpet tiles (same face).

In another survey of over 75 participants, the number one choice for comfort was rebond foam containing carpet tiles (7 mm thick, 9 lb. density, 7 mm chip size, polyurethane rebond foam) as compared to conventional filled polyurethane containing carpet tiles, rebond foam containing carpet tiles with less foam (4 mm thick, 9 lb. density, 7 mm chip size, polyurethane), rebond foam containing tiles with even less foam (2 mm thick, 9 lb. density, 7 mm chip size, polyurethane), and lastly conventional vinyl hardback carpet tiles (same face). In this survey, about 89% chose the thick rebond foam tiles as providing the most comfort, and about 11% chose the medium rebond foam tiles as providing the most comfort.

Test Method Conducted
ASTM D-5252 Hexapod Drum Tester
ISO/TR 10361 Hexapod Tumbler
Ratings Based on CRI TM-101 Photographic Scales

Apparatus: Wira Instrumentation Hexapod Tumbler Carpet

Tester Procedure

The test specimen is subjected to the reported cycles of “Hexapod” tumbling, removing the specimen every 2,000 cycles for restoration by vacuuming.

An Electrolux upright vacuum cleaner (Discovery II) is used, making four (4) forward and backward passes along the length of the specimen.

The samples are assessed using daylight equivalent vertical lighting (1500 lux). Samples are viewed at an angle of 45 degrees from 1½ meter distance, judging from all directions.

TEST RESULTS

| Number of Hexapod | | | |
|---|---|---|---|
| Cycles | 4000 | 12000 | Key to Ratings |
| Color Change | 4-4.5 | 3-3.5 | 5 = Negligible or no change |
| | | | 4 = Slight change |
| Overall Appearance | 4 | 3 | 3 = Moderate change |
| | | | 2 = Considerable change |
| | | | 1 = Severe change |

Comfort Rating

1. Gmax—Max simulates footfall onto a surface. The measure is reported as multiples of “g” (gravities), or Gmax. The lower the value, the lower the force upon impact, and the more comfortable underfoot the product feels. The higher the value, the higher the force upon impact, and the less comfortable the carpet feels.

Gmax Test Results

Standard Milliken ComfortPlus® cushion-backed carpet tile—116

Rebond cushion backed carpet tile of the present invention—121

Standard commercial broadloom without underlayment—185

Standard hardback carpet tile, such as Everwher a PVC hardback—227

Resilience Rating/Ball Bounce

Cushion Resilience—Cushion resiliency measures the rebound percent of a metal ball when dropped from a standard height. It shows the shock absorbing character of the cushion, which helps reduce visible wear of the carpet face. The higher the value, the higher the rebound percent, and the more resilient the cushion.

Resilience Results

Standard Milliken ComfortPlus® cushion backed carpet tile—30

Rebond polyurethane cushion back carpet tile of the present invention—29

Standard commercial broadloom without underlayment—17

Standard hardback carpet tile—13

Appearance Retention

Appearance Retention Rating (ARR)—the ARR value is determined by grading the appearance change of carpet subjected to exposure conditions in accordance with either the ASTM D-5252 (Hexapod) or ASTM D-5417 (Vettermann) test method using the number of cycles for short and long-term tests specified.

ARR—Light (short-term>/=3.0, long-term>/=2.5

ARR—Moderate (short-term>/=3.5, long-term >/=3.0

ARR—Heavy (short-term>/=4.0, long-term >/=3.5

The rebond foam modular carpet tile of the present invention had an APR of about 4.5 short term and 3.5 long term.

Durability

The polyurethane rebond cushion back carpet tile of the present invention is very durable and can withstand 25,000 cycles or more of the caster chair test without failure.

EN 1307: Classification of Pile Carpets

This standard sorts carpets into four categories, depending on their ability to withstand differing degrees of wear.

The categories are:

Class 1 Light intensity of use (domestic only).

Class 2 General (domestic or very light contract).

Class 3 Heavy, e.g. use in general contract areas.

Class 4 Very Heavy, e.g. use in Extreme contract areas.

Three test methods are combined to provide the classification,

1. Fuzzing or loss of mass, on the step—scuff test EN 1963.

2. I (tr) according to EN 1963. The carpet is shorn down to the backing, and various parameters such as Surface Pile weight and height, Surface pile density are measured.

I (tr) is a numerical value calculated according to a mathematical formula which includes the above test measurements.

The required value of I (tr) is higher the higher the classification.

3. Hexapod or Vettermann drum test for change in surface appearance, ISO/TR 10361.

Again, the higher the class, the higher the requirement.

In addition, there are requirements for either minimum Surface Pile weight, or Surface Pile density for contract-grade carpets.

This system is used for carpets with low, dense pile. There is a different system for carpets with high pile.

It is preferred to have a carpet composite or tile with a castor chair rating of >2.3 (test and evaluation method EN 54324.) A 2.4 or higher is a contract rating.

It is preferred to have a carpet composite or tile with EN 1307 rating of >2.

It is preferred to have a carpet composite or tile with Herzog walking comfort rating for contract use (DIN 54327) of >0.7.

| PVC | Rebond Foam | Filled Polyurethane |
|---|---|---|
| 0.71 | 0.80 | 0.77 Walking comfort for domestic use |
| 0.96 | 1.04 | 0.97 Walking comfort for contract use |

All tufted loop construction where higher value is most comfortable.

Hexapod test (ISO 10361 Method B) results are: 4,000 revs rating 4.5 12,000 revs rating 4.0 for tufted, 3.5 for bonded overall Class 4

Castor Chair test (EN 985) results are: 5,000 revs rating 3.0 tufted 2.5 bonded 25,000 revs rating 2.5 tufted, 2.0 bonded overall value 2.9 tufted, 2.4 bonded

Carpet Tile with Rebond Foam

| | 2 mm rebond foam | 4 mm rebond foam | 7 mm rebond foam |
|---|---|---|---|
| Hexapod | | | |
| (2000 cycles) | 5.0 | 4.5 | 5.0 |
| (4000 cycles) | 4.5 | 4.5 | 4.5 |
| (8000 cycles) | 4.0 | 4.0 | 3.5 |
| (12000 cycles) | 3.0 | 3.5 | 3.5 |
| (24000 cycles) | 2.5 | 3.0 | 3.0 |
| (48000 cycles) | 2.5 | 2.5 | 3.0 |
| Caster Chair | 3.5 | 3.0 | 4.5 |
| GMax | 140 | 104 | 79.6 |
| Ball Bounce | 29.1 | 29.5 | 29.2 |

(The carpet tile face for each was a 20 oz., loop pile, 1/8 gauge tufted, nylon 6,6 and
the construction was like that of FIGS. 15A or 19A.)

| | | | |
|---|---|---|---|
| Foam Tests | 9 lb. sm. chip | Filled | 8 lb. lg. chip |
| | Rebond foam | Polyurethane | Rebond Foam |
| Compression Set | 7.0% | 5.1% | 11.8% |
| Compression Resistance | 2.8 psi | 6.5 psi | 14.4 psi |

As will be appreciated, the carpet construction of the present invention may take on any number of other constructions aside from those that have been particularly illustrated and described. By way of example only, the carpet construction of the present invention may take on the configuration as disclosed in co-pending U.S. patent application Ser. No. 09/513,020, filed Feb. 25, 2000, and entitled Adhesive-Free Carpet Tiles and Carpet Tile Installations (hereby incorporated by reference herein).

It is, of course, to be appreciated that while several potentially preferred embodiments, procedures and practices have been shown and described, the invention is in no way to be limited thereto, since modifications may be made and other embodiments of the principles of this invention will occur to those skilled in the art to which this invention pertains. Therefore, it is contemplated by the appended claims to cover any such modifications and other embodiments as may incorporate the features of this invention within the true spirit and scope thereof.

What we claim is:

1. A surface covering such as a wall covering, floor covering, carpeting, or carpet tile, comprising: a primary carpet, and a rebond foam cushion fixed at a position below said primary carpet.

2. The invention as recited in claim 1, further comprising at least one adhesive layer between said primary carpet and said rebond foam cushion.

3. The invention as recited in claim 1, further comprising a layer of reinforcing material disposed within mass of adhesive material such that at least a portion of said mass of adhesive material extends away from at least one side of said layer of reinforcing material.

4. The invention as recited in claim 1, wherein the adhesive material comprises at least one of a thermoplastic and thermoset adhesive.

5. The invention as recited in claim 1, wherein the primary carpet is characterized by a face weight of about 20-60 oz/yd².

6. The invention as recited in claim 1, wherein the primary carpet is characterized by a face weight of about 12-20 oz/yd².

7. The invention as recited in claim 2, wherein the adhesive is present at a level of less than or equal to about 100 oz/yd².

8. The invention as recited in claim 2, wherein the adhesive is present at a level of about 36-90 oz/yd².

9. The invention as recited in claim 1, wherein the rebond foam cushion is characterized by a density of about 25 lbs. per cubic foot or less.

10. The invention as recited in claim 1, wherein the rebond foam cushion is characterized by a density of about 9 lbs. per cubic foot or less.

11. The invention as recited in claim 1, wherein the rebond foam cushion is characterized by an uncompressed chip size of about 25 mm or less.

12. The invention as recited in claim 11, wherein the uncompressed chip size is about 12 mm or less.

13. The invention as recited in claim 11, wherein the uncompressed chip size is about 7 mm or less.

14. The invention as recited in claim 1, wherein the rebond foam is characterized by a binder quantity of about 25% or less.

15. The invention as recited in claim 14, wherein the binder content is about 15% or less.

16. The invention as recited in claim 14, wherein the binder content is about 10% or less.

17. The invention as recited in claim 2, wherein the adhesive material comprises a hot melt adhesive.

18. The invention as recited in claim 1, wherein the primary carpet is characterized by a face weight of less than or equal to about 55 oz/yd².

19. The invention as recited in claim 17, wherein the hot melt adhesive is present at a level of about 36-50 oz/yd².

20. The invention as recited in claim 2, wherein the adhesive material comprises a polyolefin based thermoplastic hot melt adhesive.

21. The invention as recited in claim 1, wherein the primary carpet is at least one of a tufted, bonded, flocked, needle punched, and woven carpet.

22. The invention as recited in claim 1, wherein the rebond foam cushion is characterized by a thickness of about 25 mm or less.

23. The invention as recited in claim 22, wherein the foam thickness is about 12 mm or less.

24. The invention as recited in claim 22, wherein the foam thickness is about 4 mm or less.

25. The invention as recited in claim 2, wherein the adhesive material comprises a polyurethane thermoset adhesive.

26. The invention as recited in claim 1, wherein the rebond foam cushion includes a backing material bonded to one surface thereof.

27. The invention as recited in claim 1, wherein the primary carpet is a tufted carpet including pile yarn, primary backing, and a pre-coat adhesive.

28. The invention as recited in claim 1, wherein the primary carpet is a tufted carpet including pile yarn and a primary backing.

29. The invention as recited in claim 1, wherein the primary carpet is a bonded carpet including pile yarn and a backing material.

30. The invention as recited in claim 3, wherein said layer of reinforcing material comprises at least one of a porous scrim, woven, and non-woven material.

31. The invention as recited in claim 3, wherein said reinforcement material is formed of fiberglass.

32. The invention as recited in claim 3, wherein said reinforcement material comprises a porous textile structure.

33. The invention as recited in claim 3, wherein said reinforcement material consists essentially of polyester.

34. The invention as recited in claim 3, wherein said layer of reinforcing material comprises a plurality of glass fibers.

35. The invention as recited in claim 3, wherein said layer of reinforcing material comprises a plurality of polyester fibers.

36. The invention as recited in claim 3, wherein said mass of adhesive material substantially permeates and covers the layer of reinforcing material and extends in bonding relation between said primary carpet and said rebond foam cushion such that said primary carpet and said rebond foam cushion are adhesively bonded to one another by said mass of adhesive material.

37. The invention as recited in claim 3, wherein said primary carpet is a tufted carpet and wherein said mass of adhesive material extends between said rebond foam cushion and the underside of said primary carpet.

38. The invention as recited in claim 3, wherein said primary carpet is a bonded carpet and wherein said mass of adhesive material extends between said rebond foam cushion and the underside of said primary carpet fabric.

39. The invention as recited in claim 3, wherein said mass of adhesive material substantially permeates and covers the layer of reinforcing material and extends in bonding relation between said primary carpet and said rebond foam cushion such that said primary carpet and said rebond foam cushion are adhesively bonded to one another by said mass of adhesive material and wherein a layer of textile backing material is bonded to said rebond foam cushion across the surface of said rebond foam cushion facing away from said adhesive material.

40. The invention as recited in claim 1, wherein said rebond foam cushion is characterized by a density of about 6 to 12 lbs. per cubic foot.

41. A surface covering such as a wall covering, floor covering, carpeting, or carpet tile, comprising: a primary carpet, a polyurethane rebond foam cushion disposed at a position below said primary carpet, a mass of adhesive material disposed in bonding relation between said primary carpet and said rebond foam cushion and a layer of reinforcing material disposed between said primary carpet and rebond foam cushion such that at least a portion of said mass of adhesive material extends away from at least one side of said layer of reinforcing material.

42. The invention as recited in claim 41, wherein the rebond foam cushion is characterized by a density of about 25 lbs. per cubic foot or less.

43. The invention as recited in claim 42, wherein the primary carpet is characterized by a face weight of less than or equal to about 45 oz/yd².

44. The invention as recited in claim 41, wherein the adhesive material is selected from at least one of thermoplastic and thermoset adhesives.

45. The invention as recited in claim 41, wherein the adhesive material is present at a level of less than or equal to about 100 oz/yd².

46. The invention as recited in claim 41, wherein the polyurethane rebond foam cushion comprises at most 25% polyurethane binder and at least 50% polyurethane foam chips.

47. The invention as recited in claim 41, wherein the polyurethane rebond foam cushion has a density of about 6 to 12 lb./cu. ft.

48. The invention as recited in claim 41, wherein the primary carpet is a tufted carpet including pile yarn and a primary backing.

49. The invention as recited in claim 41, wherein a textile backing material is disposed across the underside of said polyurethane rebond foam cushion.

50. A method of forming a surface covering such as a carpet tile or carpet composite comprising the steps of: bonding at least one layer of rebond foam to the underside of a primary carpet fabric.

51. The method as recited in claim 50, further comprising the steps of bonding a reinforcement material between said primary carpet and rebond foam layer.

52. The method as recited in claim 50, wherein said rebond foam is bonded to said carpet by at least one adhesive.

53. The method as recited in claim 50, wherein said rebond foam is bonded to said carpet by lamination.

54. A surface covering produced by the method of claim 50.

55. A method of forming a cushion backed carpet composite comprising the steps of: bonding a layer of rebond foam to the base of a primary carpet fabric with a layer of reinforcement material therebetween.

56. The method as recited in claim 54, wherein said rebond foam is bonded to said primary carpet by at least one adhesive.

57. A carpet composite produced by the method according to claim 55.

58. A dimensionally stable cushioned carpet tile suitable for disposition as discrete modular units across a flooring surface, the carpet tile comprising:
a primary carpet fabric having a pile side and a primary base with a plurality of pile forming yarns projecting outwardly from the pile side;
a rebond foam cushion layer disposed at a position below the primary carpet fabric; and
a bridging composite extending in bonding relation substantially between the primary base and an upper side of the rebond foam cushion layer wherein the bridging composite consists essentially of a layer of stabilizing material having a first side and a second side, a first layer of at least one resilient adhesive extending away from the first side of the stabilizing material into contacting relation with the primary base and a second layer of at least one resilient adhesive extending away from the second side of the layer of stabilizing material into contacting relation with the upper side of the rebond foam cushion layer such that the layer of stabilizing material is bonded between the first and second layers of resilient adhesive at a position between the primary base and the rebond foam cushion layer.

59. The invention as recited in claim 58, wherein the primary carpet fabric is a tufted carpet and wherein the primary base comprises a primary backing and a layer of adhesive pre-coat extending across the underside of the primary backing.

60. The invention as recited in claim 59, wherein the adhesive pre-coat comprises at least one of a latex and hot melt adhesive.

61. The invention as recited in claim 60, wherein the hot melt adhesive is bitumen based hot melt adhesive.

62. The invention as recited in claim 60, wherein the hot melt adhesive is a polyolefin based hot melt adhesive.

63. The invention as recited in claim 58, wherein the resilient adhesive is at least one of a thermoset and thermoplastic.

64. The invention as recited in claim 58, wherein the primary carpet fabric is a bonded carpet.

65. The invention as recited in claim 58, wherein the rebond foam cushion layer comprises polyurethane rebond foam characterized by a density of about 5 to 25 lbs. per cubic foot.

66. The invention as recited in claim 58, wherein the rebond foam cushion layer comprises polyurethane rebond foam characterized by a density of about 5 to 12 lbs. per cubic foot.

67. The invention as recited in claim 58, wherein the first layer of at least one resilient adhesive comprises a thermoplastic adhesive.

68. The invention as recited in claim 67, wherein said adhesive is bitumen based hot melt adhesive.

69. The invention as recited in claim 67, wherein said adhesive is a polyolefin based hot melt adhesive.

70. The invention as recited in claim 67, wherein said first layer of resilient adhesive is a thermoset adhesive.

71. The invention as recited in claim 58, wherein the primary base comprises a primary backing and a layer of latex adhesive pre-coat extending across the underside of the primary backing.

72. The invention as recited in claim 58, wherein the primary base comprises a primary backing and a layer of hot melt adhesive pre-coat extending across the underside of the primary backing.

73. The invention as recited in claim 58, wherein the second layer of at least one resilient adhesive comprises a hot melt adhesive.

74. The invention as recited in claim 73, wherein said hot melt adhesive is bitumen based hot melt adhesive.

75. The invention as recited in claim 73, wherein said hot melt adhesive is polyolefin based hot melt adhesive.

76. The invention as recited in claim 73, wherein said second layer of resilient adhesive is a thermoset adhesive.

77. The invention as recited in claim 58, wherein the combined mass of the first layer of at least one resilient adhesive and the second layer of at least one resilient adhesive is not greater than about 100 ounces per square yard.

78. The invention as recited in claim 58, wherein the stabilizing material comprises a sheet of non-woven fiber glass.

79. The invention as recited in claim 58, wherein the first layer of at least one resilient adhesive comprises a hot melt adhesive and the second layer of at least one resilient adhesive comprises a hot melt adhesive.

80. The invention as recited in claim 79, wherein the stabilizing material substantially separates the first layer of at least one resilient adhesive from the second layer of at least one resilient adhesive.

81. The invention as recited in claim 58, further comprising a backing structure disposed across the lower side of the rebond foam cushion layer.

82. The invention as recited in claim 81, wherein the backing structure comprises a multi-component composite.

83. The invention as recited in claim 82, wherein said multi-component composite comprises a layer of adhesive disposed adjacent the lower side of the rebond foam cushion layer.

84. The invention as recited in claim 83, wherein said layer of adhesive disposed adjacent the lower side of the rebond foam cushion layer is present at a level of not greater than about 40 ounces per square yard.

85. The invention as recited in claim 81, wherein said backing structure comprises a multi-component composite including a quick release backing.

86. A process for producing a carpet composite comprising the steps of: modifying a rebond foam pad of approximately 5-25 pounds/cubic foot density to have a respective non-woven material bonded to each of the upper and lower surfaces thereof and with the composite rebond pad having a thickness of approximately 0.25 inch or less, slitting the composite rebond pad in half, producing two foam backings, each approximately 0.125 inch thick or less with a non-woven material attached to one surface, and bonding at least one of the foam backings using an adhesive to the back of at least one of a tufted carpet and a bonded carpet.

87. A carpet composite formed by the process of claim 86.

88. A carpet tile comprising a carpet layer and a backing attached thereto and having at least one layer comprised of compressible particles bonded together.

89. The carpet tile as recited in claim 88, wherein said layer comprised of compressible particles bonded together has an internal tear strength of at least 3 lbs.

90. The carpet tile as recited in claim 88, wherein the layer of compressible particles bonded together is a compressed particle foam and has a compressibility of less than 100% of the foam thickness at 40 psi.

91. The carpet tile as recited in claim 88, wherein said carpet tile has an appearance retention rating of at least 4.0 after 4,000 cycles.

92. The carpet tile as recited in claim 91, having an appearance retention rating of at least 3 after 12,000 cycles.

93. The carpet tile as recited in claim 88, wherein said layer comprised of compressible particles bonded together is at least one of a cut, slit and peeled foam.

94. The carpet tile as recited in claim 88, wherein said layer has a recycled content of at least 85%.

95. The carpet tile as recited in claim 88, wherein said layer comprised of compressible particles bonded together is an open celled foam comprised of open celled foam particles bonded together.

96. The carpet tile as recited in claim 95, wherein the open celled foam is comprised of foamed polyurethane.

97. The carpet tile as recited in claim 88, wherein said particles bonded together have an average uncompressed chip size of 25 mm or less.

98. The carpet tile as recited in claim 88, wherein said layer comprised of compressible particles bonded together has a density of ≦25 lbs/ft³.

99. The carpet tile as recited in claim 88, wherein said layer has a recycled content of at least 50%.

100. The carpet tile as recited in claim 88, having a hexapod rating >2.0 at 12,000 cycles.

101. The carpet tile as recited in claim 88, wherein said layer comprised of compressible particles bonded together is one layer of a hot melt laminated carpet backing.

102. The carpet tile as recited in claim 88, wherein said layer comprised of compressible particles bonded together is one layer of a flame laminated carpet backing.

103. The carpet tile as recited in claim 88, having an initial Gmax of less than 125.

104. The carpet tile as recited in claim 88, having a cushion weight of less than 32 oz/yd² and an initial Gmax less than 125.

105. The carpet tile as recited in claim 88, wherein the layer of compressible particles bonded together has at least one of a honey-combed, reticulated, and skeletal open cell structure.

106. The carpet tile as recited in claim 88, wherein the layer of compressible particles bonded together has a structure of randomly placed particles bonded together in a compressed state.

107. The carpet tile as recited in claim 88, wherein said layer of compressible particles bonded together is substantially free of any filler.

108. The carpet tile as recited in claim 88, wherein said compressible particles of said layer of compressible particles bonded together are substantially 100% recycled content.

109. The carpet tile as recited in claim 88, wherein the compressible particles are bonded together with an adhesive.

110. The carpet tile as recited in claim 109, wherein said adhesive contains at least one additive, agent or compound selected from flame retardant, anti-bacterial, color, anti-microbial, anti-fungal, conductive, anti-static, fibers, filler, recycled materials, and combinations thereof.

111. The carpet tile as recited in claim 88, wherein the compressible particles are bonded together in a compressed state.

112. The carpet tile as recited in claim 88, wherein said tile includes a plurality of layers of compressible particles bonded together.

113. The carpet tile as recited in claim 88, wherein said layer of compressible particles bonded together has at least one lateral surface which is cut, peeled, or slit.

114. The carpet tile as recited in claim 88, wherein the carpet layer includes at least one of woven, tufted, or bonded carpet.

115. The carpet tile as recited in claim 88, wherein said layer of compressible particles bonded together has air permeability.

116. The carpet tile as recited in claim 88, wherein the backing is a multilayer backing.

117. The carpet tile as recited in claim 88, wherein the backing includes a stabilizing layer.

118. The carpet tile as recited in claim 88, wherein the foam layer has a thickness of less than 8 mm.

119. The carpet tile as recited in claim 88, wherein the tile has an overall height of less than 10 mm.

120. The carpet tile as recited in claim 88, having a caster chair rating of >2.3.

121. The carpet tile as recited in claim 88, having an EN 1307 rating of >2.

122. The carpet tile as recited in claim 88, having a Herzog walking comfort rating for contract use (DIN 54327) of >0.70.

123. A cushion back carpet tile comprising a carpet layer and a cushion back attached thereto and having at least one layer comprised of preformed foamed polyurethane particles bonded together.

124. The cushion back carpet tile as recited in claim 123, wherein said layer comprised of foamed polyurethane particles bonded together has an internal tear strength of at least 3 lbs.

125. The cushion back carpet tile as recited in claim 123, wherein said layer comprised of foamed polyurethane particles bonded together has a thickness of about 2 to 20 mm.

126. The cushion back carpet tile as recited in claim 123, wherein said layer comprised of foamed polyurethane particles bonded together has a compressibility of less than 100% at 40 psi.

127. The cushion back carpet tile as recited in claim 123, wherein said tile has an appearance retention rating of at least 4 at 4,000 cycles.

128. The cushion back carpet tile as recited in claim 123, wherein said tile has an appearance retention rating of at least 3 at 12,000 cycles.

129. A foam backed carpet tile with slit or peeled foam.

130. A foam backed carpet tile with open celled foam comprised of foamed polyurethane particles bonded together.

131. The foam backed carpet tile of claim 130 with an average uncompressed particle size of 15 mm or less.

132. A foam backed carpet tile with a backing of bonded chips of resilient material attached to a textile face and a backing density of ≦14 lbs/ft³.

133. A foam backed carpet tile with a flame laminated foam backing.

134. A foam backed carpet tile with a backing of bonded chips of resilient material attached to a textile face and an initial Gmax of less than 125.

135. The cushion backed carpet tile of claim 134 with a cushion weight of less than 25 lbs. per cubic foot.

136. A cushion backed carpet tile with a carpet layer and a skeletal structured foam cushion.

137. A cushion backed carpet tile including a carpet layer and a backing layer with a total backing layer weight of less than 50 oz/yd².

138. A carpet tile comprising a carpet layer and a backing attached thereto and having at least one layer comprised of foamed open cell particles bonded together.

139. A carpet tile with a cushion weight of less than 25 oz/yd² and an initial Gmax of less than 125.

140. A carpet tile comprising a carpet layer, a stabilizing layer, and a backing wherein at least one of said stabilizing layer and backing have at least one layer comprised of preformed compressible particles bonded together.

141. A cushion back carpet tile comprising a carpet layer, a stabilizing layer, and a cushion back having at least one layer comprised of preformed compressible particles bonded together.

142. A carpet tile having a recycled foam content of at least 50%.

144. A carpet tile having a recycled foam content of at least 85%.

144. A method of recycling post industrial or post consumer waste foam, comprising the steps of:
reducing the foam to compressible particles having an average diameter of less than 25 mm,
mixing the particles with a prepolymer to coat the particles with prepolymer,
compressing the coated particles to a compression ratio of at least 2:1,
curing the polymer and fixing the particles in the compressed state to form a rebond foam,
and then using at least a portion of the rebond foam to form a backing or cushion of a carpet tile.

145. A method of producing a carpet tile having a carpet layer and a backing layer including at least one layer of rebond foam, comprising the steps of:
forming the backing layer, then
joining the backing layer to the carpet layer.

146. A cushion back carpet tile, comprising:
a carpet face material,
a foam layer,
and a backing layer including magnetic material.

147. The carpet tile as recited in claim 146, wherein said magnetic material is one of a sheet or strips.

148. The carpet tile as recited in claim 146, wherein said foam layer is rebond foam.
